(19) United States
(12) Patent Application Publication
(10) Pub. No.: US 2020/0357296 A1
(43) Pub. Date: Nov. 12, 2020

(54) INTEGRATED EDUCATION MANAGEMENT METHODS AND SYSTEMS

(71) Applicant: Rahul SHARMA, Ludhiana (IN)

(72) Inventor: Rahul SHARMA, Ludhiana (IN)

(21) Appl. No.: 16/409,288

(22) Filed: May 10, 2019

(51) Int. Cl. G09B 7/00; G06Q 50/20

(52) U.S. Cl. CPC G09B 7/00; G09B 7/04; G06Q 50/2057

(57) ABSTRACT

Embodiments provide integrated education management methods and systems to provide a personalized learning platform to users. An integrated education management system (IEMS) that includes an intelligent SaaS platform provides user a single interface for accessing different departments, functionalities or services of an organization. The Intelligent SaaS Platform provides a personalized learning platform and a subscriber network to learners. The personalized learning platform provide individual learning plans that empower students to learn at their own choice of time, place, and pace. The subscriber network connects a plurality of users, such as learners, personal mentors of the learners, resource creators, tutorial agents, or the like to share/sell and buy personalized and customized learning plan for the learners. This platform also includes analytical tools and engines that provide learning recommendations for the learners. The analytical tools and engines use all indicators from the software that are used in providing the learning recommendations.

### COPYRIGHT NOTICE/PERMISSION

A portion of the disclosure of this patent document may contain material which is subject to copyright protection. The owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to the field of educational software based systems. More particularly, the invention relates to systems and methods for integrating one or more software of the educational institute to create all-in-one software that is accessed through a single sign-on (SSO) identification (ID).

### BACKGROUND OF THE INVENTION

With the evolution of the Internet and computer technologies, the educational institutes have migrated from paper-based documentation and learning to electronic documentation and e-learning in all the departments. Today, each department of the educational institutes is managed and handled using computer software. For example, the institutes have different software to manage admission process, Student Information System (SIS), Library Management System, Virtual campus, e-learning, attendance records, canteen facility, hostel facility, and the like. However, different software used for different departments are standalone software and are not linked and integrated with each other. In general, most of the educational institutes have multiple software and logins for each or most of the standalone software associated with different departments are created. Therefore, memorizing and managing all of the software is a major setback for educational institutes.

Similarly, problems related to data entry for different departments, data mining, data storage and data integration always persist while managing different software of the educational institutes. This is primarily because the currently available software do not interact with each other and these are silo software operating on different platforms and different technologies. Moreover, the different software solutions for different departments are built on expensive, inefficient and outdated technologies, which require frequent and costly upgrades.

In addition, the stand-alone non-integrated e-learning and virtual campus software are also not useful as the current software provide all enrolled students with standardized contents. Hence, the same methods of teaching and testing for different students, who may have different learning capabilities, conflict with individual learning abilities. Each student needs customized support to fully develop their individual learning potential. Hence, there is a lack of all in one integrated education management system and software that caters to all the needs of the students, teachers, parents, educational institute staff and management through a single dedicated software. In addition, the software should also allow all the students to learn at their own pace, at a time and location of their choice, or on an individualized learning path.

### SUMMARY

Various embodiments of the present disclosure provide integrated education management methods and systems.

In an embodiment, the method includes facilitating registration of users to the virtual learning organization for creating user accounts of the users. The user accounts correspond to at least tutors, parents and authors. The method includes defining goals and learning outcomes for the learners by the registered users. The learning outcomes corresponding to one or more learning courses of the learners. The method includes creating learning curriculum map and learning course resources for the learners based on the learning outcomes. The method includes generating learning plans for the learners based on the learning curriculum map and learning course resources, the learning plans to be learnt at time, path, place and pace of the learners. The method includes assigning the users for providing the learning plans to the learners. The method includes evaluating performance of the learners based on the learning plans for generating competency scores of the learners. The method includes generating an analysis report for the learners based on the competency scores for determining problematic areas of the learners. The method includes generating recommendations for updating the learning plans based on the analysis report to improve the problematic areas. The method further includes providing personalized learning plans to the learners based on the recommendations.

In another embodiment, a virtual learning system for providing personalized learning plans to learners of a virtual learning organization is disclosed. The virtual learning system includes a database storing instances of the virtual learning system, and a learning platform, coupled with the database. The learning platform is configured to cause the virtual learning system to perform a method. The method includes facilitating registration of users to the virtual learning organization for creating user accounts of the users. The user accounts corresponding to at least tutors, parents and authors. The method includes defining goals and learning outcomes for the learners by the registered users. The learning outcomes corresponding to one or more learning courses of the learners. The method includes creating learning curriculum map and learning course resources for the learners based on the learning outcomes. The method includes generating learning plans for the learners based on the learning curriculum map and learning course resources, the learning plans to be learnt at time, path, place and pace of the learners. The method includes assigning the users for providing the learning plans to the learners. The method includes evaluating performance of the learners based on the learning plans for generating competency scores of the learners. The method includes generating an analysis report for the learners based on the competency scores for determining problematic areas of the learners. The method includes generating recommendations for updating the learning plans based on the analysis report to improve the problematic areas. The method further includes providing personalized learning plans to the learners based on the recommendations.

In yet another embodiment, a method for providing personalized learning plans to learners of a virtual learning organization is disclosed. The method includes facilitating registration of users to the virtual learning organization for creating user accounts of the users. The user accounts corresponding to at least tutors, parents and authors. The method includes defining goals and learning outcomes for the learners by the registered users. The learning outcomes corresponding to one or more learning courses of the learners. The method includes creating learning curriculum map and learning course resources for the learners based on the learning outcome. The method includes organizing the learning curriculum map and learning course resources into units, lesson plans, notes, worksheets, learning sets, questions and grading levels based on the goals and learning outcomes. The method includes generating learning plans for the learners based on the learning curriculum map and learning course resources, the learning plans to be learnt at time, path, place and pace of the learners. The method includes assigning the users for providing the learning plans to the learners. The method includes evaluating performance of the learners based on the learning plans for generating competency scores of the learners. The method includes generating an analysis report for the learners based on the competency scores for determining problematic areas of the learners. The method includes generating recommendations for updating the learning plans based on the analysis report to improve the problematic areas. The method includes providing personalized learning plans to the learners based on the recommendations.

### BRIEF DESCRIPTION OF THE DRAWINGS

The advantages and features of the present invention will become better understood with reference to the detailed description taken in conjunction with the accompanying drawings, wherein like elements are identified with like symbols, and in which:

FIG. 1 illustrates an exemplary environment, in accordance with an embodiment of the present invention;

FIGS. 2A, 2B and 2C collectively illustrate a block diagram of an Integrated Educational Management System (IEMS), in accordance with an example embodiment of the present invention;

FIGS. 3A and 3B collectively depict a flow diagram that illustrates basic configuration and entry of data elements in the IEMS, in accordance with an example embodiment of the present invention

FIG. 4 depicts a flow diagram that illustrates basic configuration and entry of data elements in the IEMS, in accordance with an example embodiment of the present invention;

FIGS. 5A, 5B and 5C collectively illustrate a flow diagram depicting flow of creating a homeschooling platform using an advance learning module of the IEMS, in accordance with an example embodiment of the present invention;

FIG. 6 illustrates a flow diagram depicting flow of information in modules associated with different logins of different users of the IEMS, in accordance with an example embodiment of the present invention;

FIGS. 7A and 7B collectively illustrate a flow diagram depicting flow of information in modules associated with student login of the IEMS, in accordance with an example embodiment of the present invention

FIGS. 8A and 8B collectively illustrate a flow diagram depicting flow of information in advance learning module associated with a teacher login of the IEMS, in accordance with an example embodiment of the present invention;

FIG. 9 illustrates a flow diagram depicting flow of information in an advance learning module of the IEMS, in accordance with an example embodiment of the present invention;

FIG. 10 illustrates a flow diagram depicting a flow of information in recommendation engine and individual learning plans module of the IEMS, in accordance with another example embodiment of the present invention;

FIG. 11 illustrates a flow diagram depicting a flow of information for handling customized and personalized learning module of the IEMS, in accordance with another example embodiment of the present invention;

FIGS. 12A and 12B collectively show a flow diagram depicting classroom teacher configuration, in accordance with an example embodiment of the present invention;

FIGS. 13A and 13B collectively show a flow diagram depicting a machine learning generated auto plan using curriculum map, in accordance with an example embodiment of the present invention;

FIG. 14 shows a flow diagram depicting procedure for cluster groups, in accordance with an example embodiment of the present invention;

FIG. 15 shows a flow diagram depicting procedures for cluster selection, in accordance with an example embodiment of the present invention;

FIG. 16 shows a flow diagram depicting procedures for initialization, in accordance with an example embodiment of the present invention;

FIG. 17 shows a flow diagram depicting procedures for objective selection, in accordance with an example embodiment of the present invention;

FIG. 18 shows a flow diagram depicting procedures for content selection when enough learning data not available, in accordance with an example embodiment of the present invention;

FIGS. 19A and 19B collectively show a flow diagram depicting procedures for content selection with enough data available, in accordance with an example embodiment of the present invention;

FIG. 20 shows a flow diagram depicting procedures for insertion of student learning table rows, in accordance with an example embodiment of the present invention;

FIG. 21 shows a flow diagram depicting procedures for lesson mastery exam, in accordance with an example embodiment of the present invention;

FIGS. 22A and 22B collectively show a flow diagram depicting procedures for updating learning tables after lesson plan, in accordance with an example embodiment of the present invention;

FIGS. 23A and 23B collectively show a flow diagram depicting procedures for archiving user data after failed lesson exam, in accordance with an example embodiment of the present invention;

FIG. 24 shows a flow diagram depicting procedures for re-initiating lesson based on objective selections, in accordance with an example embodiment of the present invention;

FIG. 25 shows a flow diagram depicting procedures for reinitiating lesson based on content selection without learning objective, in accordance with an example embodiment of the present invention;

FIGS. 26A and 26B collectively shows flow diagram depicting procedure for reinitiating lesson based on content selection with enough learning data available, in accordance with an example embodiment of the present invention;

FIGS. 27A and 27B collectively show a flow diagram depicting procedures for reinitiating lesson exam, in accordance with an example embodiment of the present invention;

FIG. 28 shows flow diagram depicting procedures for reinitiating lesson based on content selection without learning data, in accordance with an example embodiment of the present invention;

FIGS. 29A and 29B collectively show a flow diagram depicting procedure for unit exam, in accordance with an example embodiment of the present invention;

FIG. 30 shows flow diagram depicting procedure for after unit exam, in accordance with an example embodiment of the present invention;

FIGS. 31A and 31B collectively depict a flow diagram depicting procedure for generating new analysis, in accordance with an example embodiment of the present invention;

FIGS. 32A and 32B collectively show a flow diagram depicting flow of information for selecting plan for a student, in accordance with an example embodiment of the present invention;

FIG. 33 depicts a flow diagram depicting flow of information for selecting learner and course, in accordance with an example embodiment of the present invention;

FIGS. 34A, 34B and 34C collectively depict a flow diagram depicting flow of information for registration of a user as a marketplace author, in accordance with an example embodiment of the present invention;

FIG. 35 shows a flow diagram depicting flow of information for adding topics and sub-topics, in accordance with an example embodiment of the present invention;

FIGS. 36 to 46 illustrates screen shots of various User Interfaces (UI) associated with the IEMS, in accordance with an example embodiment of the present invention.

FIG. 47A illustrates a transition reward table for learning outcomes states, in accordance with an example embodiment of the present invention;

FIG. 47B illustrates a learning outcomes/objective states, in accordance with an example embodiment of the present invention;

FIG. 48A illustrates a flow diagram depicting a method for providing personalized learning plans for learners of a virtual learning organization, in accordance with an example embodiment of the present disclosure; and

FIG. 48B illustrates a flow diagram depicting a method for providing personalized learning plans for learners of a virtual learning organization, in accordance with an example embodiment of the present disclosure.

### DETAILED DESCRIPTION OF THE INVENTION

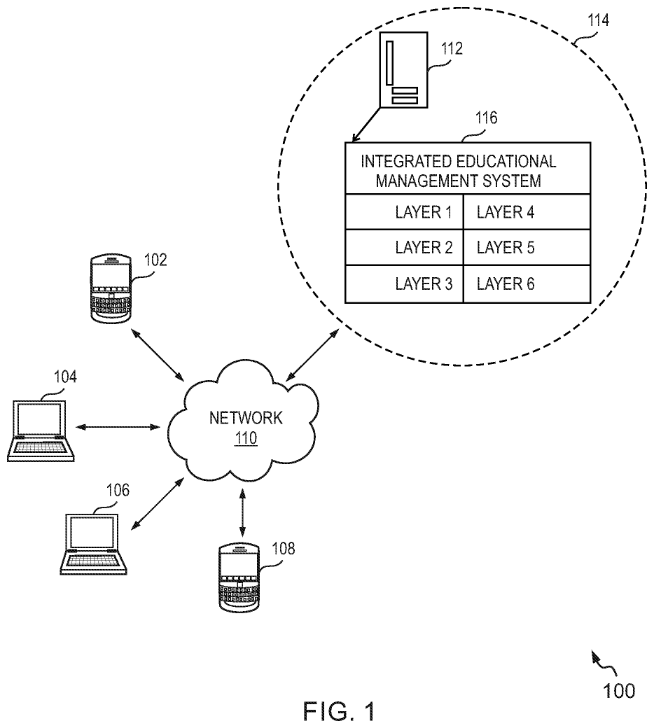

The best and other modes for carrying out the present invention are presented in terms of the embodiments, herein depicted in FIGS. 1 to 48A-48B. The embodiments are described herein for illustrative purposes and are subject to many variations. It is understood that various omissions and substitutions of equivalents are contemplated as circumstances may suggest or render expedient but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect. The terms “a” and “an” herein do not denote a limitation of quantity, but rather denote the presence of at least one of the referenced item.

Overview

Various embodiments disclose an integrated education management system to provide a personalized learning platform to users. The integrated education management system (IEMS) provides each user a single interface for accessing different departments, functionalities or services of an educational institute. The IEMS software provides institutes with functionalities and modules of packages like Enterprise Resource Planning (ERP) software, student management system, Library Management System (LMS), Student Information System (SIS), special education software, personalized and customized learning system, virtual school system, distance education, individual learning plans, reinforcement learning management system, subscriber and facilitated learning management system, education agency system and management, message (email or SMS) broadcast system, and staff information system.

The IEMS is a Software as a service (SaaS) web application that provides seamless integration of an entire educational (school/college) system hierarchy. In an embodiment, the IEMS includes a multi-layered structure. Each layer corresponds to a database group, a user roles and access group, a functionalities group, a learning plan group, a ‘customized and personalized learning system group’ and a ‘subscribers and facilitated learning network group’. Each group has different functions, components and tasks to perform in providing all-in-one single educational system. Each group is depicted in a layered fashion.

The IEMS software includes built-in Learning Management System (LMS), Student Information System (SIS), Enterprise Resource Planning (ERP), Transportation, Cafeteria, State Reports, and the like. These software systems can work independently and in an integrated fashion. The IEMS allows seamless integration with any other third-party software.

A separate machine-learning based Intelligent SaaS Platform (e.g., Veda™ Junction) is built on top of IEMS modules and packages. The Intelligent SaaS Platform provides a personalized learning platform and a subscriber network to learners. The personalized learning platform is provided by using individual learning plans that empower students to learn at their own choice of time, place, and pace. The subscriber network connects a plurality of users, such as learners, personal mentors of the learners, resource creators, tutorial agents, or the like to provide personalized and customized learning plan for the learners. This platform (built on top of IEMS) also includes machine learning based analytical tools and engines that provide learning recommendations to the plurality of users. The machine learning based analytical tools and engines use all indicators from the software that are used in providing the learning recommendations.

Moreover, the personalized learning platform provides learning tools that can be used for creating a private learning facility, such as homeschooling, home tutorial for a learner, or the like. For example, parents may use the learning tools for teaching their children with their own preferable teaching methodologies and customized learning contents. Further, these teaching methodologies and customized learning contents can be shared in a learning community. In at least one example embodiment, the customized learning contents can be sold/bought, while creating a learning marketplace.

In at least one example embodiment, the IEMS and Intelligent SaaS Platform provide a personal Intelligent Agent (IA) to tutor each learner. The IA may assist the learner based on the demand of the learner. That is, the IA is available to the learner at any time, place and pace of the learner. The IA also provides automatic individual learning plans for the learners. In at least one example embodiment, the individual learning plans are provided based on performance indicators, content profiles, evaluation profiles and learning outcome profiles of each learner. Further, the IA modifies the learning plans based on learner's performance and content profiles. This improves its knowledge of recommendations.

The IEMS and the Intelligent SaaS Platform include a single large database with a multi-layer structure. Each layer represents a particular group, such as Layer 1 represents the database group, Layer 2 represents the user roles and access group, Layer 3 represents the system modules and functionalities group, Layer 4 represents the learning plan group, Layer 5 represents the customized and personalized learning system group and subscribers, and Layer 6 represents the facilitated learning network group. Each layer is loosely coupled with other layers and is dependent on the central database layer (Layer 1). The data flows between each layer in an efficient way, which minimizes the setup/data entry effort and maximizes staff output. This layered structure enables a user to have SSO (single sign-on) and thus the user can access all needed information in a single login. The users can navigate to different functions using just a few clicks of the mouse.

The database layer (i.e., Layer 1) includes fully normalized modular tables that are designed to handle integrated data efficiently. The database is located, stored, and maintained in a single location along with multi-location backup servers. The confidential data records of the educational institute are stored in encrypted form. The Layer 2 enables the IEMS to create multiple user roles along with different access types for different user roles based on the requirement of an educational institute. In at least one example embodiment, more than 50 fixed pre-defined user roles are provided. The pre-defined user roles include, for example, but are not limited to, an administrator role, a super user role and more along with dynamic roles, which provides users with set or subset of functionalities.

The Layer 3 includes around 2000+ system functionalities, such as user information, learning management and resource planning, and the like. The information management features in this layer include interfaces like special education, state reporting, distance education, multiple design structure/interfaces, and the like. Similarly, learning management features in this layer include, but are not limited to, lesson structure, advance grading, collaboration tools, sharing methodologies, online examination with check-in mechanism, multi-level approval process and the like. The Layer 3 also includes school complex business processes like event-area management, purchase order approval process, fee management with section-based setup. The IEMS allows all the modules to interact with each other and data entered through any module can be used by another module for modification or reporting purposes.

The Layer 4 facilitates the creation of individual and personalized learning plans by using certain criteria's like student standard competency scores, which are made available to students for learning. This layer takes into consideration the student's problematic areas where course learning outcomes are not met and prepare individual learning plans that helps in addressing the individual student problems, by the organization and sequencing of course content.

The Layer 5 and 6 provide the personalized learning plans that are governed by algorithms based on mastery and reinforcement learning that provides personalized learning to the students with support of intelligent system-tutors, teachers and facilitators. The teachers, students, and parents can create and share their own curriculum, content, and learning resources. The personalized learning also allows the parents to create individual learning plans and offer students those individual learning plans which can also be shared with other parents. These layers are part of the Intelligent SaaS platform built on top of core IEMS layers and modules.

FIG. 1 illustrates an exemplary environment 100, in accordance with an embodiment of the present disclosure. The environment 100 includes a plurality of client devices associated with different users (not shown in FIG. 1). Examples of client devices include, but are not limited to, Desktops, Laptops, Smart Phones, Personal Digital Assistance (PDAs) and the like. In the environment 100, each client device is associated with different users of an educational institute, for example a client device 102 is associated with a student, a client device 104 is associated with a teacher 104, a client device 106 is associated with a parent and a client device 108 is associated with an office staff. Only four client devices and users are depicted in the environment 100 for illustrative purposes, however, there will be multiple such client devices and users. The client devices 102-108 are connected to each other through a network 110, such as the internet. The network 110 is also connected to a server device 112. Even though only one server device 112 is depicted in the environment 100 it should be obvious for the person skilled in the art that the environment 100 can include more server devices.

The server device 112 is a cloud server hosted on a cloud infrastructure, for example a private cloud infrastructure, a public cloud infrastructure, or a hybrid cloud infrastructure. The server device 112 is also referred to as a “cloud” 114 when it is hosted on any of the cloud infrastructure. In an embodiment, the server device 112 is a dedicated server hosted in an enterprise/campus of the educational institute (not shown in figure). An Integrated Educational Management System (IEMS) 116 is hosted on the server device 112. The IEMS 116 is an integrated software that provides each user a single interface for accessing different departments, functionalities or services of the educational institute. For the sake of clarity and for the purpose of this description, the IEMS 116 is also referred as a single educational management system (the single system 116). For example, the IEMS 116 integrates institutes Enterprise Resource Planning (ERP) software, student management system, Library Management System, Student Information System (SIS), special education software, personalized and customized learning system, virtual school system, distance education, individual learning plans, reinforcement learning management system, subscriber and facilitated learning management system, education agency system and management, message (email or SMS) broadcast system, and staff information system.

The IEMS 116 seamlessly combines different functionalities, departments, and services of the educational institute. Each user can access the IEMS 116 using their respective single sign-on credentials on a single (all-in-one) interface of the IEMS 116. Hence, each user will have only single login credentials to access different departments of the educational institute, for example a student can use its single sign-on credentials to access their personal information, progress report, attendance, canteen facility, hostel facility, fees dues, payment facilities, e-learning facility, and the like. Each user has a definitive role in the IEMS 116 and can access different functionalities of the IEMS 116 based on the definitive role. For example, the accounts department staff using their single sign-on facility may only have access to fees/accounts section of students. In an embodiment, the IEMS 116 is a Software-as-a-Service (SaaS) web application system hosted on the cloud 114.

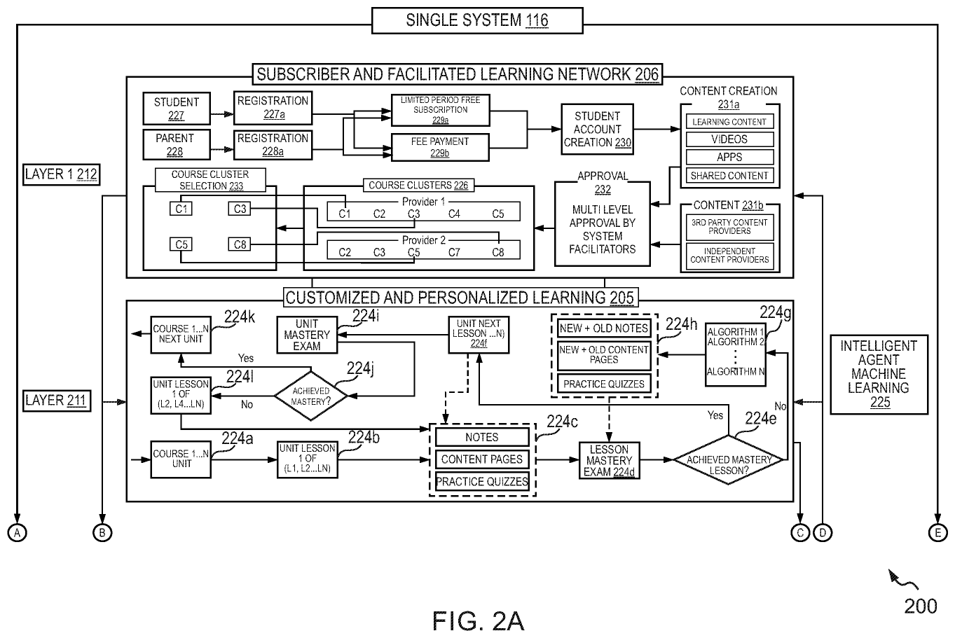

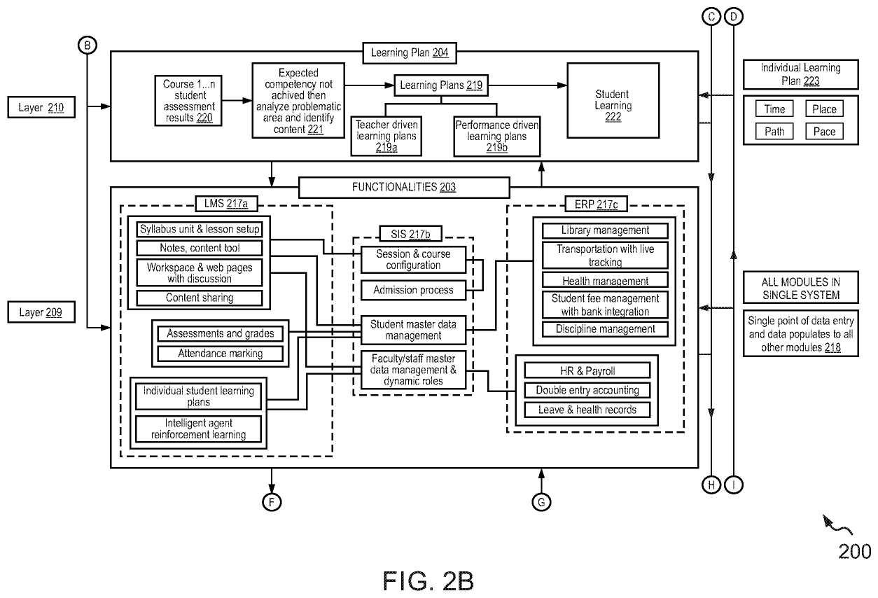

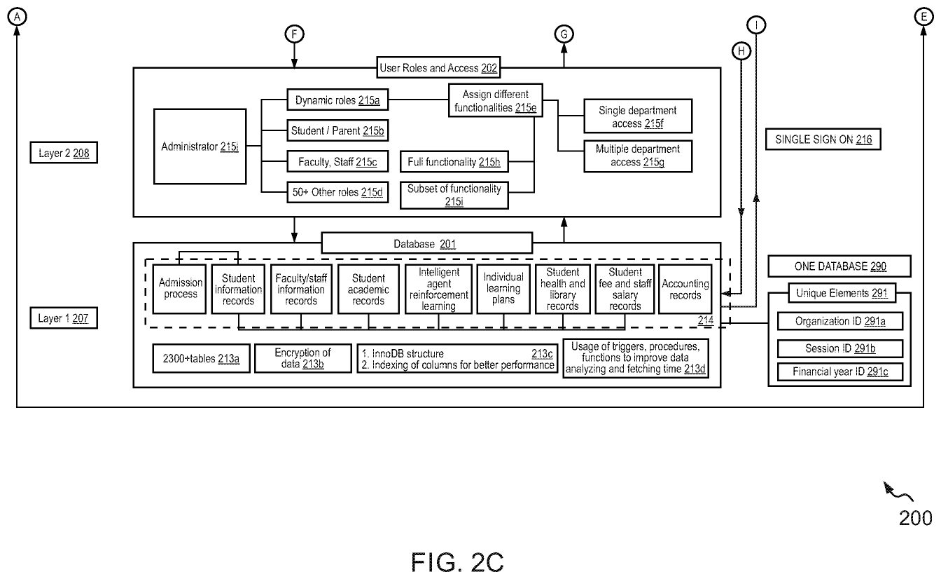

The use of SaaS web application provides the IEMS 116 with seamless integration of an entire educational (school/college) system hierarchy. Additionally, the addition of the SaaS system to existent networks at schools/colleges is virtually costless in terms of hardware cost as the staffs, parents, teachers and students can access the IEMS 116 from anywhere. In an embodiment, the server device 112 contains a set of computer programs that combine to create the SaaS web application i.e. the IEMS 116. The tasks performed at the IEMS 116 (the single educational system) are executed by different modules and components that are seamlessly integrated in the IEMS 116. Each of the modules and components of the IEMS 116 are described in detail in conjunction with FIGS. 2A, 2B and 2C.

FIGS. 2A, 2B and 2C illustrate a block diagram 200 of an Integrated Educational Management System (IEMS) 116, in accordance with an example embodiment of the present invention. The IEMS 116 is shown to include six group of components each having different functions, components and tasks to perform in providing all-in-one single educational system. The different groups of components are a database group 201, a user roles and access group 202, a functionalities group 203, a learning plan group 204, a customized and personalized learning group 205 and a subscribers and facilitated learning network group 206. Each group is depicted in a layered fashion. For example, the database group 201 corresponds to Layer 207 of the IEMS 116, the user roles and access group 202 corresponds to Layer 208, the functionalities group 203 corresponds to Layer 209, the learning plan group 204 corresponds to Layer 210, the customized and personalized learning system group 205 corresponds to Layer 211 and the subscriber and facilitated learning network group 206 corresponds to Layer 212 of the IEMS 116.

The different groups 201-206 of the IEMS 116 provide one complete virtual campus and school management system, one database hosted on a cloud, one user account as a single sign-on for all the educational institute functionalities, one navigational interface for optimal efficiency and ease of use, and provides one to one device support for all electronic devices like computers, Chromebooks, tablets and smart phones. The IEMS 116 also allows the educational institutes to integrate their current 3rd party applications with any or all functionalities of the LMS, SIS, ERP, Library, Transportation, Cafeteria, State Reports, and the like.

The Layer 207 is associated with a database, such as one database 290 of the IEMS 116. In an exemplary embodiment, the database 201 includes 23000+ tables 213a with fully normalized table structure. An encryption of data (see, 213b) is performed for data present in the database 201. The encryption of data 213b provides a fully secured data as the data are stored in encrypted form instead of plain text. The database 201 with fully normalized modular table design allows to handle integrated data efficiently. The normalized form of tables minimizes redundant data and prevents to update anomalies. Further, the data is stored in a database structure, such as an InnoDB structure 213c with indexing of columns for better performance. As the database 201 is large, information retrieval time and processing of complex data may be high. For this, usage of triggers, procedures and functions 213d improve the information retrieval time and provides fast processing of the complex data. The Layer 207 is tightly coupled with all other layers (Layers 208-212) in the IEMS 116. All the data flow from the Layer 207 only. The database 201 is located, stored and maintained in a single location along with multi location backup servers. As shown in FIG. 2C, the database 201 includes, data related to admission process 214a, student information records 214b, faculty/staff information records 214c, student academic records 214d, data related to intelligent agent reinforcement learning 214e, individual learning plans 214f, student health and library records 214g, student fee and staff salary records 214h, and accounting records 214i. In at least one example embodiment, the IEMS 116 includes one database 290 hosted in a secure private cloud. The one database 290 includes unique elements 291 with data, such as organization id 291a, session id 291b and financial year id 291c. At Layer 208, the user roles and access group 202 allows to create multiple roles and different access types for different users. The multiple roles and different access types are created based on requirement of an educational institute. In at least one example embodiment, the IEMS 116 offers highly efficient dynamic roles 215a, student/parent 215b, faculty/staff 215c along with 50+ fixed user roles 215d. The IEMS 116 also allows different permission sets and profiles to specify objects and information that the users of the dynamic role 215d can access. Thus, the users of the dynamic roles 215d are assigned with different functionalities 215e. The different functionalities 215e can be categorized into single department access 215f and multiple department access 215g. Also, the users of the dynamic roles 215d are provided with a full functionality 215h or a subset of functionalities 215i. The full functionality 215f or the subset of functionalities 215g can be reused and assigned to different users. These multiple user roles are created by an administrator 215j. Further, the multiple user roles have property of access control of multiple related, yet independent, modules/functionalities of the IEMS 116 in single login, such as Single Sign-On (SSO) 216. The access is provided to each user through the SSO 216.

For the sake of clarity, some of the roles, objects and elements of Layer 208 are defined below:
Super Administrator Role: A role that is available by default and is used to create the organization, session and financial session.
Organization element: An object in the organization element is a root (parent) element of the single instance on an installation of the software. Each installation can have multiple instances.
Session element: An object in the session element is a forked (child) element of the organization element. The session can be a year, a semester, a trimester or a quarter.
Financial Session element: An object in the financial session element is a child element of the organization element. It is mapped to the financial year followed by the organization and is used for accounting modules. It runs independently from the session element.
Administrator Role: A role that is used to create other roles and to give different access to the other roles. The administrator has access to all functionalities in the software.
Super User Role: A role (user) under this category will have access to everything. The user of the Super User (also known as super user) may login to account of any other user in the IEMS 116. For example, the super user may login to accounts of students, faculty, parent, or any other users and may monitor progress, check usage and can even perform the same tasks.
Access based dynamic Roles: The IEMS 116 can create users with different or combination of roles and may assign different functionalities to them. For example, different access types can be assigned to a user under dynamic role, like providing access to one of more modules based on role type, access to one of more functionalities of a module or access to different departments for the chosen functionality. In another example, for level 1 course, a user role can be created which may be given access to four modules (attendance, grades, learning plans and fee accounting. For Level 2 course, a user may get access to sub functionalities for each module, attendance entry, grade view, learning plan approval and fee reports. Similarly, for level 3 course, a user may get access to one or more departments or schools within the institution like middle school and primary school.

At the Layer 209, the functionalities group 203 provides an integration of different management modules of an educational institute. The different management modules include LMS 217a, SIS 217b and ERP 217c. The LMS 217a performs tasks for managing syllabus unit and lesson setup, creation of notes using content tool, organizing workspace and web pages with discussion and content sharing. The LMS 217a also manages assessments and grades and attendance marking. Further, the LMS 217a provides individual student learning plans and intelligent agent based reinforcement learning. The LMS 217a is connected to SIS 217b and all data of the LMS 217a are shared to the SIS 217b. The SIS 217b handles session and course configuration, admission process, student master data management and faculty/staff master data management and dynamic roles. The SIS 217b is further connected to the ERP 217c. The ERP 217c performs library management, transportation with live tracking, health management, student fee management with bank integration, and discipline management.

The library configuration will be done by adding Department and Sub-Department. The Librarian will add required resource types and then set particular library rules based on resource types for different user types like student and/or teachers. The librarian can then add books based on added resource types. Thereafter, the librarian will re-shelve the books. The librarian can also generate bar code for each book and can issue books to students/teacher based on their User Id or User name. Following are some of the different book status:

1. Available: Book status ‘Available’ indicates that the book is available in shelf.

2. Reshelf: Book status ‘Reshelf’ indicates that the book has to be re-shelved.

3. On Hold-Shelf: Book status ‘On-Hold Shelf’ indicates that the book is in shelf and a user has put the book on hold.

4. On Hold: Book status ‘On-Hold’ indicates that the book is issued by a user and other user has put the book on hold.

5. On-Recall: Book status ‘On-Recall’ indicates that a user has issued the book, and other user has re-called for the book. This is done only when there are limited book copies.

6. Check-out: Book status ‘check-out’ means that book is issued.

The librarian can issue a book to the user if book status is in ‘Available’ status. If the user has kept a book “on hold”/“on-hold shelf” then only that user will get the book when it is available. If a book is with a user with no other copies left and another user wants it, then another user has to keep that book in recall status. The librarian will collect the book and then issue the book to other user. If the user doesn't return the book in time, then user has to pay fine to the librarian depending upon the rule setup earlier. The librarian can also have the status and user report of the books. Following are the data flow of library management:
i. Add department, sub-department and setup library configuration.
ii. Add resource type and set the rule for that resource type and user type.
iii. Add items/books for a particular department, sub department and resource type.
iv. Re-shelf books to their department and sub-department.
v. Issue/check-out books to particular user.
vi. Return/check-in books from particular user.
vii. Issue/check-out the on-desk books to a user that has kept the book in on-hold/on hold-self.
viii. Pay fine to librarian if books are not returned in time

Features: Issue/check-out of books; Return/check-in of books; report lost and damage of books; special reserve of books; approve new tags and reviews on the books; status of items on desk; select up list on-hold; pay fine and user reports.

Creation of transport route is done by a transportation officer. The user can also create route dynamically or using maps such as Google® map. To link this to accounts, the transportation office will create a transport fee slabs for route and will assign those slabs to students. After creation of transport route, the transportation officer will assign different stoppages for each route. The students can then apply for transport from their respective login or transportation officer can also assign transport to students. All the transport activities will be recorded like vehicle entry logs, single/multiple student(s) check-in/out logs. The transportation officer or parent can also do Live tracking of the buses. The following are the data flow of transport management:

Creation of route.
i. Creation of transport fee slab and then assign to students.
ii. Assign stoppages using Google or system search.
iii. Assign buses to the transportation
iv. Allot transportation to students with arrival and departure timings.

Vehicle entry records.
v. Single/multiple student check-in/check-out logs.
vi. Route tracking reports.

The transportation management includes route network creation, automatic vehicle allocation system, student transportation request system, integration with accounting and live tracking.

The discipline management includes prerequisite of staff setup as dynamic user, discipline management access to dynamic user, building and room setup, student master data and teacher master data.

The dynamic user will do configuration by adding incident type, resolution type and by adding items types. Once configuration is done, the dynamic user will set up incidents occurred in school or educational area by adding behavioral referral, subsequent meetings and thereafter final decision will be made. The dynamic user will add incident with all the participants. Post addition of the incident, the dynamic user will schedule a meeting/hearing by selecting building and room. Once meeting is done for any incident, it will show “In process” status and if incident is added recently and no hearing has been done, then it will be associated with “Presented” status.

The final resolution will be added by dynamic user once meeting is done with other referred staff. The meeting/hearing done with other staff helps officer to give better judgment on incident. The final resolution will be added by selecting resolution start date and end date and by selecting action type. The academic user will assign action/resolution for every person involved in the incident. Once the incident is accomplished after a final decision, all the reports related to the incident will be generated. The parents of every student involved in the incident will be notified through a behavior letter. Following are the steps involved in Discipline management:
i. Add incident type
ii. Add resolution type
iii. Add items type involved in incident
iv. Create behavior referral
v. Add participants
vi. Create hearing/meeting
vii. Add final decision/resolution
viii. Send behavior letter to parents

The dynamic user is provided with health management access. Health Management officer will first do setup for different configuration type. This configuration type includes certificate, exemption, screening provider, waiver reason, office visit type, and the like. After adding configuration data, the health management officer will do setup for health condition and type of screening that will be performed for students. Then health management officer will do setup for screening details by selecting different screening data which was added by the officer. Thereafter, the health management officer will do screening outcome setup. The health management officer will then perform setup for screening details result.

The health management officer can also perform vaccination setup by adding number of doses and the number of vaccinations required. The vaccination rules are also setup in which the vaccination rules associated with each dose is mentioned. After adding the vaccination details, the health management officer will associate vaccinations with grade level. This enables to identify students that will require specific vaccinations.

The health management officer can also add heath data and student conditions for each of the students. Depending on the screening required for the students, the health management officer can also add screening waiver by selecting appropriate waiver reason. The health management officer can also add vaccination details for each of the student. While adding vaccination details, the officer will make selections for vaccination names associated with grades, exemption types, certificate type and will select number of vaccination doses required for each student. The health management officer can also send the vaccination alerts for the students as well as parents. The status update of vaccination for each student is also recorded that includes number of doses completed and doses provided date. The following are the steps for Health Management Dataflow:
i. Adding configuration data.
ii. Adding health condition and screening data.
iii. Setup for screening details data.
iv. Setup for screening outcome.
v. Screening details result setup.
vi. Adding vaccination data.
vii. Performing vaccination rules setup.
viii. Associating vaccination type with the grade level
ix. Adding screening waiver for students.
x. Adding screening details for each student by selecting screening type, waiver, date, provider type and name.
xi. Adding vaccination details for students.
xii. Send vaccination alert for students and parents
xiii. View schedule
xiv. Adding student office visit details.
xv. Adding employee office visit details.
xvi. View all office visit report.
xvii. View overall report.

Providing certificate status as completed, partially completed or pending.

The ERP 217c also maintains data of HR and payroll, double entry accounting and, leave and health records. The Layer 210 is a single point of data entry 218 and data populates to all other modules of the IEMS 116. The Layer 209 is the core layer of the IEMS 116 as it includes information of the learners, learning management and resource planning, and the like.

The student leave management includes prerequisites, such as student master data, general configuration, scheduler/time table, attendance setup configuration and leave quota setup from admin login. The parent/student can send leave request for any course. The leave application is traversed for approval from their respective class in-charge or course in-charge. In case the leave request is more than three (3) days, leave can be approved/disapproved by higher authority only. If the leaves are approved, they will automatically be marked as leave in attendance records.

The following are the data flow of student leave management:
i. Send leave request for all course/single course.
ii. Approval/disapproval of leave request from class in-charge or higher authority.

The features of student leave management include leave approval for submission under parent/student module, communication with teachers, online leave approval/disapproval by faculty/class in-charge, and integration with attendance.

The faculty leave management include faculties sending leave from their login by selecting dates and it will then be sent to Human Resource (HR) department and Payroll department for approval. After approval from HR, it will automatically mark leave in the attendance. The following are the data flow of Faculty/Staff leave management:
i. Send leave request to HR and Payroll department
ii. Approval/disapproval of leave request

The features of faculty leave management include leave approval for submission under faculty module, Online leave approval/disapproval by higher authority and integration with attendance.

Accounting configuration should be step up first prior to starting accounting transactions in different modules. In this configuration, user will define closing process, financial year, accounting period setup, account type creation, chart of accounts, different transaction types, validation process, approval process. The features of the accounting configuration include defining closing/carry forward process, financial year creation with accounting period details, account types and chart of accounts creation, control account, budgetary account creation; capital and fund balance account setup access based transaction types, validation process with credit and debit access, and approval process setup for each transaction type.

Budgeting

Prerequisite: Accounting configuration like financial year and period setup, account types, chart of accounts, budgetary accounts setup, transaction types, approval process, validation process.

Data Flow: Adding super area, committee/area setup, revenue/expense head, revenue/expense line items, Budget amount setup, budget modifications, budget approval, budget opening entry and budget report.

Features: Budget configuration; Super area; Committee area setup; Budget amount setup in different line items under revenue/expense head; Revenue/expense head mapping with general ledger accounts; Complete approval process of budget amount and budget opening entry.

Cashier

The prerequisite includes accounting configuration like financial year and period setup, account types, chart of accounts, budgetary accounts setup, transaction types, approval process, validation process.

Data Flow: Opening entries, journal entries, all cash and bank transactions, vendor payments, customer receipts, cancellation of transaction, petty cash configuration, General Ledger (GL) entries, all ledger access.

Features: Opening entries assign the amount of all the main accounts like capital, asset, liabilities, revenue and expenses for starting the accounting process like manual cash payments, manual cash receipts, all types of journal transactions like prepaid expenses, goods taken by a proprietor, outstanding expense, outstanding income, income received in advance, interest on capital, interest on drawing, interest on investment, interest on loan, bad debts, and the like.

Configuration of petty cashier and cafeteria cashier: Assigning amount and transaction limit to petty cashier and cafeteria cashier. The Cashier has access to cancel all types of invoices, vouchers and payments. The Cashier has access to view all ledgers like T-Ledger, Sub Ledger, General Ledger and all other useful reports.

Petty Cashier

The prerequisite includes amount allocation and transactions limit setup from a main cashier login

Data Flow: All the petty cash entries will be done by petty cashier

Features: Petty cashier do the petty entries on daily basis within the defined amount and transaction limit

Payables

The prerequisite include all committee/area, event management approvals—Administrator master data setup

Data Flow: The payables will do vendor creation, vendor configuration, cheque printing configuration, tax setup, complete purchasing process, vendor invoicing and payments, others manual expenditures, over payments, manual journal entries, adjustments, refund process, general entries and all types of ledger

Features: Complete purchasing process: Purchase Order (PO) creation and approval, Request for Proposal (RFP) creation and approval, vendor invoice creation and approval, vendor invoice payments and approval. Further, multiple invoice creation, multiple invoice payments are also performed at the same time.

Procurement Management

The prerequisite includes all committee/area, event management approvals—Administrator master data setup, all user setup—Administrator master data setup

Data Flow: Committee/Area setup, line items and amount setup, budget approval, the users will do purchasing requisitions from their respective logins. The requisitions will travel to the defined approvers and approvers then approve or disapprove the requisition based on the budget available. After purchasing requisition approval, payable will send the RFP to vendor and vendor may revert with the PO. Then PO will be sent for the approval. Thereafter, the Vendor will send the invoice and payables will record the invoice and send for approval and after approval of vendor invoice payable will do the payment to vendor.

Features include three types of purchasing process and expense process:

i. Normal purchase order process

Step 1: Request for asset or inventory from user login.

Step 2: Request approval from defined user (teacher, Head of Department (HOD), other officers, district head/principal, superintendent/management and then payables)

Step 3: RFP (Payable Login)

Step 4: RFP approval from the defined user (teacher, HOD, other officers, district head/principal, superintendent/management and then payables)

Step 5: Send RFP to vendor

Step 6: Create PO

Step 7: PO approval from the defined user (teacher, HOD, other officers, district head/principal, superintendent/management and then payables)

Step 8: After purchase order approval record invoice from the vendor

Step 9: Invoice approval from (payables, dynamic accounting user, other users, district head/principal and management)

Step 10: Payment to vendor

ii. Committee/Area Purchase Order Process

Step 1: Create committee/area from budget admin login

Step 2: Add committee member

Step 3: Add committee budget from budget admin

Step 4: Budget approval from defined user (principal and management)

Step 5: Budget opening entry

Step 6: Requisition for PO (Committee member login)

Step 7: Request approval from the defined user i.e. committee/area head, other officers, district head/principal and superintendent/management

Step 8: Request for RFP (payable login)

Step 9: RFP Approval from the defined user

Step 10: Send RFP to vendor (payable login)

Step 11: Create PO (payable login)

Step 12: PO approval from the defined user

Step 13: After PO approval, record invoice from the vendor

Step 14: Invoice approval from committee head, other officers, district head/principal and superintendent/management)

Step 15: Payment to vendor (payable login).

iii. Committee/Area event PO process

Step 1: Create event from committee/area member login

Step 2: Add event member

Step 3: Add event budget

Step 4: Event Budget approval from committee/area head, other officer, district head/principal and superintendent/management

Step 5: Requisition for PO.

Step 6: PO Request approval from committee/area head, other officer, district head/principal and superintendent/management

Step 7: Request for RFP.

Step 8: RFP approval from the defined user (committee/area head, other officer, district head/principal and superintendent/management)

Step 9: Create RFP

Step 10: Create PO

Step 11: PO approval from the defined user (principal and management)

Step 12: After purchase order approval record invoice from the vendor

Step 13: Invoice approval from (principal and management)

Step 14: Payment to vendor

iv. Committee/Area event expense process:

Step 1: Requisition for event activity.

Step 2: Event activity approval from committee/area head, other officer, district head/principal and superintendent/management

Step 3: Advance payment after approval

Step 4: Event advance approval from (other accounting users, other officer, district head/principal and superintendent/management)

Step 5: Event expenses report

Step 6: Event expenses report approval from defined user (committee/area head, other officer, district head/principal and superintendent/management)

Receivable

The receivable will do the customer creation, customer configuration, property tax setup and configuration, others manual revenues, manual journal entries, adjustments, refund process, general entries and all types of ledger.

Features: Customer creation and fund association, customer invoice creation and approval, customer receipts and approval.

Property tax account creation and fund association, property tax invoice creation and approval, property tax collections and approval.
i. Cancellation of invoices, refund overpayments and refund/closure of the transactions.
ii. GL entries and all types of reports and ledgers.
iii. Other transaction like Accrual of federal aid.

Fee Accounting

The prerequisite includes student master data setup—Administrator Master Data Setup.

Data Flow: Students ledger account creation and mapping with GL account. Fee type creation and association with GL account, fee type amount setup for single and multiple programs. Assign different fees to single/multiple students in different ways. Student scholarship, discount, adjustments setup. Student fee invoice creation, cancellation, fee receive and over payments, refund, refund with closure, and the like.

Features: Student ledger account creation to maintain student ledger, fee types creation and amount setup, setup of transportation, cafeteria, hostel/dorm fee and library fee. The students can have different types of fee as per their choice of facilities. Any fee Cancellation will revert the entry and allow to reset the fee for student same for received fee. Refund the fee and closure of the fee account for the student. Advance fee receiving from the student and can adjust the advance fee in the pending fee invoice.

Online Payment Gateway Integration

Prerequisite: Bank API, Student master data, Accounting configuration data and Fee details

Data Flow: Student/parent will make payment from their login by selecting online payment method and system will automatically redirect to bank payment gateway. After the payment, bank payment gateway will automatically redirect to student/parent dashboard. The payment status automatically gets updated by getting the response from the bank. However, if a transaction fails, or connection break down then authentication status is updated.

Features: Online transactions with different banks and different types of security checks along with API support.

Help Desk

Prerequisite: Helpdesk officer should be added in the system. Student master data, faculty master data and parent details must be added in the system.

Data Flow: At first Help desk officer will set up rules for query handling. Rules are set by entering issue category name and by assigning related officers to the issue category. Issues will be logged by students/teachers/parents. The user will log issues like infrastructure, maintenance, lack of library books. Once any user logs issue based on issue category and priority basis, help desk officer will view the issue and forwards it to respective officer who has been assigned to resolve it and he can periodically check the status of issue, after it is being forwarded to other officers. The help desk officer and user who have logged issue will communicate regarding the issue status by raising questions in comment section. Other officers will view the issue and resolve it based on priority basis. After the issue is resolved by assigned officer, it is again forwarded to help desk officer. The help desk officer will view the resolved issue and change the status of issue from ‘Pending’ to ‘Completed’ if it is resolved completely. Finally help desk officer can view query/issue reports based on category, priority and issue status. Following are the steps involved in resolving issue:

i. Rules setup for query handling

ii. User logs issue

iii. Help desk officer forwards it to respective officer.

iv. Assigned user resolves the issue

v. Help desk officer change the status of issue if it is resolved.

Features: Rules set up for query handling, log issue from different users, forward issue by help desk officer to other officers, resolve issue by assigned officer, change issue status by help desk officer, view issue status reports.

As all the IEMS 116 functionalities are associated with the Layer 209, customizing forms and multiple ways for entering same data will need less efforts and administration. The one-time entry of all information in the central database can be used in all the functionalities 206 of the Layer 209. Further, information management features in the Layer 209 include interfaces like special education, state reporting, distance education, multiple design structure/interfaces, and the like. Similarly, the learning management features in the Layer 209 include, but are not limited to, lesson structure, advance grading, collaboration tools, sharing methodologies, online examination with check-in mechanism, multi-level approval process and the like. This also includes school complex business processes like Event-Area management, Purchase Order approval process, fee management with section-based setup. All modules can work independently and can be assigned to any roles. However, the IEMS 116 allows all the modules to interact with each other and data entered through any module can be used by another module for modification or reporting purposes.

At the Layer 210, the learning plan group 204 provides learning plans 219 for learners. The learning plans 219 is provided based on learning plans created by a teacher and based on performance of a learner. The learning plans 219 can be classified into teacher driven learning plans 219a and performance driven learning plans 219b. The Layer 210 is associated with a machine learning based analytical tool and recommendation engine that helps in creating individual and personalized learning plans. The individual and personalized learning plans are created based on certain criteria like student competency scores. Thus, the learning plans 219 is created based on assessment results (i.e., the competency scores) of the learner. The assessment results are obtained from course 1 . . . n student assessment results 220. The course 1 . . . n student assessment results 220 are analyzed and if expected competency not achieved then analyze problematic area and identify content 221. The analysis result is then used to generate the learning plans 219. The learning plans 219 are provided to the learner for student learning 222. The learning plans 219 provided to the learner is an individual learning plan 223 that can be learnt at suitable time, path, place and pace of the learner.

Typically, most of the schools use instructional methods to teach students and they are evaluated at fixed time intervals by performing assessments. The schools use economically convenient methods, where students are evaluated and taught in groups. Hence, individual attention is not paid to each student, which affect student learning. To improve this, the Layer 210 enables the educational institute to create individual and personalized learning plans that are made available to the students for learning. This approach takes into consideration the student's problematic areas where course learning outcomes are not met. Individual learning plans help addressing the individual student problems, by the organization and sequencing of course content. Some of the modules included in the Layer 210 are defined below:

Attendance Management and Profiling

Content Structure: This includes standards-goals-learning outcomes mapping tool, Unit and lesson planning. In this module, standard types, standard levels, standards, goals and learning outcomes are mapped to each Unit/lesson object.

Learning Objects: This includes online notes, content authoring tools, online assessments, workspaces, forums and discussions, Group Discussions (GD).

Collaborative learning Objects: This includes workspaces, forums and discussions.

Evaluation Objects: This includes tasks such as Homework, Exams, Class Tests, Projects, Labs, Viva Voce, Assignments, Group Discussion, Attendance, Online Assessments, and the like.

Appraisal Management: This includes student reports, pictures, course assessment, personality traits and general behavior records.

Advanced grade management: This module provides unique grading scheme structure and propagation mechanism.

Communication Objects: This enables online communication like alerts, internal/external emails, notice, circulars and academic calendar.

Discussion Objects: This provides access to forums and discussion

Learning System for teachers, Goals Management for teachers

Some of the other modules in addition to the above are advanced planners, teacher feedback tools, grade analyzer tools, and the like. In addition to this, the Layer 210 also includes a recommendation engine, individualized learning and individual learning plans which include different modules. Some of them are explained below:
Analysis Tool and Recommendation Engine: This module uses data analytics algorithms and machine learning to calculate each student competency levels and competency score for each course. The scores are calculated for each lesson and unit from following areas:

i. Student scores from online assessments and quizzes

ii. E-learning quizzes

iii. Student profile and cognitive skills

iv. Parent involvement

v. Teacher feedback

vi. Student Scores from Homeworks, Assignments, class tests, projects labs
Individual Learning plans: Based on competency scores for each lesson and unit, student profiler, content profiler, the machine learning enabled engine recommends the individual learning plans. There are multiple types of learning plans that can be generated in the IEMS 116. For the sake of clarity, some of the learning plans are described and mentioned below:

i. Daily learning plans: The Daily learning plans is provided to a group of students, independent of student performance.

ii. Teacher driven group plans: This plan is provided by teachers to a group of students and are independent of student performance.

iii. Teacher driven individual learning plans for each student: In this learning plan, a plan is created without involving the student performance. These plans can be created for whole class or for individual student. Purpose of this learning plan is to present a well-organized way of selected content for student revision.

iv. System generated learning plans for each student: This provides performance-based learning plans that can be used after the evaluation of student performance in Assessments/Online Exams from all types of learning content, as plans are directly linked with learning content. Based on objective (Learning Outcome) status and standard competency score, student overall performance (Competency Score) is calculated. Multiple reports from Analysis Engine along with system recommended student revision/learning plan are shown, which teacher can use to create ILP with modifications if needed. In an embodiment, the teachers can also modify these learning plans and provide customized learning for each student.

There are various uses of individual learning plans for the students. For the sake of clarity, some of the uses are mentioned below:
Each student using the software can be assigned multiple learning plans for each course.
The students can select and activate a single learning plan for ease of use.

The use of individual learning plan is also explained using a following example. For example, a student ‘A’ has five (5) courses assigned to him/her and each course has one or more learning plans, and one of the five courses say ‘ELA’ has four individual learning plans, i.e. ELA-1, ELA-2, ELA-3, ELA-4, assigned for the student ‘A’. The student ‘A’ can then activate only one (1) learning plan at a time. Hence, if the student ‘A’ activates plan ELA-2, then learning plan ELA-2 is visible on all screens, through a proprietary hide/show mechanism. The student ‘A’ can move step by step for the activated plan and go through the different learning objects and assessments. In an embodiment, the learning objects/assessment/items of each individual learning plan can be locked down in order. In general, the student must learn as per the order provided in the plan for maximum benefits. The teachers can also observe and monitor the progress of each student for each assigned learning plan and they get multiple reports on the activities. The teachers can re offer learning plans to students.

The unique methodology of the advanced learning management system with recommendation engine and individual learning plans offers:
Content Structure: Standards-goals-learning outcomes mapping tool, Unit and lesson planning. Standard Types, Standard levels, Standards, Goals and Learning outcomes are mapped to each Unit/lesson object.
Learning Objects: Online notes, content authoring tools, Online assessments, Workspaces, Forums and discussions, Group Discussions. All learning objects mapped to Units/lessons
Collaborative learning Objects: Workspaces, Forums and Discussions. All collaboration objects mapped to Units/lessons
Evaluation Objects: Task group (Homework, Exams, Class Tests, Projects, Labs, Viva Voce, Assignments, Group Discussion, Attendance), Online Assessments, Workspace Each assessment type is mapped to learning outcomes. For example, questions of exams are mapped directly to single learning outcome and homework, assignments, projects mapped to one or more learning outcomes.
Appraisal Management: Student reports, Pen picture, Course Assessment, personality traits, general behavior records.
Advanced grade management: Unique grading scheme structure and propagation mechanism, Grade entry from 9 different screens, Normal scoring, Letter Grading, Rubrics based grading, Grading for Learning outcomes.
Analysis and Recommendation Engine: Identification of learning needs of students, identifications of problems in content and evaluation questions, calculation of competency scores for each student for each lesson
Customized Individual learning plans for each student: Recommendation of personalized plans for each student based on their competency score and competency level for each lesson and unit.
Unique methodology that activates only a single learning plan for learning at a point of time.

The Layer 211 includes the customized and personalized learning group 205 that provides personalized learning plans. The personalized learning plans are governed by algorithms based on mastery and reinforcement learning that provides a personalized learning experience to the students. The personalized learning plans are provided with support of intelligent system-tutors, teachers and facilitators. The teachers, students, and parents can create and share curriculum, content, and learning resources. The customized and personalized learning group 205 also allows the parents to create individual learning plans and offer students those individual learning plans which can also be shared with other parents.

In an example embodiment, a course, such as course 1 . . . n unit 224a is broken down into unit lesson 1 of (L1, L2, . . . , Ln) 224b. From the unit lesson 1 of (L1, L2, . . . , Ln) 224b, a collection of notes, content pages and practice quizzes 224c are created. The collection of notes, content pages and practice quizzes 224c is provided to a learner to achieve a mastery level. An assessment of the learner can be performed through a lesson mastery exam 224d. The assessment result is analyzed to check if mastery of lesson 224e is achieved at 224e. If yes, the learner can move to unit next (lesson 1 . . . n) 224f. Otherwise, if the learner has fails the mastery exam, then using algorithms 224g, such as (algorithm 1, algorithm 2, . . . , algorithm n) 224g, the old collection (i.e., the collection of notes, content pages and practice quizzes 224c) is updated into a new collection of new and old notes, new and old content pages and practice quizzes 224h. The assessment of the learner is again performed to check the learner qualifies the mastery exam 224d. If the learner qualifies then the unit next (lesson 1 . . . n) 224f is provided to the learner. For the unit next (lesson 1 . . . n) 224f, assessment of the learner is performed through another unit mastery exam 224i. The result is checked if the learner has achieved mastery 224j. If the learner has achieved mastery 224j then course 1 . . . n next unit 224k is provided to the learner. Otherwise, unit lesson 1 of (L2, L4, . . . Ln) 2241 is used for generating the collection of notes, content pages and practice quizzes 224c.

The Layer 212 (i.e., the subscriber and facilitated learning network 206) includes a machine-learning based Intelligent SaaS Platform that provides a personal Intelligent Agent, such as Intelligent Agent (IA) 225. In at least one example embodiment, the IA 225 provides each learner the individual personalized learning plan (e.g., the individual learning plan 223). The individual learning plan 223 empowers the learner to learn at their own choice of time, place, pace, and on a customized learning path suitable to the learner. As individual learners need customized support to fully develop their individual learning potential, the IEMS 116 plans to educate all learners to mastery levels. This is achieved using the Intelligent Agent 225 that tutors each learner on demand (any time, place and pace) using one or more components of the IEMS 116. The Intelligent Agent 225 that tutors the learner for each course forms an education agency.

The machine learning based analytical tools and engines also generates learning recommendations for each student. The learning recommendations are also generated for teachers and for courses set for the learners. It offers multiple types of individual learning plans for learners that are configured and customized by the teachers. Through the subscriber's network, users (e.g., students and parents) can subscribe to learn any course and the IEMS 116 recommends a cluster of courses, such as course clusters 226 to the users. The users can select and choose the cluster-course combination.

At the layer 212, a student 227 and a parent 228 can subscribe to the subscriber and learning network 206 to create a course. The parent 228 can prepare a course for their children. The student 227 and the parent 228 perform a registration 227a and registration 228a respectively. Both the student 227 and the parent 228 can register for limited period free subscription 229a and fee payment 229b subscription. After the registration, a student account is created at 230. After the student account creation 230, content creation 231a is performed to provide learning content, videos, apps as well as shared content from other parents or students. Further, content such as content 231b from third-party providers and independent content providers can be accessed. The content 231a and 231b undergo an approval 232 phase. The approval 232 includes multi-level approval by facilitators of IMES 116. After the approval 232, the course clusters, 226 are generated. From the course clusters 226, a course cluster is selected through a course cluster selection 233. The subscriber and facilitated learning network 206 allows the parent 228 to share the units (e.g., the unit lesson 1 of (L1, L2, . . . Ln) 224b and unit (next lesson . . . n) 224f), notes (e.g., the collection of notes, content pages and practice quizzes 224c and the collection of new and old notes, new and old content pages and practice quizzes 224h), e-learning sets, evaluation resources and learning plans with multiple users by authorizing their individual sharing codes.

The customized and personalized learning based on mastery learning and reinforcement learning is explained below:
The Intelligent Agent 225 provides automatic individual learning plans for users based on performance indicators, content profiles, evaluation profiles and learning outcome profiles.
The Intelligent Agent 225 can also modify the learning plan based on learner performance and content profile and improves its knowledge of recommendations
The teachers/content writers focus on modification of curriculum map and content and Facilitators can manage courses and content.
The IEMS 116 also provides a paid service in which users pay subscription fees and revenue generated is shared between the company and clusters of teacher lesson-planners, network resource facilitators, and users who share highly-rated curriculum, content, and learning resources.
The users can monitor and manage progress along with the system. (e.g. activate/deactivate parts of the course learning plans).

In one embodiment, the IEMS 116 is offered as a first software version that provides a service on a private cloud infrastructure where a plurality of users of the educational institute can get an individual installation and multiple instances of the IEMS 116. In the embodiment, a separate private cloud for each user is provided and there is no interference between different installations or instances. In the embodiment, the clients can select and choose from various modules/processes from the IEMS 116.

Examples of the modules and functionalities of IEMS are shown in the Table 1 below.

TABLE 1

| Educational Information | | |
|---|---|---|
| System Modules | Learning Modules | Other Modules |
| 1. Administration and | 1. Faculty, Teacher and Assistant | 1. Library Management |
| Information Management | | |
| 2. Faculty Admin and | 2. Student and Parent Module | 2. Employee Master, HR and |
| Info. Management | | Payroll, leave management |
| 3. Student Registration | 3. Advance Grading System | 3. Employee Appraisal |
| & Enrolment | | |
| 4. Scheduler and | 4. Attendance Management | 4. Fee Management |
| Automated Time-table | | |
| 5. Discipline Management | 5. Assignment/Task Management | 5. Petty Cashier |
| 6. Online, Direct | 6. Learning system for Teachers | 6. Accounts Payables |
| Admission and Registration | | |
| 7. MIS and Reporting | 7. Curriculum Mapping- Units, | 7. General Ledger |
| | Lessons | Accounting |
| 8. Exam and Room | 8. Content Authoring Tool | 8. Accounts Receivables |
| Schedule | | |
| 9. Session Change | 9. Online Notes & Content | 9. Cash Accounting |
| Management | Management | |
| 10. User Logs and | 10. Online Assessments/Exams & | 10. Budget Management |
| Snapshots | Instant Quiz | |
| 11. Distance Education | 11. Online Communication, Alerts | 11. Procurement |
| | and Emails | Management |
| 12. Alumni Module, | 12. Forums and Discussions | 12. Event & Area |
| Help Desk | | Management |
| 13. Batch Job Module | 13. Dynamic Reports & Snapshots | 13. Inventory |
| | | Management |
| 14. Transcript | 14. Surveys, Feedback and Planner | 14. Online Payment |
| Management | | Gateway Integration |
| 15. Course Curriculum | 15. Student Grade Analyzer Tool | 15. Training and |
| | | Placement |
| 16. Director, Management, | 16. Group Discussion/Class | 16. Leave Management |
| Principal Logins | Participation | |
| 17. Dynamic Roles for | 17. Academic Calendar, Events & | 17. Transport |
| all Officials and Staff | Activity | Management |
| 18. ID Card Generation, | 18. Workspaces- Collaborative | 18. Dormitory |
| Staff Management | Learning | Management |
| 19. Dynamic Sub | 19. Advance Online Drive Storage | 19. Fixed Asser |
| Admin Module | | Management |
| 20. User Profile | 20. Planners, Student Appraisal | 20. Staff recruitment, |
| Management | Management | teacher training |
| 21. Health | 21. Course Evaluation/Teacher | 21. Cafeteria |
| Management | Feedback | Management |

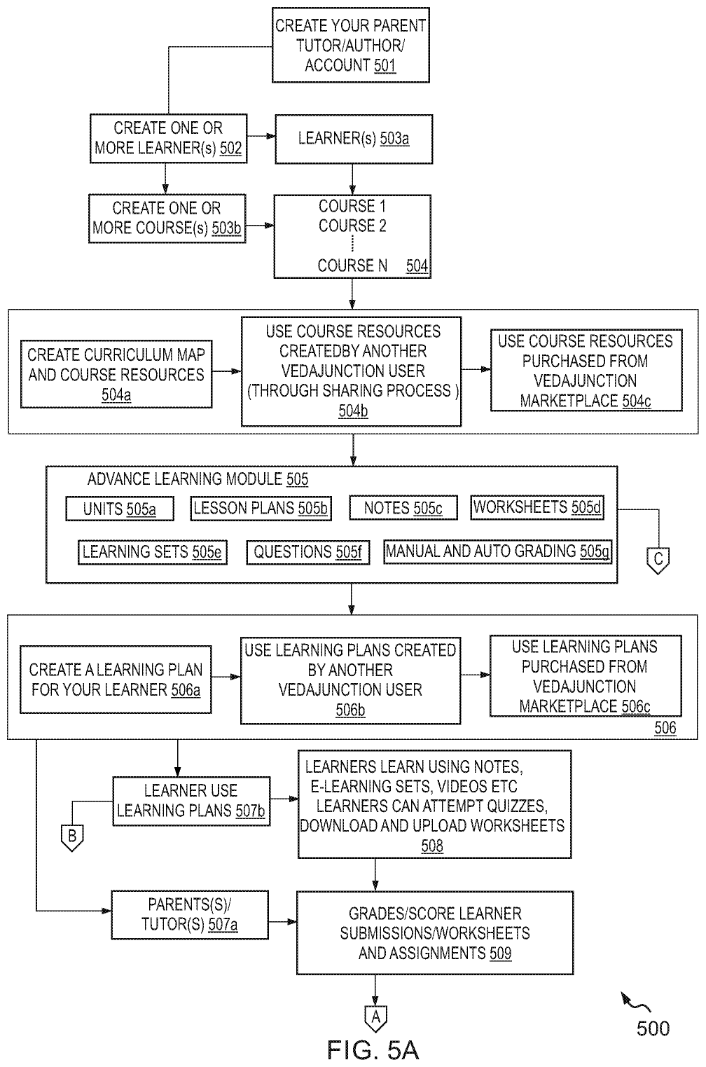

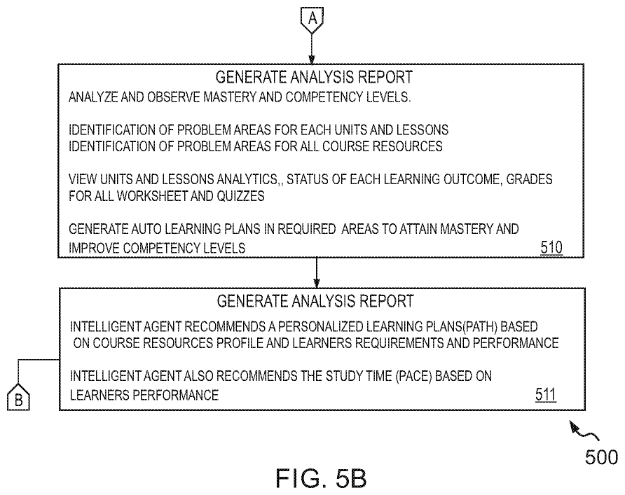

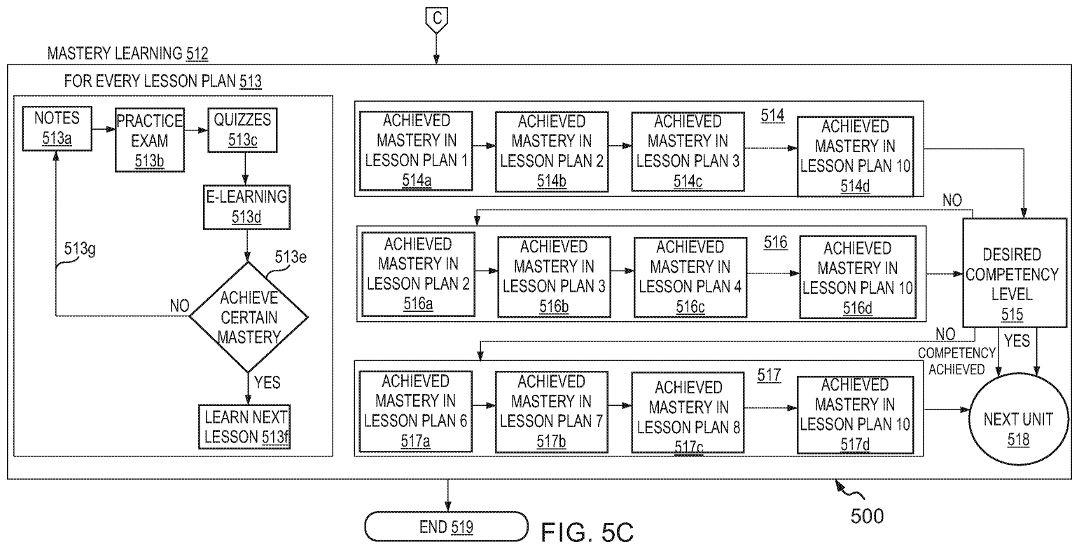

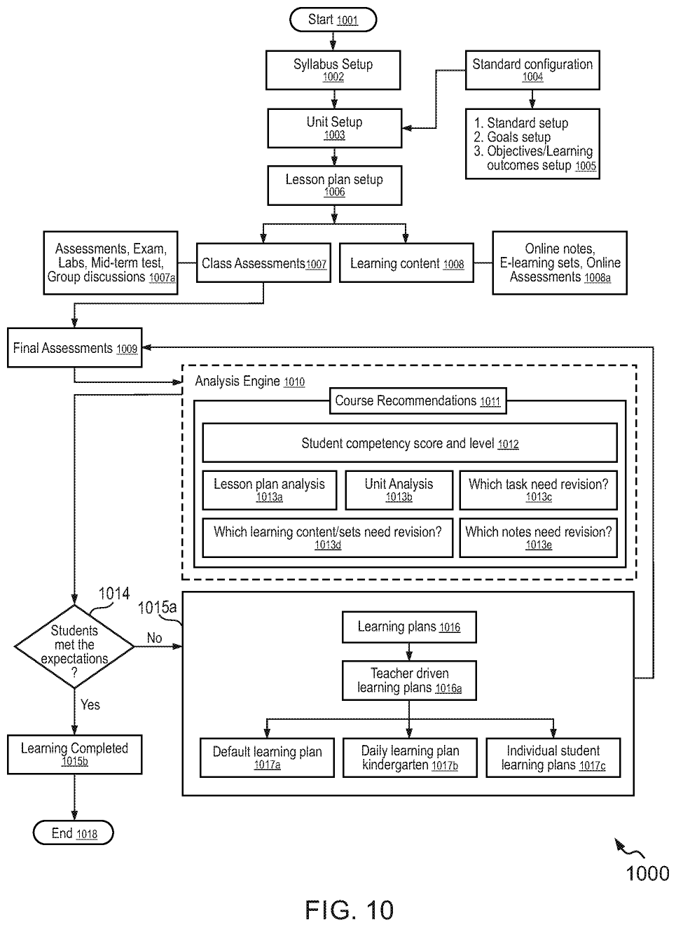

In an embodiment, the recommendation engine (shown in FIG. 10) and individual learning plans package and modules (refer FIGS. 5A and 5B) are placed on top of the advanced learning system module. In the embodiment, the modules are finalized in the instance and the implementation process takes place where multiple steps are performed to get the system ready for use. Initially, a super administrator and/or an administrator are created and assigned core roles using core elements like organization, session and financial session. The administrator performs different task of creating other users and logins. This first software version is offered as a subscription model.

In another embodiment, the IEMS 116 is offered as a second software version (Veda Junction) where the facilitated and subscriber learning network 206 is built on top of all the modules and is offered as a cloud service. The second software version provides personalized learning with the support of intelligent system-tutors, teachers and facilitators. The teachers, students, and parents create and share curriculum, content, and learning resources. Additionally, the parents can create individual learning plans and offer them to the students and share with other parents. The software also provides an intelligent agent for each course which is a part of the facilitated and the subscriber network module. The intelligent agent provides automatic individual learning plans for learners based on performance indicators, content profiles, evaluation profiles and learning outcome profiles. The intelligent agent also modifies the learning plan based on learner performance and content profile and improves its knowledge of recommendations. Through the IEMS 116, the learners can subscribe to learn any course and the IEMS 116 may recommend a cluster of courses to the learners. Thereafter, the users/learners can select and choose the cluster of course combination.

The IEMS 116 also provides a paid service (Veda Junction) option in which the users pay subscription fees and thereafter revenue generated could be shared between company, teacher, planners, network resource facilitators, and users who share highly-rated curriculum, content, and learning resources. The users/learners can monitor and manage progress along with the system and may even activate or deactivate parts of the course learning plans. The IEMS 116 can also integrate with third party software to provide external accreditation and certifications.

The IEMS 116 is a single application that caters to all the need of the educational institutes and has one centralized database, thereby eliminates the need of having multiple systems. The architecture of the IEMS 116 comprises of a single large database with multi-layer structure. Each layer (Layer 207-212 as shown in FIGS. 2A, 2B and 2C) is loosely coupled with other layers and are dependent on central database layer (Layer 207). The data flows between each layer in very efficient way which minimizes the setup/data entry effort and maximizes staff output. This ultra-efficient layered structure also enables user to have SSO (Single Sign On) and user can access all needed information in single login. The layered structure model hence can also be used as a Plug n Play model and the implementation of the IEMS 116 only involves setup of configuration and basic user data to start using it. The IEMS 116 also allows easy data migration between servers and is easily manageable. The IEMS 116 also eliminates redundancy and accuracy by having a centralized single database. The users through the IEMS 116 can navigate to different functions using few click of the mouse. In addition to managing all the functions of a single educational entity it can easily be modified or expanded to manage state/districts/country level educational institutes. The different layers (Layer 207-Layer 212) are coupled and integrated in such a way that it becomes for the educational institute to modify the IEMS 116 as per their needs. The different layers of the IEMS 116 is described below:

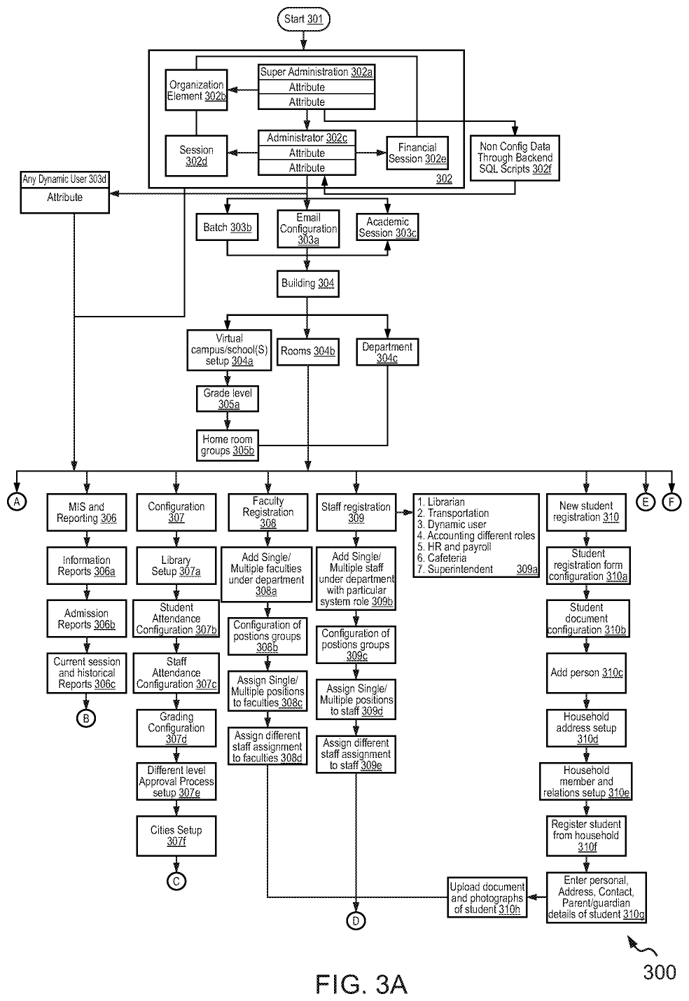

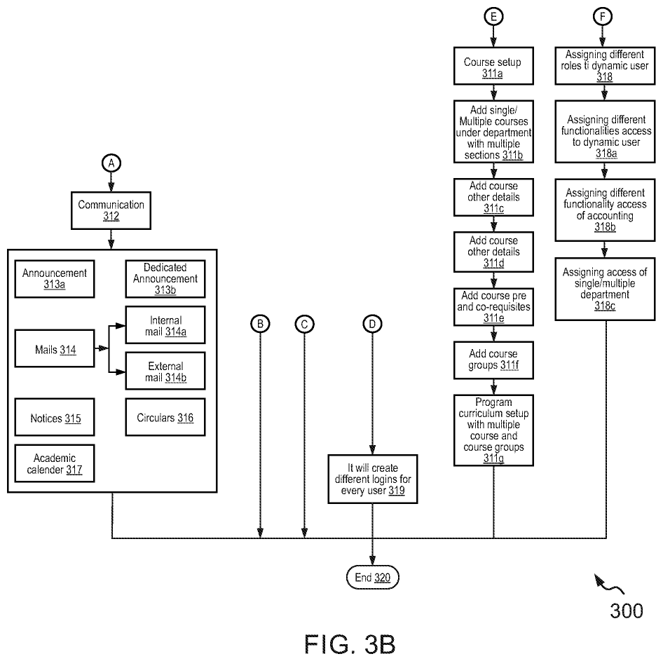

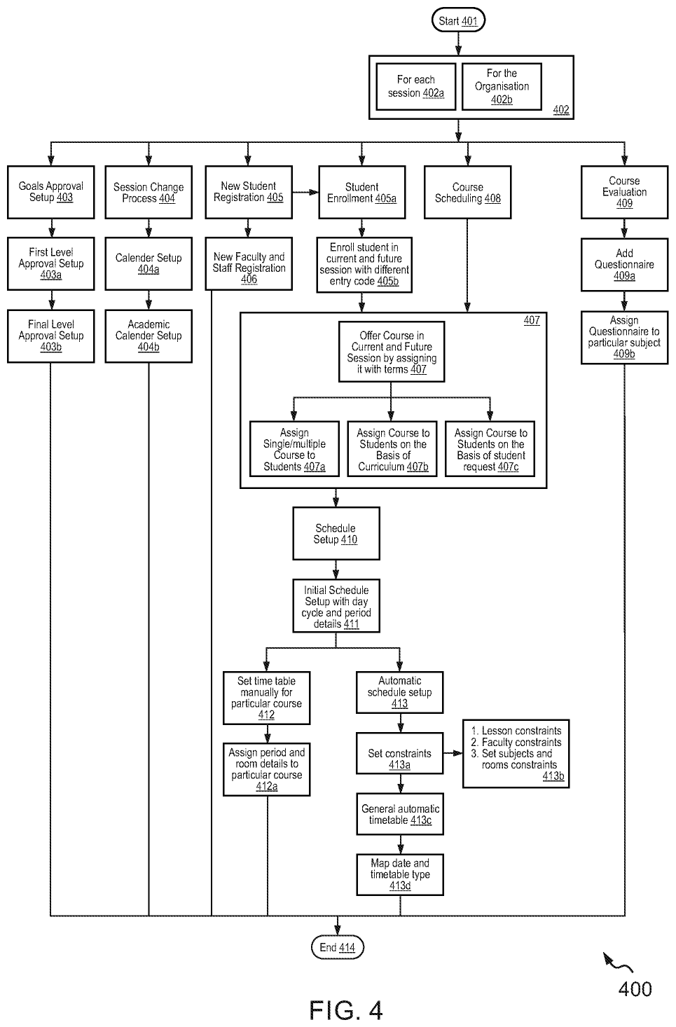

FIGS. 3A, 3B and 4 depict flow diagrams (300, 400) that illustrate basic configuration and single point entry of data elements in the IEMS 116, in accordance with an example embodiment of the present invention. The flow diagram depicts 3 core elements, such as organization, session and financial session along with 2 core roles, such as super administrator and administrator.

At start 301, the basic configuration and single point entry of data element starts. This step involves setup and installation processes, such as a setup for private cloud, application server installation and database server installation. Once the setup and the installation are complete, the IEMS 116 is installed. After installation of the IEMS 116, database statements, such as trigger and procedure are installed.

At 302, a login of a first administrator 302a, such as the super administrator 302a for super administration is created. A user having the super administrator role in the IEMS 116 handles creation of a virtual organization, such as university, district, school trust. The super administrator provides data for non-configuration data through backend SQL scripts 302f.

The virtual organization is created using organization element 302b. This element is a unique identifier that represents a virtual organization in the IEMS 116. The organization element 302b establishes an Org ID that is defined by a legal name, postal address, and points of contact. The organization element 302b can also establish more than one Org ID and is responsible for handling the user roles and information records associated with each one. The Org ID is the core element and directly associated with all information stored in a database (e.g., the database 207 of FIG. 2C).

Further, the super administrator 302a referred to hereinafter as super admin 302a creates second administrator as a general software administrator, such as administrator 302c for the virtual learning organization. The non-configuration data through backend SQL scripts 302f is provided to the administrator 302c. A user having the administrator role 302c has access to all features in an admin console and can manage every aspect of the organization's account. Once the administrator login is created, the login of super admin 302a is de-activated. An administrative work is a broad category that includes all configurations, setup and other administration work.

For the virtual organization, a session 302d is created using session element. The session element is used to create, a session ID. The session ID is a unique number that is associated with each academic session of the organization. Multiple academic terms can be part of single session ID. Session information/data like course associations, schedule, content etc. are directly associated with the session element.

Further, a financial session 302e for the organization is created using financial session element. The financial session 302e provides a unique ID that is associated with Financial/Fiscal Year of the organization. The unique ID represents an annual time-period at the end of which the organization accounts are closed in order to calculate their budgets, revenue and expenses. All accounting data is directly associated with the unique ID of the financial session 302e.

The administrator (admin) 302c user performs various configurations, such as email configuration 303a, creation of batch 303b and academic session 303c configuration to create a required system for the organization. The administrator 302c also creates other user roles, such as any dynamic user 303d. The any dynamic user 303d that includes student, teacher, parent, or other officers are configured (includes entering records and maintaining data) by the administrator 302c. Post creation of the dynamic user 303d, the admin 302c assigns different roles as per preference of the user by assigning particular functionalities to the dynamic user 303d. In this step, single/multiple department access are assigned to the dynamic user 303d.

The various configurations along with prerequisite required for each configuration and data flow are explained below in the following steps:
Email Configuration 303a:

Prerequisites: Organization Setup and Admin User Setup

Data Flow: The admin 302c first performs setup of email credentials. The admin 302c then performs setup of domain, port and server for the organization.
Batch creation 303b:

Prerequisites: Organization setup and Admin User setup

Data Flow: Batch creation 303b is the next step in the process flow. Batch 303b is independent of academic session 303c and synonymous with graduating class or all the years within it like Batch/Class of 2017 or 2015-17 batches.
Academic Session 303c:

Prerequisites: Organization setup and Admin User setup

Data Flow: The admin 302c creates the academic session of the organization and associates it with the terms of the virtual organization. This process is repeated for each year when academic year ends.

After the creation of batch 303b and the configuration of the academic session 303c, the admin 302c creates building 304 for the virtual learning organization. The building 304 is created with records, such as name, postal address and location code. Thereafter, under a particular building 304 the admin 302c adds one or more schools/colleges. A virtual campus/school(s) setup 304a is performed by the admin 302c.

In the virtual campus/school(s) setup 304a, the admin 302c will add multiple grade level 305a and home room groups 305b. The admin 302c also performs setup of rooms 304b and department 304c.

The admin 302c performs a general setup for MIS and reporting 306. After setting up the MIS and reporting 306, setup for information reports 306a, admission reports 306b and current session and historical reports 306c are performed by the admin 302c.

After the entire general setup, the next step of the admin 302c is to do basic configuration 307 required for the IEMS 116. Examples of some basic configurations includes, but are not limited to, library setup 307a, student attendance configuration 307b, staff attendance configuration 307c, grading configuration 307d, different level approval process setup 307e, and cities setup 307f.

The admin 302c also does setup of registration details with registration and drop dates. The admin 302c performs setup for faculty registration 308a. The admin 302c adds single/multiple faculties under department 308b, performs configuration of positions groups 308c, assign single/multiple positions to faculties 308c and assign different staff assignment faculties 308d. Further, the admin 302c performs setup for staff registration 309. Staffs of the organization may be registered based on category 309a that includes librarian, transportation, dynamic user, accounting different roles, HR and payroll, cafeteria and superintendent. The admin 302c may add single/multiple staff under department with particular system role 309b, perform configuration of positions groups 309c, assign single/multiple positions to staff 309d as well as assign different staff assignment to staff 309e. The faculty/teacher are added using different single and multiple links under particular department.

After the above configurations, the next steps are to setup information of courses, students, and employees. The next step is to do registration of students in the IEMS 116. In this step, the admin 302c does configuration of student registration forms. Thereafter, the admin 302c adds persons with all basic details. After adding persons, the admin performs setup of household with household members, household addresses and member relations. Further, the admin 302c registers student using these household details by either entering or fetching all the details of students like personal details, address details, contact details, parent/guardian details and other info. The admin 302c performs configuration for new student registration 310, student registration form configuration 310a, student document configuration 310b, add person 310c, household address setup 310d, household member and relations setup 310e, register student from household 310f, enter personal address, contact, parent/guardian details of student 310g and upload documents and photographs of student 310h. After registering the student, the student is enrolled in current or future session with particular entry code during year/session start. Once a student is registered, an ID card for student is then generated. Different link is used by the admin 302c to enroll a student in particular session with entry code. Once the session is completed the admin 302c can exit the student with particular exit code.

After all basic configuration is performed, the admin 302c add courses under departments and schools. In this step, the admin 302c will also create program curriculum for particular grades with multiple courses, course requisites and course groups. The admin 302c performs course setup 311a. In the course setup 311a, the admin 302c may add single/multiple courses under department with multiple sections 311b, add course other details 311c, add course other details 311d, add course pre and co-requisites 311e, add course groups 311f and perform program curriculum setup with multiple course and course groups 311g.

The admin 302c also performs configuration for communication 312 between all users of the IEMS 116. The communication 312 is configured for providing announcement 313a and dedicated announcement 313b and for sending mails 314 that may include internal mail 314a and external mail 314b. The communication 312 also includes notices 315 and circulars 316. The next step by the admin 302c is to setup academic calendar 317. In the academic calendar 317, day types and holidays with selection of dates and months. In this step, the admin 302c will also do setup of marking periods by associating it with terms and start/end dates.

The admin 302c also assigns different roles to dynamic user 318 that include assigning different functionalities access to dynamic user 318a, assigning different functionality access of accounting 318b and assigning access of single/multiple department 318c.

Once the courses, the students, the teachers and the faculties are added, the courses are assigned to the students and the faculties. First, the admin 302c offers course in current future session. Thereafter, the admin 302c may assign single and multiple courses to students manually or using curriculum or assign courses to students on the basis of request from the students. Once the courses are assigned to students, the next step is to assign courses to faculties. Once all the configuration is done in the IEMS 116, the user can generate, view, download (excel, csv or pdf) different types of report for every module.

At 319, the admin 302c will create different logins for every user. At end 320, the various configurations and the single data point entry are completed.

Referring now to FIG. 4, in flow diagram 400, the admin 302c creates a session (i.e., a learning session) and an organization (i.e., virtual learning organization). At start 401, the creation of the session and the organization begins. At 402, the admin 302c provides input data for each new session 402a and for the organization 402b. In an embodiment, all basic and general configurations are performed through the admin 302c login, thereafter the IEMS 116 automatically creates different logins of different users. In an embodiment, the admin 302c may change login credentials of the different users. For example, the admin 30c2c can change password of a user the and provide different usernames and passwords to different users. Thereafter, each user can do their login with particular user names and password. The users can change the password provided by the admin 302c as per their preference.

The admin 302c performs goals approval setup 403 that includes first level approval setup 403a and final level approval setup 403b. The admin 302c also performs session change process 404 that includes calendar setup 404a and academic calendar setup 404b. After the session change process 404, the admin 302c performs new student registration 405 that includes student enrollment 405a and enrolling student in current and future session with different entry code 405b. After the enrollment, the admin 302c performs course scheduling 408. The admin 302c also performs configuration for course evaluation 409 that includes adding questionnaires 409a and assigning questionnaire to particular subject 409b.

Once the student enrollment 405a and 405b and the course scheduling 408 are completed, the admin 302c proceeds to step 406. At 406, the admin 302c offers course in current and future session by assigning it with terms 407 of the virtual organization. The offer course in current and future session by assigning it with terms 407 includes assigning single/multiple course to students 407a, course to students on the basis of curriculum 407b and course to student on the basis of student request 407c.

The admin 302c also performs schedule setup 410 that includes initial schedule setup with day cycle and period details 411. The initial schedule setup with day cycle and period details 411 includes set time table manually for particular course 412 and automatic schedule setup 413. The set time table manually for particular course 412 includes assigning period and room details to particular course 412a. In the automatic schedule setup 413, the admin 302c sets constraints 413a. The constraints 413a are set based on a list 413b that includes lesson constraints, faculty constraints and set subjects and rooms constraints. After setting the constraints 413a, a general automatic timetable 413c is created as well as date and timetable type 413d are mapped. At end 414, the creation of the session and the organization are completed.

In an example embodiment, the intelligent personalized learning platform provides each learner with the intelligent agent that creates individual learning plans. The empowers the learners at their own choice of time, place, pace and path. This offers a homeschooling platform that provides the personalized learning using individual learning plans. The intelligent personalized learning platform also offers content independent advanced learning module for parents, students, learners, teachers and content providers and facilitators, which is explained next with reference to FIGS. 5A and 5B.

FIGS. 5A and 5B illustrates a flow diagram 500 depicting flow of creating a homeschooling platform using an advanced learning module 505 of the IEMS 116, in accordance with an example embodiment.

At 501, a user account for a parent/tutor/author is created. The user account hereinafter referred to as parent account. At 502, accounts for one or more learners are created after creating the parent account. At 503a, the accounts corresponding to the one or more learners are provided to the learners. After receiving the login credentials, the learners can change passwords as per their preferences. At 503b, one or more courses for the one or more learners are created.

At 504, learning courses (e.g., course 1, course 2, . . . , course N) for the one or more learners are created. At 504a, learning curriculum map and learning course resources are created. At 504b, use course resources created by another users, such as other parents, tutors or authors through sharing process. At 504c, use course resources purchased from a learning marketplace, such as Veda Junction marketplace.

The learning curriculum map and the learning course resources created at 504a-504c are provided as an input to the advanced learning module 505. The advanced learning module 505 organizes the learning curriculum map and the learning course resources into units 505a, lesson plans 505b, notes 505c, worksheets 505d, learning sets 505e, questions 505f and manual/automated grading levels 505g.

At 506, the organized curriculum map and learning resources are used to create a learning plan 506a for the learner. Also, learning plan 506b created by another user and learning plan 506c purchased from the Veda™ Junction marketplace are used.

At 507a, the learning plans 506a-506c are provided to the parents or tutors. The parents or tutors assign the learning plans 506a-506c to the learners. At 507b, the learners use the learning plans 506a-506c.

At 508, the learners learn using notes, e-learning sets, videos, etc. The learners also attempt quizzes, downloads and uploads worksheets. At 509, grades/scores of the learners' submissions/worksheets and assignments are evaluated.

At 510, analysis report is generated based on the evaluated grades/scores. From the analysis report, mastery levels and competency levels are analyzed and observed. The analysis report also allows identification of problem areas for each units and lessons as well as identification of problem areas for all learning course resources (e.g., the learning course resources 504a-504c). Moreover, the units and lessons analytics, status of each learning outcome, grades for all the worksheets and quizzes in the analysis report can be viewed. The learning plans are updated, and the updated learning plans are generated automatically in required areas to attain mastery and improve competency levels.

At 511, the updated learning plans are auto-generated. The intelligent agent (e.g., the Intelligent Agent 225) recommends a personalized learning plan (i.e., a customized learning path) based on course resources profile and learner's requirements and performance. The intelligent agent also recommends the study time (i.e., pace of the learner) based on the learner's performance.

The advanced learning module 505 is further used for achieving mastery learning 512. For every lesson plan 513, notes 513a are created. At 513b, learners practice exam. At 513c, the learners attempt quizzes. At 513d, the learners access e-learning. At 513e, mastery level achieved by the learners are checked. At 513f, if the learners qualify, then the learners move to next lesson. At 513g, if the learners do not qualify then the learners are provided updated notes for practice until the desired mastery level is achieved.

At 514, the learners achieve mastery for different lessons, such as mastery in lesson plan 514a, mastery in lesson plan 514b, mastery in lesson plan 514c and mastery in lesson plan 514d. At 515, if desired competency level is achieved then the learner moves to next unit 518.

If the desired competency level is not achieved the learners are provided with updated lesson plans. At 516, the learners achieve mastery in lesson plan 516a, mastery in lesson plan 516b, mastery in lesson plan 516c and mastery in lesson plan 516d. If the learners achieve desired competency level for lesson plans 516a-516c, then the learner moves to next unit 518. Else, the learners undergo mastery in lesson plan 517a, mastery in lesson plan 517b and mastery in lesson plan 517c. The lesson plans are updated until the learners achieve competency level. After achieving the competency level, the learners move to the next unit 518. The process ends at 519.

The flow diagram 500 allows parents to share the units, lessons, notes, e-learning sets, evaluation resources, and learning plans with multiple users of Veda Junction by authorizing their individual sharing codes. This way the parents can share their resources with other parents of the Veda Junction subscriber community. Thus, the Veda Junction provides a marketplace for buying and selling user curriculum maps, learning resources, and individual learning plans. A user can upload content on the Veda Junction marketplace and can sell it to Veda Junction homeschooling subscribers. Users can also subscribe to course resources from vendors and content publishing companies tested and approved by Veda Junction. Mentor support resources on how to design curriculum and personalize individual tutorial instruction are also available in the marketplace. Smart algorithms based on mastery and reinforcement learning govern the Personalized Learning plans for users. It provides personalized learning with the support of intelligent system-tutors, teachers & facilitators.

It provides personalized learning with the support of intelligent system-tutors, teachers & facilitators.
Teachers, students, & parents create and share curriculum, content, and learning resources
Parents can create individual learning plans and offer them to their children and share with other students and their parents.
The Intelligent Agent for each course is a defining feature of our Subscriber Network. It empowers learners to act with an enhanced degree of control and autonomy when making informed personal choices of learning environment, subject matter, approach, and/or pace for themselves. Individually customized tutorial teaching on student demand replaces traditional group learning on teacher demand in our Subscriber Network.
   Learners can subscribe to learn any course.
   Software recommends the cluster of courses to learners
   Users can pick and choose the cluster-course combination
   Customized and personalized learning based on Mastery Learning and Reinforcement Learning as explained below
   The Intelligent Agent automatically recommends individual learning plans for learners based on performance indicators, content profiles, evaluation profiles and learning outcome profiles
   The Intelligent Agent modifies the learning plan based on learner performance and content profile to continuously improve its knowledge and recommendations to improve student learning outcomes.
   Facilitators manage courses and content

A paid service in which users pay subscription fees. Revenue is shared between the company and clusters of teacher lesson-planners, network resource facilitators, and users who share highly-rated curriculum, content, and learning resources.

Learners can monitor and manage progress along with the system (e.g. activate/deactivate parts of the course learning plans).

Can meet external accreditation and certification requirements.

Manages Terms and Conditions of Use; permissions, royalties and fees; subscription sales and renewals; partnership agreements; ad-tech marketing and sales; and related business data analytics and reporting, as well as any federal, state and local reporting requirements.

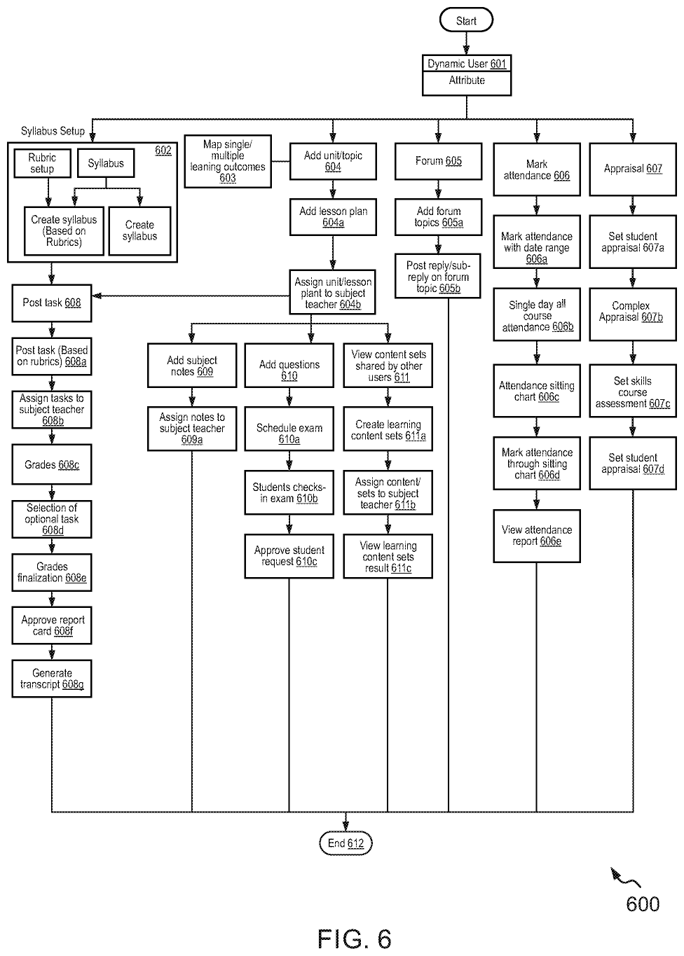

Further, the admin 302c also created a user role, such as dynamic user. The dynamic user is a type of user created by Admin of the virtual learning organization to whom various access of functionalities and departments are given to perform various tasks. The information flow of creating the dynamic user is explained in FIGS. 6, 7A, 7B, 8A and 8B.

FIG. 6 illustrates a flow diagram 600 depicting flow of information in modules associated with dynamic user login. For the sake of clarity and for the purpose of this description modules of dynamic user login is explained. The steps involved by the Dynamic user includes steps for curriculum mapping unit/topics and lesson plans that are described below:
i. Add standard types.
ii. Add Standards by mapping it with particular standard level and course type.
iii. Add Goals and Objective under particular standard types and standard.
iv. Add Units/topic by mapping it with multiple Standards, Goals & Objectives.
v. Add multiple lesson plans under particular Unit/Topic by mapping it with multiple Standards, Goals & Objectives.
vi. Assign Unit/topic and lesson Plan to selected course teacher.
vii. The steps involved by the Faculty/Teacher:
viii. Utilize Unit/lesson plan shared from academic user.
ix. Add Units/topic by mapping it with multiple Standards, Goals and Objectives.
x. Add multiple lesson plans under particular Unit/Topic by mapping it with multiple Standards, Goals and Objectives.

At 601, creation of dynamic user login starts. At 601, the dynamic user is created. At 602, a syllabus setup is performed. The syllabus setup includes rubric setup and syllabus for creating syllabus based on the rubrics. In this step, faculty or academic user will create the syllabus for particular subject by assigning particular weightage for internal and external courses separately. User will also separately assign weightage to particular task types. User will also create the syllabus by mapping it with rubrics and assign particular weightage to rubric skills. Following are steps to perform syllabus setup:
i. Create syllabus for particular subject by assign weightage for internal and external courses/assessments.
ii. Assign weightage to particular task types for internal and external courses/assessments separately.
iii. Create syllabus for particular subject by mapping it with rubrics and by assigning weightage for internal and external courses/assessments.
iv. Assign weightage to particular task types and to particular rubric skills for internal and external courses/assessments separately.

At 603, single/multiple learning outcomes is mapped. Mapping of standard level and course type with standard goals and objective, mapping of learning outcomes with unit/topics, mapping of learning outcomes with lesson plan, mapping same learning outcome with multiple lesson plans. Add multiple lesson plans under a particular unit/topic. Add lesson plan using CSV file.

At 604, unit/topic is added. At 604a, lesson plans are added. At 604b, unit/lesson plan is assigned to subject teacher. At 605, a forum is created. At 605a, forum topics are added. At 605b, reply/sub-reply on forum topic is added.

At 606, attendance is marked. Step 606a represents step of ‘mark attendance with date range’. Step 606b represents step of mark single day all course attendance. Step 606c represents step of ‘prepare attendance sitting chart’. Step 606d represents step of ‘mark attendance through sitting chart’. Step 606d represents step of ‘view attendance report’.

At 607, appraisal is created. Step 607a represent step of ‘set student appraisal’. Step 607b represent step of ‘create complex appraisal’. At 607c, set skills course assessment is completed. At 607d, set student appraisal is completed.

Step 608 represents step of create post task. Step 608a represents step of ‘create post task based on rubrics’. Step 608b represents step of ‘assign tasks to subject teacher’. The user will post the task by mapping it with/without lesson plan. While posting task, user will assign particular score and weightage to the task. The user will also post the task for all students or by selecting particular group of students. Further, the user will post all type of tasks like Assignment, Homework, Exam, Project, Labs, and Group Discussion. The user will also post task by mapping it with rubrics. Once the task from Dynamic user is posted, it will be assigned to particular subject teachers and teachers will utilize these tasks from their login and can post additional tasks. The student will then attempt the task from their login by doing manual submission or by online submission. Following are the steps for Assignment/Task management:
i. Dynamic user post different type of task types
ii. Assign task to selected subject teacher
iii. Utilize task from Faculty login
iv. Post different type of task types from Faculty Login
v. Post different type of task types from Faculty Login by mapping it with rubrics skills
vi. Submission of task from Student login with manual submission or online submission

At 608c, grades are calculated. At 608d, optional task is selected. At 608e, perform grades finalization. At 608f, approve report card, and at 608g, generate transcript. After posting the tasks for the students, the faculty will enter grades for students with letter/rubric or manually. The faculty will also enter grades by evaluating the task submitted from the students. After that the faculty will normalize the grades at task level if needed using simple or t-score normalization. Post normalization, the faculty will finalize the grades and faculty can also add comments for students while finalization. The faculty will then send it for further approval process. Once, the further approvals (from higher authority) is received the report card for each student is then created. The transcript can also be generated for students. Complete grade book to enter, edit or view grades, online and PDF grade reports, functionality to select optional tasks for finalizing internal and external assessments, and graphical reports. The following are the steps for grading system:
i. Enter grades using letters/rubric/manually analyzing student's submissions.
ii. Normalization of grades at task level using t-score or simple normalization.
iii. Choosing best student of the term.
iv. Grade finalization for a course.
v. Approve grades from higher authority.
vi. Approve report card of each student.
xi. Grade approval process to generated transcript of student.

At 609, subject notes are added. At 609a, notes are assigned to subject teacher. At 610, questions are added. Dynamic user or Faculty will add Multiple Choice Questionnaire (MCQ) or essay type questions by mapping it with course and learning outcomes to conduct online exam/assessment. The Dynamic user will add question directly for faculties or will add it through content provider. Add multiple/Single response types questions to question bank, schedule exam with random or fixed order, schedule exam with time range, schedule mid-term/Class test or exam with weightage. After adding questions, the faculty or the dynamic user will schedule exam/assessment for particular subject.

At 610a, exam is scheduled. Once the exams are scheduled, the student may attempt it from their respective student login. Thereafter, the exam result will be displayed. The following are the steps for Online assessments/Exam data flow:
i. Add questions like MCQ or essay type.
ii. Schedule exam/mid-term with random/selected question and random/fixed order.
iii. Exam check-in with single/multiple student approval process.
iv. Attempt from student login.
v. View scheduled multiple choice/essay type exam result.

At 610b, student checks-in exam. At 610c, approve student request. At 611, creation of dynamic user ends. At 611a, learning content sets are created. At 611b, assign content sets to subject teacher. At 611c, view results of learning content sets. At 614, the flow of information in modules associated with the dynamic user login ends.

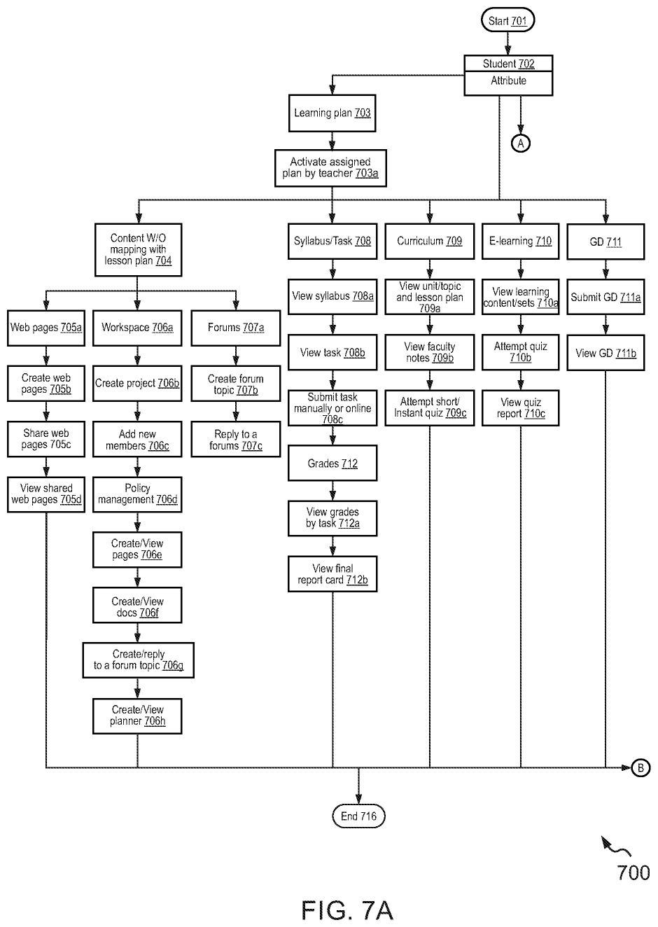

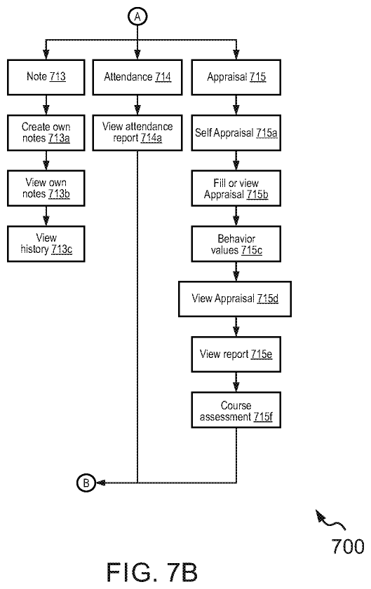

FIGS. 7A and 7B collectively illustrate flow diagram 700 depicting flow of information in modules associated with student login of the IEMS 116, in accordance with an example embodiment. For the sake of clarity and for the purpose of this description modules of the student login related to learning is described. At 701, creation of student login starts.

At 702, student login is created. At 703, a learning plan is created. At 703a, assigned plan is activated by teacher. At 704, content with or without mapping with lesson plan is created. At 705a, creation of web pages is initiated. At 705b, web pages created. At 705c, the web pages are shared. At 705d, shared web pages are viewed. At 706a, setup a workspace.

The faculty or student will first create a workspace project. The user who creates the project will be the project administrator. The faculty will be the admin and can also make any student as a moderator of that project. The project admin can then add members for the project. The project admin can also give Read/Update privilege to member. Based on the privileges, admin or any member of the project may create or update pages, documents, forums and planner for the project. The admin may validate/reject the pages/document/forums which are created by project members based on project policy status set by administrator. Hence, the project admin can set the policy status of pages, documents and forums as “open” or “closed”. If the status is set as “closed” then:

For project administrator—pages, documents and forums that are created or edited will have to be approved by the project admin to be viewed by all project members.

For project members—Project Administrator will approve the pages, documents and forums which is created/updated by the project members. This is required if it has to be visible to all other project members. If the status is set as “open” then:

For project administrator—The pages, documents and forums which is created or updated will be visible to all members immediately.

For project members—The approval process from the project administrator is not needed. The pages, documents and forums which is created or updated will be visible to all other members immediately. Following are steps for Workspace data flow:
i. Create new project for particular course.
ii. View project list where you are administrator or member.
iii. Add new members to project
iv. Provide privilege access to project members
v. Set policy status as ‘open’ or ‘closed’. Teacher may assign a student as moderator
vi. Create pages for project.
vii. Validate/reject pages
viii. Create documents either by adding contents from media and by uploading attachment.
ix. Validate/reject documents
x. Create forums topic for project.
xi. Reply to a forum topic
xii. Validate/reject forums.
xiii. Create planner

At 706b, create project. At 706c, add new members. At 706d, initiate policy management. Student project collaboration application, policy management, report writing, document management, project planning, moderated by teacher. At 706e, create/view docs. At 706f, create/reply to a forum topic. At 706g, create/view planner.

At 707a, setup forums. At 707b, create forum topic. At 707c, reply to forums. At 708, create syllabus/task. At 708a, the syllabus is viewed. At 708b, task is viewed by the students. At 708c, submit task manually or online. At 709, a curriculum setup is initiated. At 709a, view unit/topic and lesson plan. At 709b, view faculty notes. At 709c, attempt short/instant quiz.

At 710, create e-learning. At 710a, view learning content/sets. At 710b, attempt quiz. At 710c, view quiz report. In this step, dynamic user creates learning content/sets by integrating it with course and lesson plan. The learning content/sets will be created using images, videos from you tube or by third party like Flickr™. The learning content/sets will consist of 1 to ‘n’ pages (where ‘n’ is any numeric value). Academic department user will assign content/set to selected course faculty and faculty will utilize the content/sets from their login. The dynamic user assigns quiz with these content/sets. Different types of quizzes will be created with number of checks. While creating quizzes, the dynamic user selects question by lesson plan filter, standard goal or question description or objective description etc. The dynamic user assigns quiz(zes) either to all sets or for random sets. The student will then have to read those sets from their login and must attempt the quiz. Create online lessons integrated with quizzes (integration with question banks) using content authoring tool. Provide integration of contents from other publishers, like Youtube™, Flickr™ and/or teaching academy. Further, it includes providing real time student analytics.

The following are the steps for Content Authorizing Tool:
i. Create learning content/set from the Dynamic user.
ii. Assign learning Content/Sets to a teacher.
iii. Utilize Content/Sets from the teacher login.
iv. Create learning content/set from teacher login.
v. Create quiz using number of checks.
vi. Assign quiz either to all sets or for random sets.
vii. View learning content/sets analytics report.

At 711, create a group discussion. At 711a, submit the group discussion. At 711b, view the group discussion. Initially, the Teacher or the Dynamic user will post a topic for GD. The student will then submit their appropriate comment for the particular topic. The teacher will then provide grades for the student based on their basis of comment. The teacher will also approve the comment and student will also be able to see other student comments from their login which are approved by the teacher. Real time student interaction with current lesson, faculty can grade student based on their interaction. Following are steps for Group Discussion Data flow:
i. Post task as GD and the topic for GD
ii. Students will comment on the topic
iii. Teacher will grade student for their comments
iv. Teacher will also be able to approve the comments
v. Students will see approved comments from their login

At 712, notes are created. In this step, Faculty or Dynamic user will create notes by selecting course and lesson plan, for the reference of student. User will create notes with descriptions and multiple attachments. The notes are created using images and videos. Also, the notes can be reused in future session. Student can view or download notes. After creating notes from the Dynamic user, it will be assigned to subject teacher and Faculty will utilize the notes and post those notes. Following are the steps for online Notes and Content Management:
i. Create Notes from the Dynamic user by selecting course and lesson plan
ii. Assign notes to particular subject teacher
iii. Utilize notes from teacher login
iv. Create notes from Teacher login by selecting course and lesson plan

At 713a, own notes are created. At 713b, view the own notes. At 713c, view history. At 714, mark attendance. At 714a, view attendance report. At 715, create appraisal. At 715a, create a self-appraisal. At 715b, fill or view appraisal. At 715c, behavior values are created. At 715d, view appraisal. At 715e, view report. At 715f, course assessment is performed. At 716, flow 700 of the student login ends.

The first step in this module is to configure Units plan and Lessons plan by mapping it with Goals and Learning Outcomes. To do setup of Units plan and Lessons plan firstly the user is going to do setup of standard, goal and objectives, which will be created by a dynamic user. The dynamic user will create the standard, goals and objectives by mapping it with the standard level and course type.

After the setup of goals and objective, Academic department user will create Unit/Topic by mapping it with multiple goals and objectives under particular dates and subjects. After adding Unit/Topic, academic user will create multiple Lesson plans under Unit/Topic by using multiple goals objective, which was mapped in Unit/Topics. Thereafter, academic user will have assigned them to faculty and faculty will utilize those unit/topics and lesson plan from his login.

Student/faculty/other officers will store the data in different formats like audio, video, ppt, doc, xlsx, swf, image. They will also directly link with user Google drive by configuring Gmail account with the system. They will also share any type of file with other users.

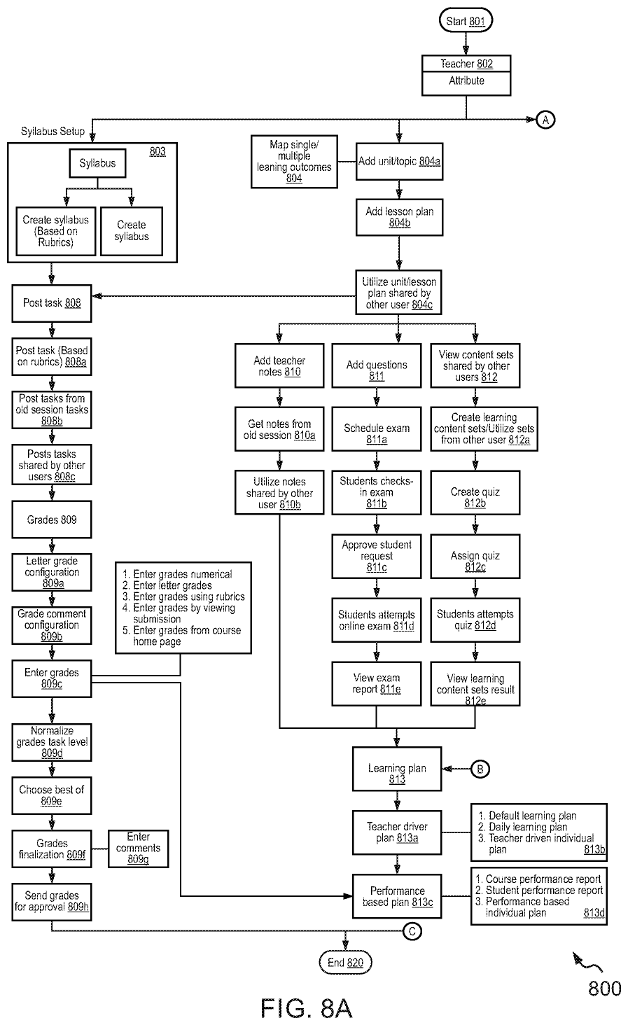

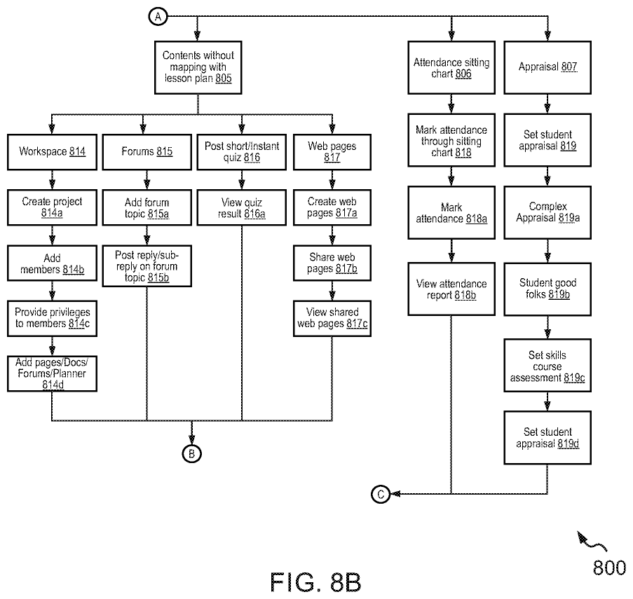

FIGS. 8A and 8B illustrate flow diagram 800 depicting flow of information in advance learning module associated with a teacher login of the IEMS 116. For the sake of clarity and for the purpose of this description modules of teacher login is described below. The description of each module includes name of the module, prerequisites and the flow of data in the respective module. Faculty/Teachers create Unit/Topic from his login by mapping it with multiple goals and objectives under particular dates and course. After adding Unit/Topic, Faculty will create multiple Lesson plans under Unit/Topic by using multiple goals and objectives, which are mapped in Unit/Topics.

At 801, teacher login creation starts. At 802, teacher login is created by providing attributes of a teacher. At 803, a syllabus setup is performed. The syllabus setup includes creation of a syllabus based on rubrics and based on information provided by the teacher. At 804, single/multiple learning outcomes are mapped with unit, topic and lesson plan by the teacher. For example, unit/topic 804a and lesson plan 804b are mapped with the single/multiple learning outcomes. At 804c, unit/lesson plan shared by other users are also utilized. At 805, contents without mapping with lesson plan are configured. At 806 and 807, attendance sitting chart and appraisal for the student are configured by the teacher.

At 808, the syllabus created for the students and the lesson plans are configured for post task. At 808a, the post task is configured based on the rubrics. At 808b, post tasks from old session tasks are configured. At 808c, post tasks shared by other users are also configured. At 809, grades for the students are configured by the teacher. At 809a, letter grade configuration is performed. At 809b, grade comment configuration is performed. At 809c, grades for the students are entered by the teacher. The teacher can enter numerical grades, letter grades, grades using rubrics, grades by viewing submission and grades from course home page. At 809d, grade task level is normalized. At 809e, best of normalized grade is selected. At 809f, finalization of grades is performed. At 809g, comments are entered for the grades by the teacher. At 809h, grades are sent to facilitators for approval. First the grades are entered and finalized from a teacher's login. Thereafter, the grades will be sent for approval to higher authority. Once the grades are approved from higher authority, report cards will be finalized for a term. The report cards are then approved at the end of session and the students can generate a transcript for particular student.

At 810, teacher notes are added to the lesson plans. At 810a, notes from old session are obtained from database of the IEMS 116. At 810b, notes shared by other users are utilized.

At 811, questions are added for taking a test of the students. The admin 302c will first create a set of set of questionnaires for feedback of teacher. The admin will then assign the questionnaire to appropriate subjects. The student for those subjects can also give feedback on the questionnaire from their logins. Thereafter, the admin can check reports for different questionnaire in different graphical formats. Following are steps for Course evaluation data flow:
i. Create questionnaire from admin login
ii. Assign questionnaire to appropriate subjects
iii. Feedback from student login by attempting questionnaire
iv. View report in different graphical format from admin

At 811a, a lesson exam is scheduled by the teacher. The schedule can also be provided by the student. At 811b, the student checks in the exam. Here, the student sends a request for attending the exam. At 811c, the student request is approved. At 811d, the students attempt an online exam. At 811e, exam report is viewed by the teacher.

At 812, content sets shared by other users are viewed by the teacher. At 812a, learning content sets/utilized sets from other users are created. At 812b, quiz for the learning content sets is created by facilitators of the IEMS. At 812c, the facilitators assign the quiz to the teacher. The teacher then provides the quiz to the student. At 812d, the student attempts the quiz. At 812e, the learning content sets result are viewed by the teacher.

At 813, a learning plan for the student is generated. The learning plan is generated based on the exam report and the learning content sets result. Also, the learning plan is generated based on notes created at 810, 810a and 810b. At 813a, a teacher driven learning plan is included. The teacher driven learning plan includes plans 813b, such as default learning plan, daily/weekly learning plan and teacher driven individual plan. At 813c, a performance-based plan is generated. The performance-based plan includes plans 813d, such as course performance report, student performance report and performance based individual plan.

At 814, workspace for the student is configured. At 814a, a project is created for the student. At 814b, members for learning are added by the teacher. At 814c, privileges for the members are provided by the teacher. At 814d, pages/documents/forums/planner are added for the student by the teacher. The users of the IEMS 116 provide storage of online private secured documents and file storage for all users, encrypted storage, automatic access and collaboration with a third-party drive. The output obtained at step 814 is sent to the learning plan created at 813.

At 815, forums for discussion are created. At 815a, forum topics are created. At 815b, post reply/sub-reply on forum topic is created. The forums, the forum topics and the post reply/sub-reply are connected to the learning plan created at 813. Initially, a forum topic is selected. The faculty and student can create forum topic by mapping it with a particular course. The forum topic which is posted by faculty will be visible to all the students who are enrolled for that particular course. However, if a topic for forum is selected by the students then the teacher will approve it. The student and the teacher can reply to a forum topic and they can also comment on the replies created by each other. In general, the faculty will approve the comments created by students. Following are the steps for forums data flow:
i. Create forum/topic by course selection or by adding attachment.
ii. Reply to a forum topic posted by faculty and student.
iii. Reply to a comment created on forum topic by faculty and student.

At 816, post short/instant quiz is created. The short/instant quiz is created after a lesson is initiated by the student. At 816a, a quiz result of the student is viewed by the student. The responses provided by the student for the quiz and the quiz result are used in the learning plan of step 813.

In the step 816, the teacher will post short quiz for selected courses. The short quiz can either be for single course or for multiple courses with plurality of question. These questions can be MCQ type. After that the students will attempts short quiz, faculty will view the result in form of bar chart, pie chart or list chart. The faculty can also post instant quiz for selected courses. The instant quiz would be only for one question at a time and these questions will be MCQ pattern. The students can then attempt instant quiz and the faculty will view the collated result in the form of bar chart, pie chart or list chart. The following are the steps for short and instant quiz:
i. Post short quiz to selected course student with plurality of questions
ii. View the result using bar chart, pie chart and list chart
iii. Post instant quiz to selected course student with only one question.
iv. View result using bar chart, pie chart and list chart.

Post single/multiple short quiz of selected course, the student can view posted short quiz result using different chart, post instant quiz to selected course students and view posted instant quiz result using different chart.

At 817, web pages for the learning are configured. At 817a, web pages are created. At 817b, the web pages are shared. At 817c, the shared web pages are viewed by the students. The information of the web pages is provided to the learning plan of step 813.

At 818, attendance sitting chart is prepared by the teacher. At 818a, attendance is marked using the attendance sitting chart. At 818b, attendance report is viewed by the teacher. The IEMS 116 can automatically create number of reports regarding every module in different formats (for example MS Excel, PDF, graphical or image). The user can also generate dynamic report by putting particular filter as per their reference. The teacher or admin can also view the brief snapshot of student with details of all modules in single reports.

At 819, student appraisal is set. At 819a, complex appraisal of the student is set. At 819b, good folks' student is identified based on the appraisal. At 819c, course assessment skills are set. At 819d, student appraisal is set. At 820, the flow of information for teacher login ends.

Further, IEMS 116 provides an online communication among users. During setup of a student, parent or teacher/tutor, the admin 302c will first send announcements and dedicates alerts to all users/faculties/students/parents. The admin 302c can also compose mails to all users/faculties/students/parents with or without attachment. Other users can also compose external mails through their login. The admin 302c will setup the academic calendar for that particular year and send it in an email. The other users can also send emails to communicate with each other. Using this, the teacher too can send alerts to student and parents. The teacher and student can set their preference by mapping their email address and cellular phone number for notification. The students, parent and teachers can also get the alerts regarding grades or if there any type of notification for any other activity in system.

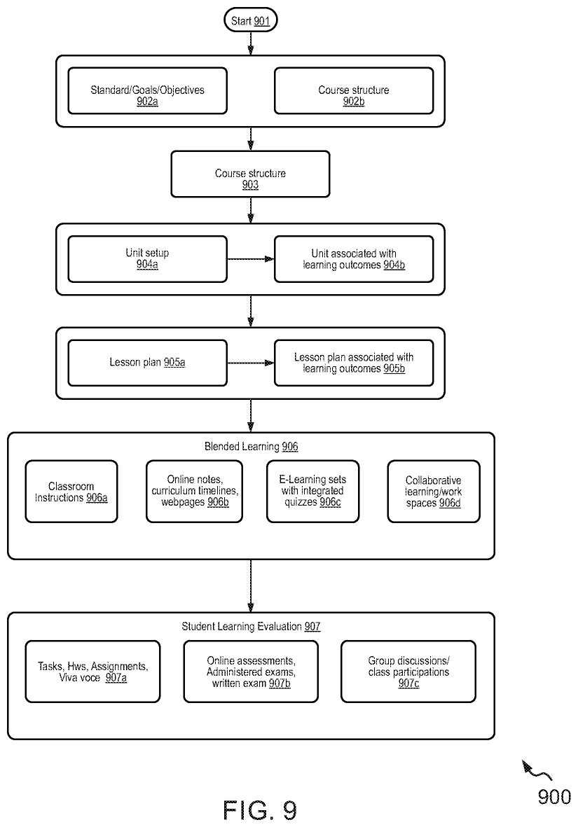

FIG. 9 illustrates a flow diagram 900 depicting flow of information in advance learning module, such as the advance learning module 505 of FIGS. 5A and 5B, of the IEMS 116, in accordance with an example embodiment of the present invention. At 901, the flow of information in the advance learning module 505 starts.

In the advance learning module 505, there are numerous elements, few of the elements are described below:
Organization Element: The organization element is the parent element of the single instance on an installation of the software. Each installation can have multiple instances. Each organization refers to an entity—a school district, a school, a college, a university or an institute. The organization element remains constant.
Session Element: A session object is the child element of the organization element. A session can be a year, a semester, a trimester or a quarter. The session must be changed after the duration of it is over. For example—Session 2017-2018, fall semester within 2017-2018.
Department Element: A department element handles the department within the organization. For example, Math, Science, Computers, Accounts, Transportation.
School Element: A school entity within the organization handles a complete virtual school. For example, Middle School, High School, Primary school, Honors school.

Grade Levels and Sections/Homerooms: A school element can have multiple grade levels and a grade level can have multiple sections or homerooms.

v. In the flow diagram 900, initially standards, goal and objectives 902a are defined. A course structure 902b is also added by a user. Thereafter, a course 903 is configured to assign to teachers/faculties. The course structure 902b is added by using course element of the advance learning module 505, which is described below:
Course element: A course element is part of the organization and is offered in a school. A course can have multiple sections. For example—
i. Course Math 101 is part of Math department and is offered in Primary school.
ii. The courses must be assigned to a school in each session. For example:
iii. Course Math 101 is assigned/offered in session 2017-2018 and may not be offered in 2018-2019.

Roles: Roles are defined for teacher, faculty, dynamic users (unlimited roles), students, parents, staff and others.

Course assignment to teacher: In each session, a course must be assigned to a teacher. For example, Course Math 101 offered in primary school in session 2017-2018 is assigned for teaching to Teacher A.

Course assignment to students: In each session, a student can be assigned one or more courses. For Example, Student A can be assigned 5 Courses—(Math, English, Science, French, Social Studies).

For each session, for each course offered in that session the following unique structure is offered:
Attendance Management and profiling
Content Structure: Standards-goals-learning outcomes mapping tool, unit and lesson planning. Standard Types, standard levels, standards, goals and learning outcomes are mapped to each Unit/lesson object.
Learning Objects: Online notes, content authoring tools, online assessments, workspaces, forums and discussions, Group Discussions
Collaborative learning Objects: Workspaces, forums and discussions
Evaluation Objects: Task group (Homework, exams, class tests, projects, labs, viva voce, assignments, GD, attendance), online assessments, workspace
Appraisal Management: Student reports, pen picture, course assessment, personality traits, general behavior records.
Advanced grade management: Unique grading scheme structure and propagation mechanism, Grade entry from 9 different screens, Normal scoring, Letter Grading, Rubrics based grading, Grading for Learning outcomes.
Communication Objects: Online communication like alerts, internal and external emails, notice, circulars, academic calendar
Discussion Objects: forums and discussion
Storage: online drive
Learning System for teachers, Goals Management for teachers
Other Modules: Advanced planners, teacher feedback tools, grade analyzer tools
Session Change and New session: Once a session is over, a new one starts, and courses are offered again in this new session along with new course assignment to student and teachers.

Few unique areas in Advanced Learning module are: —
5 levels of learning outcomes in the form of Standard types, standard levels, standards, goals and learning outcomes.
Each unit and lesson mapped to multiple learning outcomes from different standard and standard types.
Each learning object is mapped to a unit/lesson and to one or more learning outcomes.
Each evaluation object is mapped to one or more learning outcomes.
Tasks (homework, assignments, projects and other such things are mapped to a lesson and to one or more learning outcomes of that lesson).
Each assessment question is mapped to a learning outcome.
Multiple user interfaces for different roles.
Grades approval and finalization process flow: Grades finalized by subject teacher are sent to other users up to six (6) levels before being available in report cards and transcripts.

Most of the school uses instructional methods to teach students and they are evaluated at fixed time intervals by analyzing assessments. School uses economically convenient methods, where student is evaluated and taught in groups. Individual attention is not paid to students which affects student learning. To improve this, the IEMS 116 model offers to create individual and personalized learning plans by using certain criteria's like student standard competency scores, which are made available to students for learning. Hence, this strategy of education takes into consideration the student's problematic areas where course learning outcomes are not met. Individual Learning Plan (ILP) helps addressing the individual student problems, by the organization and sequencing of course content.

Some of the elements of learning are described below:

Learning Outcomes (Objectives): Is what a student is expected to be able to do as a result of a learning activity. This suggests what skill, knowledge or behavior student is able to learn, demonstrate, and practice etc. as a consequence of a learning activity. It also includes attitudes, and habits of mind that students take with them from a learning experience.

Unit: Element used in our system model, in particular super topic that is taught in course. It is the combination of lessons that are linked by concepts. It consists of concepts and learning goals that are taught over a period of time and are knitted together, often across subject areas. It normally last over period of two or three weeks and includes several standards, skills (goals are about your purpose or aim), and desired outcomes for interconnected learning.

In IEMS 116, course unit includes name, standard level, generic course type, time period (over which it is taught), rubrics associated, and detailed description of the unit and brief overview of the lessons involved.

Lesson: Part of unit, a lesson may be either one section of a learning content group (combination of text and multimedia) or, more frequently, a short period of time during which learners are taught about a particular subject or taught how to perform a particular activity. Usually lessons have a time slot of 50 to 70 minute and include subset of standards, skills and learning outcomes that lesson unit have.

Lesson includes its name, unit (part of which the lesson is), start-end date, sessions, minutes allotted, reference links (websites and books), standard level, course type, rubrics associated and detailed information of lesson which generally includes Introduction to topic, foundation (checking/revising knowledge from past), body of new information and at last independent practice.

Learning Outcome/Objective Score: Score assigned to each learning outcome on a scale to 1-5. It is the number computed for each objective from the student performance based on assessment(s) results that describes the skill or competency level of the students.

Learning Outcome/Objective Status: Textual value associated with scores. Scores for met (excellent) is 5, met (very good) is 4, partially met (normal) is 3, partially met (average) is 2 and not met is 1.

Competency Score: It is number calculated from student evaluation from exam performed.

Competency Level: Linked with competency score it represents the whole value associated. If competency score is less than 1 it is denoted with 1, for greater then 1 and less than 2 it is 2, for greater than 2 and less than 3 its 3 and else its 4.

Notes: Recorded information captured from lesson taught. Creator records the essence of the information, freeing their mind from having to recall everything. Notes must acquire and filter the incoming sources, organize and restructure existing knowledge structures, comprehend and write down their interpretation of the information, and ultimately store and integrate the freshly processed material.

In IEMS 116, Notes includes its name, Lesson, tentative date, reference links (websites and books), and detailed information of lesson which generally includes topic then sub topic followed by its details.

Questions: Directly associated with learning outcomes, it helps evaluating the student learning. System model offers addition of questions with option to select question type (whether it is text only or it contains multi media). The advance learning module 505 also provides reinforcement learning. For each course we have predefined units, lessons, one or more learning outcomes assigned to lessons. We have notes, e-learning sets with pages that are part of lessons, question bank for each lesson of unit. States are status of each learning outcome there are five possible states for each Learning Outcomes. Actions are selection of learning outcomes, learning content and evaluation questions.

A content structure 903 is provided based on the standards, goals and objectives 902a and the course structure 902b. After creating the content structure 903, a unit setup 904a is performed. At 904b, each unit is associated with learning outcomes. A setup for lesson plan 905a is also performed. At 905b, each lesson plan is associated with learning outcomes. The unit 904a and lesson plan 905b are mapped with single and multiple learning outcomes on the basis of goals, standard level and course types. These lesson plan and learning outcomes will be mapped with every learning content module.

The online teacher notes are mapped with the lesson plan and learning outcomes. Using a content authoring tool, a number of content sets is created. The number of content sets are mapped with the lesson plan and learning outcomes. Further, quiz for the content sets are created by adding questions, where question is mapped with the learning outcomes.

A learning plan module is also defined. It also includes blending learning module 906 along with student learning evaluation. The blended learning 906 includes classroom instructions 906a, online teacher notes, curriculum timelines and webpages 906b, e-learning sets with integrated quizzes 906c and collaborative learning/workspaces 906d. The collaborative learning/workspace 906d creates projects with pages, documents and media for particular students. Many more modules like web pages, quiz's forums to increase student learning skills.

A student learning evaluation 907 is performed. In an example embodiment, the student learning evaluation 907 is performed using evaluation objects 907a-907c, such as tasks, homeworks, assignments and viva-voce 907a, online assessments, administered exams and written exam 907b and group discussions and class participants 907c. The evaluation objects 907a-907c are mapped to one or more learning outcomes. These learning outcomes are used to evaluate the students. For example, a task will be posted by assigning weightage and by mapping it with learning outcome, so after grading it will calculate the overall status of learning outcomes by considering all task and exams grades and weightage.
i. Set syllabus by assigning particular weightage for internal and external.
ii. Post different types of task by mapping it with lesson plan learning outcomes.
iii. Post multiple task by mapping them with single learning outcomes.
iv. Post Single task by mapping it with multiple learning outcomes.
v. Post Group Discussion topics to evaluate student on the basis of class participation.
vi. Online Exam Questions: Each question is mapped to single learning outcome.
vii. Add multiple Online Exam questions using single learning outcome and after evaluation of these exams it will helps to calculate the overall status of learning outcomes by considering grades and weightage of all questions and exams.
viii. Schedule multiple exams with number of questions to evaluate the student using learning outcomes.
ix. Schedule different type of administration exams by assigning weightage.

Advanced grade management: Once student attempt the course from their login, all the evaluation objects will be graded. All the tasks are graded, and all the exam questions are graded and evaluated. Scores for each task are available for student.
i. Evaluate student by entering marks using different methods.
ii. Enter grades using numerically or letter value.
iii. Enter grades using rubrics and set status of learning outcomes for students as met, partially met or not met.
iv. Automatic evaluation of student for online exams.

The student learning evaluation 907 is performed on the basis of learning outcomes at different level like task, online exams, e-learning sets.

On top the advanced learning module 505 as described above is layer of recommendation engine, individualized learning and individual learning. This tool uses data analytics algorithms and machine learning to calculate student competency levels and competency score for each course. The scores are calculated for each lesson and unit from following areas:
i. Student scores from online assessments and quizzes
ii. E-learning quizzes
iii. Student profile and cognitive skills
iv. Parent involvement
v. Teacher feedback
vi. Student scores from home works, assignments, class tests, projects labs

The recommendation engine, individualized learning and individual learning also provides the following features:
Smart algorithms based on mastery and learning, govern the personalized learning plans for users. This therefore provides personalized learning with the support of intelligent system-tutors, teachers and facilitators.
Provides personalized learning with the support of intelligent system-tutors, teachers & facilitators.
Teachers, students, and parents can create and share curriculum, content, and learning resources.
Parents can create individual learning plans and offer them to their children and share with other students and their parents. Parents share the units, lessons, notes, e-learning sets, evaluation resources, and learning plans with multiple users of Veda Junction by authorizing their individual sharing codes. This way parent can share their resources with other parents of the Veda Junction subscriber community.

The Intelligent Agent 225 for each course is a defining feature. It empowers learners/students to act with an enhanced degree of control and autonomy while allowing them to make informed personal choices of learning environment, subject matter, approach, and/or pace. Individually customized tutorial teaching on student demand replaces traditional group learning on teacher demand in our Subscriber Network.
i. Learners can subscribe to learn any course.
ii. Software recommends the cluster of courses to learners.
iii. Users can select and choose the cluster-course combination.
iv. The Intelligent agent automatically recommends individual learning plans for learners based on performance indicators, content profiles, evaluation profiles and learning outcome profiles.
v. The Intelligent Agent modifies the learning plan based on learner performance and content profile to continuously improve its knowledge and recommendations to improve student learning outcomes.

Facilitators manage the courses and contents. A paid service is also provided through which the users pay subscription fees. Revenue is shared between the company and clusters of teacher lesson-planners, network resource facilitators, and users who share highly-rated curriculum, content, and learning resources.

Learners/Students can monitor and manage their progress, for example they can activate/deactivate parts of the course learning plans.

The IEMS 116 can also meet external accreditation and certification requirements.

Allows multiple individual instances to be fully integrated with one another to form smart learning network communities including any instances that are part of the IEMS 116.

It can also integrate partner and third-party applications, content, and learning resources, using Single-Sign-On (SSO) authentication mechanism.

It manages terms and conditions of use; permissions, royalties and fees; subscription sales and renewals; partnership agreements; ad-tech marketing and sales; and related business data analytics and reporting, as well as any federal, state and local reporting requirements.

FIG. 10 illustrates a flow diagram 1000 depicting flow of information in recommendation engine and individual learning plans module of the IEMS 116, in accordance with an example embodiment of the present invention. At 1001, the flow of information in the recommendation engine and individual learning plans module 1010 referred to hereinafter as analysis engine 1010 starts. At 1002, a syllabus setup is performed. At 1003, a unit setup is performed after completing syllabus setup. In the flow diagram 1000, initially standards, goal and objectives are defined. At 1004, a standard configuration for standard setup, goals setup and objectives/learning outcomes setup 1005 is performed.

At 1006, a lesson plan setup is performed. After the lesson plan setup, class assessments 1007 and learning content 1008 are created. It also includes blending learning module along with student learning evaluation. At 1007a, assessments, exam, labs, mid-term test and group discussions are created. At 1008, learning content is created using online notes, e-learning sets and online assessments 1008a.

Once the student attempts a course, the system evaluates the student on the basis of marks and learning outcomes status. The next step is to calculate the overall status of learning outcomes by considering grades of all task grades, online exams question, quiz's, where ever there is a mapping of particular learning outcomes. For example, a user posted two (2) tasks and five (5) online exams questions with different weightage by mapping it with same learning outcome, so after grading of both the task and exams, system will consider both the task grades and questions marks wherever that objective is mapped, to calculate the overall learning outcome status.

At 1009, final assessments are performed. The output of the final assessments is provided to an analysis engine 1010. The analysis engine 1010 uses the output for generating course recommendations 1011. The course recommendations 1011 are generated based on student competency score and level 1012. Further, the course recommendations 1011 also provides lesson plan analysis 1013a, unit analysis 1013b, which task need revision 1013c, which learning content/sets need revision 1013d and which notes need revision 1013e. An updated lesson plan based on all these (i.e., 1013a-1013e) is provided to the students. Following are the steps for calculating overall status of Learning Outcomes:

Step 1: Learning Outcome States Explained

Step 2: ‘Met’ is state defining, where student meets excellence.

Step 3: Partially Met is state defining, where student meets average marks/grades.

Step 4: Not Met′ is state defining, where student does not meet defined values.

Step 5: Learning Outcome Status

Step 6: Textual value associated with scores.

At 1014, it is checked if the students have met the expectations. Score assigned to each learning outcome on a scale to 1-5. Scores format (excellent) is 5, met (very good) is 4, partially met (normal) is 3, partially met (average) is 2 and not met is 1. This number computed for each objective from the student performance based on assessment(s) results that describes the skill or competency level of the students.

S=(W1+W2/2)/(W1+W2+W3)×100, where S is learning outcome status, W1 is the sum total of assessment weightages where learning outcomes are met, W2 is the sum total of assessment weightages where learning outcome is partially met; and W3 is sum total the assessment weightages where Learning outcome is not met.

Let's assume, there are three assessments t1, t2, t3 with weightages 5,10,5 respectively. Learning outcomes (objectives) associated with t1 are obj1, obj2, obj3 and for t2 are obj1, obj2, obj4 and for t3 they are obj2, obj3, obj7. Now. Assume for t1 obj1 is met and for t2 obj1 is partially met. Then individual values of objectives are already calculated. Now, the user has to calculate overall status (weighted) of learning outcome. So, for Obj1, it will be like S=((5+10/2)/(5+10))*100 and S=66.6. This calculated value is compared with the configuration table (with percentage range defined for each state) to get the overall learning outcome status.

After this, there are some points where you can view the learning outcome status of students using different parameters like:
i. Student Tasks: In this parameter, it will show status of learning outcome for students and for every task or online exams wherever you mapped a particular objective.
ii. In case of online exam, it will show status for learning objectives that is mapped with particular questions. By clicking on exam name, it will also show status of outcomes for every question that is mapped in the selected exam.

For example, an exam is posted with 5 questions and all those questions are mapped with 1 different learning outcomes, then by click on exam name it will show outcome status for every single question for particular student. On student task screen it will calculate the outcome status for particular student using following formula:

((number of ‘Met’ status count)+(number of ‘Partially Met’ status count)/2)/(Total number of status count)×100

iii. So, now suppose the output for 5 questions is ‘Met’, ‘Met’, ‘Not Met’, ‘Not Met’, ‘Partially Met’. Then,

Number of Met Status count is ‘2’

Number of Partially Met Count is ‘ 1’

Total Number of status count is ‘5’

(2+½)/5×100=50

This calculated value is compared with the configuration table (with percentage range defined for each state) to get the learning outcome status.

In case different tasks (like assignment, Home Works (HW's), Projects etc.) it will show status of every objective that is mapped with that particular task. For example, a task is posted by mapping it with 3 objectives, then on student tasks screen it will show status for that particular 3 objectives for every student.

Tasks: In this parameter it will show the status count for particular task by grouping the student of same outcome status for particular outcome. For example, a task is posted with 1 objective and this task is for 10 students. So, for 5 student's outcome status is ‘Met’, for 3 students it is ‘Partially Met’ and for 2 students it is ‘Not Met’. So, in this parameter, it will show status count for this objective in case of ‘Met’ as 5, in case of ‘Partially Met’ as 3 and in case of ‘Not Met’ as 2.

Lesson Plan: In this parameter it will first calculate the overall status of learning outcome for every student for particular outcome, by considering all the task and exams wherever that objective is mapped, and then show it on the basis of lesson plan. Following formula will be used to calculate over all status of learning outcome and this value will help you to calculated competency score:

S=(W1+W2/2)/(W1+W2+W3)×100

Where S is learning outcome status,

W1 is the sum total of assessment weightages where learning outcomes are ‘Met’, W2 is the sum total of assessment weightages where learning outcome is ‘Partially Met’.

W3 is sum total the assessment weightages where learning outcome is not met.

After calculating the overall status of learning outcome, it will show the status count for particular outcome under particular lesson plan by grouping the student of same outcome status for particular outcome.

For example, in a lesson plan an objective is mapped with 10 student's evaluation, after calculating overall learning outcome status, for 5 students' overall outcome status is ‘Met’, for 3 students it is ‘Partially Met’ and for 2 students it is ‘Not Met’. So, in this parameter, it will show status count for this objective in case of Met as ‘5’, in case of ‘Partially Met’ as 3 and in case of ‘Not Met’ as 2.

Objective Status by Standards: In this parameter, firstly it will calculate the overall status of learning outcome for every student for particular outcome, by considering all the task and exams wherever that objective is mapped and show it on the basis of standards. It will show the percentage value of status.

Following formula will be used to calculate over all status of learning outcome

S=(W1+W2/2)/(W1+W2+W3)×100

Where S is learning outcome status,

W1 is the sum total of assessment weightages where learning outcomes are met, W2 is the sum total of assessment weightages where learning outcome is partially met.

W3 is sum total the assessment weightages where learning outcome is not met.

iv. After calculating the overall status of learning outcome, it will show the status percentage for particular outcome under particular standard by grouping the student of same outcome status for particular outcome. Following formula will be used to calculate status percentage:

(Number of student with particular outcome status)/(Total number of student)×100

For example, in a standard an objective is mapped with 10 student's evaluation, after calculating overall learning outcome status, for 5 students' overall outcome status is ‘Met’, for 3 students it is ‘Partially Met’ and for 2 students it is ‘Not Met’. So, to calculate status percentage of Met:

5/10×100=50%

So, it will show status percentage as 50 for outcome status as ‘Met’ for particular learning outcome under that standard.

Standard Status: In this parameter it will show the number of students on the basis of overall Outcome status percentage for particular standard. Firstly, it will calculate the overall status of learning outcomes and then it will show number of students on the basis of outcome status and percentage value. For example, in one standard there are 4 Learning outcomes and that is mapped to 5 students. For 1 student for all 4 outcomes overall status is ‘Met’, ‘Met’, ‘Partially Met’ and ‘Not met’. Following is the formula to calculate particular Outcome status percentage:

(Number of objectives with particular status)/(Total Number of objectives for particular standard)×100.

Suppose for a student, the user is calculating ‘Met’ status percentage, in an example number of objectives with ‘Met’ Status is 2 and total number of objectives for that standard is 4 so percentage value will be 50%. Now user can select ‘Count Percentage of’ as ‘Met’ and set 50% on scale for that standard then in student count it will show name and ID of that student.

After this, the parameters are used to calculate analysis for different values using overall learning outcome status and competency level. Following is the explanation of those values and Analysis:

Student Competency Level and Score: This analysis will show you the competency level of student on the basis of Standards competency level. Firstly, system will calculate the competency level for particular standard on the basis of learning outcomes those are mapped with that particular standard. Following is the procedure to calculate competency level for standard:

Competency Level for standard: Competency Level is value to evaluate student performance on the basis of lesson performance of students. Competency score can be calculated for each Standard and for individual student. This score helps determining which outcome needs to be revised. Below is the formula to calculate competency score.

S=(C1+C2/2)/C×4

where,

S is student Standard competency score

C1 is Total ‘Met’ Count, which means total learning outcomes of the standard for student where they meet the excellence.

C2 is Total ‘Partially Met’ Count, which means total learning outcomes of the standard for student where they meet the average.

C is Total learning outcomes count, which includes all standards all learning outcomes count including ‘Met’, ‘Partially Met’ and ‘Not Met’ for student.

For Example:

There are two students ST1, ST2 with two standards S1 and S2. The count of ‘Met’, ‘Not Met’ and ‘Partially Met’ is as follow:

| | | Met | Not Met | Partially Met |
|---|---|---|---|---|
| ST1 | S1 | 2 | 3 | 2 |
| ST2 | S2 | 3 | 1 | 2 |

Score for ST1 and S1=((Sum of all objective count where state is ‘Met’+Sum of all objective count where states is ‘Partially Met’/2)/sum of all objective count)*100

S=((2+2/2)/(2+3+2))*4=>1.7

Below is the table to explain competency level

| Competency Score | Competency Level |
|---|---|
| <=1 | 1 |
| >1 && <=2 | 2 |
| >2 && <=3 | 3 |
| Otherwise | 4 |

Using above calculated values, the analysis engine 1010 helps evaluating student performance and determining the learning content that needs to be revised.

After calculating the competency level for every standard for particular student, it will take average of competency level of standards to calculate overall competency level of student. Following formula will be used to calculate average of standards competency level for particular student:

(Sum of competency level for every standard)/(Total Number of standards)

For example, there are three standards outcomes that are mapped with learning content to evaluate student performance, now the competency level for every student for particular standard is 2, 3 and 1. Now after taking average of competency level of standards, the overall competency level for student is 2

(2+3+1)/3=2

By clicking on competency level of student it will show you competency level for every standard for that particular student with competency score.

Here it will also show the ‘Met’ percentage of all objectives those are mapped to learning content for evaluation of student performance. Following formula will be used to calculate ‘Met’ percentage

(Number of objectives with ‘Met’ status)/(Total number of objectives)×100

For example, there are 10 outcomes of 2 standards that are mapped with learning content for student evaluation, in which 6 outcomes are ‘Met’ so the ‘Met’ objective percentage will be 60.

6/10×100=60

By clicking on ‘Met’ percentage for particular student it will show the status of all the objectives that are mapped to learning content for student evaluation.

Using the analysis of Student competency level and Objective status, teacher will create a revise learning plan for students. And while creating plan it will show content of those standard only which doesn't meet the required competency level for student.

Lesson Plan Analysis: This analysis will show the average of competency score and competency level with student count and objective status for particular lesson plan outcomes. First, the system will calculate the competency level using the overall status of learning plan, that user calculated earlier in student tasks parameters.

Competency Level: Competency Level is value to evaluate student performance on the basis of lesson performance of students. Competency score is calculated for each lesson and for individual student. This score helps determining which lesson plan needs to be revised. Below is the formula to calculate competency score:

S=(C1+C2/2)/C×4

where,

S is student lesson competency score

C1 is Total ‘Met’ count, which means total learning outcomes of the lesson plan for student where they meet the excellence.

C2 is Total ‘Partially Met’ count, which means total learning outcomes of the lesson plan for student where they meet the average.

C is Total learning outcomes count, which includes all lessons and all learning outcomes count including ‘Met’, ‘Partially Met’ and Not Met′ for student.

For Example: There are two students S1, S2 with two lesson plan L1, L2. The count of ‘Met’, Not Met′ and ‘Partially Met’ is as follow:

| | | Met | Not Met | Partially Met |
|---|---|---|---|---|
| S1 | L1 | 2 | 3 | 2 |
| S2 | L2 | 3 | 1 | 2 |

Score for S1 and L1=((Sum of all objective count where state is met+Sum of all objective count where states is partially met/2)/sum of all objective count)*100

S=((2+2/2)/(2+3+2))*4=>1.7

Below is the table to explain competency level

| Competency Score | Competency Level |
|---|---|
| <=1 | 1 |
| >1 && <=2 | 2 |
| >2 && <=3 | 3 |
| Otherwise | 4 |

Using above calculated values, analysis engine helps evaluating student performance and determining the learning content that needs to be revised.

After calculating the competency score and competency level of every student using particular lesson plan outcomes status, it will take average of competency score and competency level. For example, there are 10 students with different competency level and score for particular lesson plan outcomes, then it will take average of all using following formula:

(Sum of Competency Score or Sum of Competency level of all students)/(Total number of student).

This competency score and competency level average will also help to calculate the Unit analysis in next step.

Under lesson plan analysis there are different methods to view the different values using different filters, which are explained below:

Standard/Goals/Objective Status: Under this it will show average of competency score and competency level with student count. By click on student count for particular lesson plan, it will show competency score and competency level of every student that user had calculated earlier.

There is two field labeled as ‘Percentage Student’ & ‘whose Competency Score is less than’, these field will help user to filter particular lesson plan and student on the basis of percentage and competency level. Using these filters, it will show only those lesson plans in which that much percentage of student whose competency level is less that that particular entered value. For example, a lesson plan which is mapped to ten (10) student evaluations, in which for six (6) students competency level is ‘2’ or less than ‘2’. Following is the formula to calculate percentage:

(Number of Students with particular ‘Competency Score is less than’ value)/(Total Number of student)×100

So now there are six (6) students whose competency scores value is less than ‘2’ and total number of students are 10 so percentage value is 60.

Now if user enters ‘Percentage students’ as 60 and enter ‘whose competency score is less than’ ‘2’, then it will show you that particular lesson plan details that user had taken above and also under student count it will show all those students whose competency score is less than ‘2’.

Objective/Outcome status: Here user will also view the student percentage for outcome status those are mapped with that particular lesson plan, for example a lesson plan with one (1) learning outcomes. In this outcome, overall ‘Met’ percentage is 60% of students, 25% of students with ‘Partially Met’ status and 15% of students with ‘Not Met’ status. Then in graphical view it will show you percentage of student for that particular objective status. Following is formula to calculate student percentage for objective status:

(Number of students with particular objective status)/(Total number of students)×100

Teacher can also view e-learning and notes which are mapped with that particular lesson plan, so that it will help Teacher to analysis that for these lesson plan, these contents is needs to revise

Average Competency Score: Under this, the IEMS 116 shows Average of competency score and competency level with student count. When a user clicks on student count for particular lesson plan, the IEMS 116 will show competency score and competency level of every student that user had calculated earlier.

There is one additional field/filter that is labeled as ‘Average competency score below’, these field will help user to filter particular lesson ‘plan and student on the basis of percentage and competency level. Using these filters, it will show only those lesson plans in which the percentage of student competency level is less than that of a particular entered value. For example, a lesson plan, which is mapped to 10 student evaluations, and in which for sic (6) students competency level is ‘2’ or less than ‘2’. Following is the formula to calculate percentage:

(Number of students with particular ‘Competency Score is less than’ value)/(Total Number of student)×100

v. In the above, there are six (6) students whose competency score value is less than two (2) and total number of students are ten (10) so percentage value is 60.

Now, if user enter value of ‘Percentage students’ as 60 and enter value of ‘whose Competency score is less than’ as 2, then it will show the particular lesson plan details that had scored above 60 and under student count it will show all those students whose competency score is less than ‘2’. Under student, the system will show all the students which are mapped to the lesson plan for evaluation. It will also depict details of competency score and competency level.

Objective/Outcome Status: The user can also view student(s) percentage for outcome status those are mapped with a particular lesson plan, for example a lesson plan with one (1) learning outcome, the ‘Met’ percentage is 60% of students, 25% of students with ‘Partially Met’ status and 15% of students with ‘Not Met’ Status. Then in graphical view, it will show you percentage of student for that particular objective status. Following is the formula to calculate student percentage for objective status:

(Number of students with particular objective status)/(Total number of students)×100

Teacher can also view e-learning and notes which are mapped with that particular lesson plans, so that it will help teacher to analyze the lesson plans and identify if content of the lesson plans needs to be revised.

Average task score: All the tasks for a particular lesson are depicted. This also shows score of the tasks by taking average of marks for every student for the tasks. Following formula will be used to calculate average:

(Sum of score of all student for particular task)/(Total number of student)

In this, there is a filter labeled ‘Score below’ that helps the user to filter particular task under score, for example if user enter value in ‘Score below’ as 60, then it will show all the task whose average score is less than 60. This will help the user to analysis which lesson plan need to revise for students.

Unit Analysis 1013b: In this analysis, it depicts the units with student percentage for outcome status that are mapped with a particular unit/topic, for example a unit/topics is mapped with ‘1’ learning outcomes, for that outcome overall ‘Met’ percentage is 60% of students, 25% of students with ‘Partially Met’ status and 15% of students with ‘Not Met’ status. Then in graphical view it will show percentage of students for the particular objective different status. Following is formula to calculate student percentage for objective status:

(Number of Students with particular Objective status)/(Total Number of students)×100

There is one field labeled as ‘Average competency score of lesson plan below’, this field will help teacher to filter the particular units on the basis of Average competency score of lesson plans. Once the value is entered in the respective field it shows only those units for which a lesson plan average competency score is less than the entered value. For example, a unit topic is map with two (2) lesson plan in that lesson plans, one (1) lesson plan average competency score is two (2) and for other average competency level is three (3) and in field ‘Average competency score of lesson plan below’ the value entered is two (2), so the system will show units as for 1st lesson plan for which average competency score is two (2).

Now consider an example, where other unit is mapped with two lesson plans, for one lesson plan average competency score is two and for other average competency score is three and in the field ‘Average competency score of lesson plan below’ the value entered is one, so it will show not show any unit as for both lesson plan average competency level is greater than one. In an embodiment, the teacher(s) can also review e-learning and notes which are mapped with that particular lesson plan, so it will assist teachers to analyze the lesson plan, and they can identify if the contents need to be revised.

Which Task Need Revision 1013c: In this it will analyze and provide the task based on the percentage of student with particular objective status. There are two fields labeled ‘Percentage students’ and ‘Whose status is’, these fields will help to filter the tasks. It will show those tasks whose outcome status (which is selected in ‘Whose Status is’ field) is equal to or greater than student objective status percentage (which is entered in ‘Percentage Student’). First, it will calculate the overall outcome status of student for a task. The following formula will be used to calculate overall outcome status:

((Number of ‘Met’ status count)+(Number of ‘Partially Met’ status count)/2)/(Total number of status count)

vi. For example, there are three (3) objectives mapped with particular task, and status for three (3) objectives is ‘Met’, ‘Not Met’ and ‘Partially Met’.

Number of ‘Met’ status count is: 1

Number of ‘Partially Met’ count is: 1

Total number of status count is: 3

(1+½)/3=0.5

This calculated value is compared with the configuration table (with percentage range defined for each state) to get the overall learning outcome status. After calculating overall learning outcome status for particular student and task, it will group the students for a task to calculate a percentage status for the task. Following formula will be used to calculate percentage student for particular objective status:

(Number of students with particular objective status)/(Total number of students)×100

Suppose there are 10 students mapped with particular task, and overall objective status is calculated for every student for that particular student. Now there are 5 students with ‘Met’ status, 3 students with ‘Partially Met’ status and 2 students with ‘Not Met’ status. So, student percentage for ‘Met’ Status is:

5/10×100=50

Average score: In this, the IEMS 116 shows all tasks with their score by taking average of marks for every student for each task. Following formula will be used to calculate average:

(Sum of Score of all students for particular task)/(Total number of student)

Also, there is one filter labeled ‘Score below’, it will help users to filter particular task under score, for example, if a user enter value in ‘Score below’ as 60, then it will show all task whose average score is less than 60. This will help the user to analysis which task need to revise for students.

Which Learning Content/Sets Need revision 1013d: Through this, learning contents sets are mapped with lesson plans, on the basis of Average competency score of lesson plan. So, it will help teachers to find which lesson content is needs revision for students on the basis of competency level.

There is one field labeled ‘Average competency score of lesson plan below’, it will show only those lesson plan and learning content/sets for which average competency score is less or equal than the entered value in that field. For example, a lesson plan is mapped in two (2) learning content sets, and average competency score of that lesson plan is two (2), now enter ‘Average competency score of lesson plan below’ as two (2), it will then show lesson plans with both learning content/sets for which lesson plan average competency score is less than two (2).

Which notes need revision 1013e: This shows all the notes that are mapped with lesson plans based on the Average competency score of lesson plan. It will help teachers to find which lesson content needs revision for students on the basis of competency level.

There is one field labeled ‘Average competency score of lesson plan below’, it will show only those lesson plan and notes for which average competency score is less or equal to the value entered in this field. For example, a lesson plan is mapped in two (2) notes, and average competency score of that lesson plan is (2), then enter ‘Average competency score of lesson plan below’ as two. Hence, the system will show the lesson plan with notes for which the lesson plan average competency score is less than two.

After creating all the learning content, a teacher will create different types of learning plans, so that student will make their submission and can view/read the content for their learning. The learning plans can be created using all types of learning content in the system. Using these plan students can view/attempt all the learning data on single screen. At 1015a, if the students have not met the expectations then learning plans 1016 are generated. The learning plans 1016 can include teacher driven learning plans 1016a. The teacher driven learning plans 1016a can be provided to the students as a default learning plan 1017a, a daily learning plan kindergarten 1017b and an individual student learning plan 1017c.

At 1015b, if the students have met the expectations then the students' learning is considered completed. At 1018, the flow of information in the analysis engine 1010 ends.

Individual learning plans 1016: Based on competency scores for each lesson and unit, student profiler, content profiler, the machine learning enables/recommends individual learning plans. There are multiple types of learning plans that are generated by the IEMS 116. Some of the individual learning plan is defined below:

Daily learning plans: These plans are provided to a group of students, independent of student performance.

Teacher driven group plans: These plans are provided by teachers to a group of students and are independent of student performance.

Teacher driven individual learning plans for each student: These are learning plans that are created without taking in to account student performance. These plans can be created for whole class, group of students or only for individual student. Purpose of these learning plans is to present a well-organized way of selected content for revision of the topic.

System generated learning plans for each student: Performance based learning plans are created after evaluating and analyzing student performance in assessments/online Exams from all types of learning content. These plans are directly linked with learning contents. Based on objective (learning outcome) status and standard competency score, student's overall performance (competency score) is calculated. Multiple reports from analysis engine along with system recommended student learning plan are then presented to the teachers. In an embodiment, the teachers can also create individual learning plan with modifications, if needed. Teachers can also completely modify these learning plans and provide customized learning for each student.

Student use of Individual learning plans: Each student using the IEMS 116 can be assigned multiple learning plans for each course. They can select and activate a single learning plan for ease of use. For example, student A has five courses assigned to him/her and each course has one or more learning plans, and one of the five courses say ‘ELA’ has 4 individual learning plans (i.e. ELA-1, ELA-2, ELA-3, ELA-4) assigned for the student A. The student A can then activate only one learning plan at a time If the student A activates plan ELA-2, then learning plan ELA-2 is visible on all screens, through a proprietary hide/show mechanism.

Student A can move step by step for the activated plan and go through the different learning objects and assessments at their own pace. The learning objects/assessment of each individual's learning plan is locked down in an order. The student must learn as per the order provided in the plan. The teachers can also observe and monitor the progress of each student for each assigned learning plan and they get multiple reports on the activities. Teachers can re offer learning plans to students.

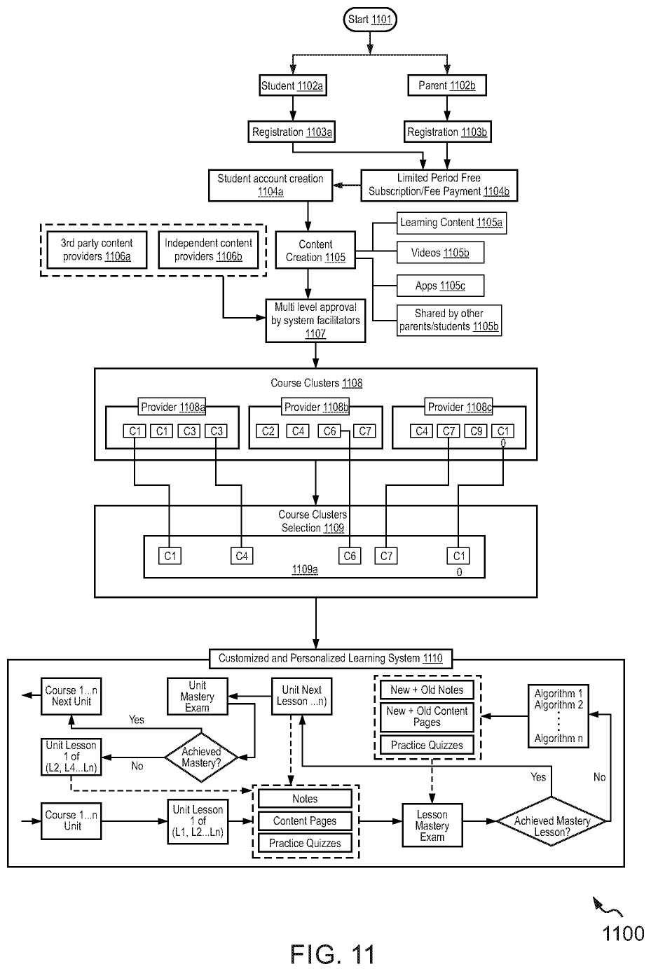

FIG. 11 illustrates a flow diagram 1100 depicting a flow of information for handling customized and personalized learning module of the IEMS 116, in accordance with another example embodiment of the present invention. At 1101, the flow of information for handling customized and personalized learning module starts. In the FIG. 11, the first step is to register student 1102a and/or parent 1102b through registration 1103a and registration 1103b respectively. The fee is then paid by the registered party (i.e., the student 1102a and the parent 1102b). After the registration 1103a and the registration 1103b, a student account 1104a for the registered party is created. The student account 1104a can be created for limited free period subscription/fee payment 1104b.

It then performs steps like content creation 1105. The content creation 1105 include learning content 1105a, videos 1105b, apps 1105c, as well as contents shared by other parents/students 1105d. The contents can be provided by 3rd part content providers 1106a and independent content providers 1106b. These contents undergo a multi-level approval by system facilitators 1107.

Further, course clusters 1108 are created. The course clusters 1108 include clusters of courses provided by different providers, such as provider 1108a, provider 1108b and provider 1108c. From the course clusters 1108, one or more courses 1109a is selected based on course clusters selection 1109. For example, the one or more courses 1109a include two courses provided by provider 1108a, one course provided by provider 1108b and two courses provided by provider 1108c.

Based on the course clusters selection 1109, customized and personalized learning module 1110 (e.g., customized and personalized learning module 205 of FIG. 2A) is activated. The customized and personalized learning module 1110 includes various elements that are described and defined below:
Learning outcomes (Objectives): A student is expected to be able to do perform these objectives as a result of a learning activity. The learning outcome suggests what skill, knowledge or behavior student is able to learn, demonstrate, and practice, as a consequence of a learning activity. It also includes attitudes, and habits of mind that students receive from a learning experience.
Unit: The element used in the IEMS 116, which refers to a particular topic taught in course. It is the combination of lessons that are linked by concepts. It consists of concepts and learning goals that are taught over a period of time and are knitted together, often across subject areas. In the IEMS 116, course unit includes name, standard level, generic course type, time-period and rubrics associated with the units. The detailed description of the unit and brief overview of the lessons is also included.
Lesson: This is part of unit, a lesson may be either one section of a learning content group or, more frequently, a short period of time during which learners are taught about a particular subject or taught how to perform a particular activity. Usually lessons have a time slot of 50 to 70 minute and include subset of standards, skills and learning outcomes that lesson unit have. Lesson also includes name, associated unit, start-end date, sessions, minutes allotted, reference links (websites and books), standard level, course type, rubrics associated and detailed information of lesson which generally includes introduction to topic, foundation, body of new information and other information associated with it.
Learning Outcome/Objective Score: The score assigned to each learning outcome is on a scale to 1-5. It is the number computed for each objective from the student performance based on assessment(s) results that describes the skill or competency level of the students.
Learning Outcome/Objective Status: This is a textual value associated with each score. For example, the scores/status for ‘Met’ (Excellent) is 5, ‘Met’ (Very Good) is 4, ‘Partially Met’ (Normal) is 3, ‘Partially Met’ (Average) is 2 and ‘Not Met’ is 1.
Competency Score: It is number calculated from student evaluation from exam performed.
Competency Level: This is linked with competency score and represents the whole (rounded off) value associated. If the competency score is less than 1 it is denoted with 1, for greater then 1 and less than 2 it is 2, for greater than 2 and less than 3 its 3 and else its 4.
Notes: This is recorded information captured for each lesson. The creator records the essence of the information, freeing their mind from having to recall everything. The notes must acquire and filter the incoming sources, organize and restructure existing knowledge structures, comprehend and write down their interpretation of the information, and ultimately store and integrate the newly processed material. The notes also include name, lesson, tentative date, reference links (websites and books), and detailed information of lesson which generally includes topic then sub topic followed by its detail.
Questions: These are directly associated with learning outcomes and helps evaluating the student learning.
Reinforcement Learning
Assumptions: For each course the IEMS 116 includes predefined units, lessons, one or more learning outcomes assigned to lessons. Notes, e-learning sets with pages are also part of lessons, question bank for each lesson of unit.
Rnext Policy: The user uses proprietary policy which is explained below:

Algorithm—Course 1—Learning Level 1

For each lesson of unit there are different Sections. Each section is described below:

Section 1: Choosing Learning Outcomes (Objectives)

If enough data is available from learners past history then, determine a count ‘C’ of available learning outcomes for the lesson. It is the number count of learning outcomes that is present in a database. This also include the outcomes defined/created by parent for student learning while registration process.

Calculate objective count C1 to be selected for first learning level.

C_1=C*x/100

Where x is percentage based on expected competency score of students

Select objectives which have more probability of getting passed in first level of learning. This is achieved by using counters values from Section 4 (described below) and from step 6(c). For example, counter values are:

Learning Outcome

TABLE 2

| Learning Outcome | S₁ | S₂ | S₃ | S₄ | S₅ |
|---|---|---|---|---|---|
| O1 | 2267 | 456 | 345 | 545 | 494 |
| O2 | 456 | 534 | 454 | 234 | 656 |
| O3 | 344 | 654 | 323 | 122 | 675 |
| O4 | 123 | 55 | 68 | 64 | 34 |

As shown above in table 2, preference is given to O1 and O4 here as the S1 (‘Met’ counters) is more than other counters.

If enough data is not available, then determine the count of available learning outcomes for the lesson. It is the number count of learning outcomes that is present in system database. This also include the outcomes defined/created by parent for student leaning while registration process.

Calculate objective count to be selected for first learning level.

C_1=C*x/100

Where x is percentage based on expected competency score of students

Select C1 number of learning outcomes randomly out of total learning outcomes available.

Section 2: Identify content to be displayed

Fetch expected competency scores by student/parent.

Determine the learning content count available. It is the number count of available content either from 3rd party content providers, independent content creators or from parent defined learning material for student.

Filter down the learning material to get the exact count and algorithm that can use for processing. It uses student expected score along with difficulty level of content available to accomplish this.

C1=C*(expected Competency Score/course Competency Score)

Where C1 is filtered content count and C is content count from step 2 with difficulty level. Thereafter, calculate the percentage ratio for each learning material type available from step 3 by using the count from step 2. For example, in normal cases it is 40 percent notes (text and multimedia) and 60 percent e-learning material with pages.

Then determine learning content count along with length of each material to be selected based on availability of learning material and expected competency score defined.
If((S<N&T>N)∥E<60)

Acquire only 60 percent of initial content pages from overall e-learning pages available; else

Acquire full E-Learning pages

Where S is selected content count, N is number defined, T is total content count available. E is the expected competency score percentile value.

Choose learning content to be used—This involves Q values calculated by other learner's performance history along with difficulty level of learning material. Refer to section 5 for additional details. After choosing the learning content material, system algorithm includes 10-20 percentage randomly selected other content, that are less used, to explore better learning options of same topic. Thereafter, the selection is stored in the database.

Section 3: Select Questions for Lesson Mastery Exam

Prior to calculating question count, determine the questions available in the IEMS 116 based on learning outcomes associated with lesson from section 1, the difficulty level associated and student expectancy competency value. For example, assume that the learning outcome count is a value C. Thereafter, lower down the number of learning outcomes to be used for mastery exam by a fixed percentage (say 60 percent) which can be altered as per requirement.

C_1=C* 60/100

Multiply the count value in step 1 above by 0.6 to obtain the number.

Now acquire C1 number of outcomes on random basis out of C. Then identify the separate count for each learning outcomes with single question available and learning outcomes with multiple questions. For the purpose of this description name the outcome as A and B. Thereafter, store selected outcomes in database. Identify the question count to use in mastery exam (calculation involves factors like available question count from point 3, difficulty level of questions and student expected score).

Multiply the count C1 from step 2 above by 1.5 to obtain a value ‘Q’. Select Q number of questions by including certain fixed ratio of questions from A and B with unique and random order of difficulty level for questions of B.

Acquire questions from the question bank and store it in database.

Section 4: Update database after Lesson/Unit mastery exam

Assuming there are 5 questions Q1, Q2, Q3, Q4, Q5 with learning outcomes 01, 02, 04, 01, 07 respectively. Student has corrected response for Q1, Q2 and Q5.

Then acquire student learning outcome final status by evaluating student exam result. This is accomplished by checking the student exam question response. Formula used to calculate learning outcomes (associated with multiple questions) status S is

S=( [symbol] ΣW [symbol] _1*L/(( [symbol] ΣW [symbol] _1*L)+( [symbol] ΣW [symbol] _2*L))

where W1 is number associated with difficulty level of question with correct answer, W2 is for incorrect answers and L is current learning level of student. S value is compared with database table (with percentage range defined for each state) to get the learning outcome exact status. Further, update the learning outcome status calculated from step 1 above to update the value in the database. Additionally, update lesson combined competency score by combining the status values of learning outcomes present under the lesson.

In the algorithm, the combined competency score CS is obtained as

CS=(Σ(S*E))/T

where ‘S’ is value for learning outcome status, ‘E’ is count of learning outcomes associated with status and ‘T’ is total learning outcomes. For example, total learning outcomes associated with lesson are ‘10’ in which three (3) of which are ‘Met’ (excellent), two (2) are ‘Met’ (good), two (2) are ‘Partially Met’ and two (2) are ‘Not Met’, then competency score will be:

(((3*5)+(2*4)+(2*3)+(2*1)))/10

i.e. 3.1

Update unit learning outcomes status in database using values calculated from step 2.

Similarly, update unit lesson competency score using values calculated from step 3.

Next step involves storing/updating sequence, its learning content and learning state values in database. Hence, the values are stored in database after calculation. Thereafter, compare the current content and learning outcome sequence with learner's data already present in the database.

Assume the content sequence is C1 C7 C3 C4 . . . Cn and learning outcome sequence is O1 O3 O7 . . . On. Both sequences in defined order is compared (string match) with database records to get the unique sequence. If no matches found, new sequence is generated and used.

If new sequence is generated, then insert current content sequence in database table.

Insert/update state learning outcome sequence with counters of states stored along with it. S1 is for ‘Met’ (excellent) counters, S2 for ‘Met’ (good), S3 for ‘Partially Met’ (normal), S4 for ‘Partially Met’ (average) and S5 for ‘Not Met’.

In an example, the same learning objective and learning level record is already present with counter values and current outcome state value is partially met (which is 3). Thereby, updating S3 with S3+1.

Section 5: Update Q values for each learning outcome

Reward would have a minimum value of 25

Reward would have a maximum value of 100

Archive student learning data for lesson current learning level. Student current learning level records which include lesson, associated learning outcomes, learning content, questions for quizzes and mastery exam and their responses are moved to history table in database. Thereafter, determine the next action (selection of content) to be taken for student for lesson. Action in that case will be nil if student achieved the competency.

Update Q values using a predefined algorithm like SARSA. Q values are updated for each learning outcome and its combination with learning content available for lesson. The method then acquire the learning outcomes (0) and their combination with learning content(C). Thereafter, the method

Fetch the current (Sc) and previous (SP) state (status value) of each unique combination of learning outcome with content.

Fetch maximum (QMN) and average (QAN) q values of new action (QCN) (learning content).

[symbol]

QM [symbol] _N=MAX( [symbol] QC [symbol] _N)

[symbol]

QA [symbol] _N=AVG( [symbol] Q [symbol] _N)

For each unique combination of learning outcome with content:

Get reward value R for moving from state 1 SP to state 2 SC.

Fetch the present Q values of learning outcome and learning content combination. QMO and QAO.

Calculate new Q values using below formula

[symbol]

QM [symbol] _1= [symbol] QM [symbol] _O+α*(R+γ* [symbol] QM [symbol] _N− [symbol] QM [symbol] _O)

[symbol]

QM [symbol] _2= [symbol] QA [symbol] _O+α*(R+γ* [symbol] QA [symbol] _N− [symbol] QA [symbol] _O)

The “alpha” factor (α) for the formula stands at 0.8 (which can be altered as per requirement).

The “gamma” factor (γ) for the formula stands at −1 (which can be modified as per the need).

Section 6: Update Q values for sequence

Algorithm—Course 1—Next Learning Levels

For each lesson of unit

Section 1: Choosing learning outcomes (Objectives)

Select learning outcomes NMC which are ‘Not Met’ in last learning run.

X % of outcomes where student learning outcome PMC status is ‘Partially Met’ (average) and ‘Partially Met’ (normal).

Y % of outcomes is predicted where the status is ‘Met’ (excellent) and ‘Met’ (good) and wherein Y is always less than 10.

Total learning objectives to be selected are calculated using:

C_N= [symbol] NM [symbol] _C+( [symbol] PM [symbol] )_C*X/100)+(M_C*Y/100)

Section 2: Choosing Learning Material Using COUNTERS

Count (CR) for content for learning material is calculated based on learning outcomes count selected. Formula used for calculating count is

C_R=C_L+((C_T−C_L)*β)

Where CL is content count in last learning run, CT is total content available and β is increase factor.

Content Selection—Using COUNTERS

Select learning content by using learning objective state COUNTERS values. This involves exploration, reuse of learning content from experience.

X % of content exploration, where X is defaulted to 19 and is configurable.

C_X=C_R*X/100

Select CX number of contents for exploration, content that is not the part of learner's history. For each learning outcome, calculate exploration score for content combination having low values of counters. Further division of CX is made to obtain a fixed ratio of e-learning sets and notes.

Y % of content reuse. For each leaning outcome and its association with learning content, calculate the learning score R by using weighted values (X %) of counters, weighted values (Y %) of detailing of content and weighted values (Z %) of content read status. These values vary depending upon the learning outcome status in last learning run.

If learning outcome status is not met in last learning run

R_i=(X*C_C)+(Y*C_D)+(Y*C_R)

where X is given value of 0.6 and C_C is value associated with ‘Met’ (Excellent and Good) percentage of learning outcome and content combination. Y is assumed 0.25, when content detail level CD is more than average detail level of content in last leaning run and 0 if detail level is less than previous. Z is assumed 0.15 is content is not the part of student previous learning runs.

If learning outcome status is partially met in last learning run, then

R_i=(X*C_C)+(Y*C_D)

where X is given value of 0.6 and CC is value associated with ‘Partially Met’ percentage of learning outcome and content combination. Y is assumed 0.25, when content detail level CD is more than average detail level of content in last leaning run and 0 if detail level is less than previous. Combine results from above to calculate the overall rank of content.

Select X % of content with low rank of exploration score and Y % content with high rank of learning score. Thereafter, combine results from above steps to get the final list of learning content.

Content Selection—Using Q Values

Select learning content by using learning objective state Q values. This involves exploration, reuse of learning content from experience X % of content exploration, where X is defaulted to 19 and is configurable.

C_X=C_R*X/100

CX number of contents is available for exploration, content that is not the part of learner's history. For each learning outcome, calculate exploration score for content combination having low values of counters. Further division of CX is made to obtain a fixed ratio of e-learning sets and notes.

Y % of content is reused. For each leaning outcome and its association with learning content, calculate the learning score by using weighted values (X %) of Q values, weighted values (Y %) of detailing of content and weighted values (Z %) of content read status. These values vary depending upon the learning outcome status in last learning run.

If learning outcome status is not met in last learning run

R_i=(X*C_C)+(Y*C_D)+(Y*C_R)

where X is given value of 0.6 and CC is value associated with ‘Met’ (Excellent and Good) percentage of learning outcome and content combination. Y is assumed 0.25, when content detail level CD is more than average detail level of content in last leaning run and 0 if detail level is less than previous. Z is assumed 0.15 is content is not the part of student previous learning runs.

If learning outcome status is partially met in last learning run

R_i=(X*C_C)+(Y*C_D)

where X is given value of 0.6 and CC is value associated with ‘Partially Met’ percentage of learning outcome and content combination. Y is assumed 0.25, when content detail level CD is more than average detail level of content in last leaning run and 0 if detail level is less than previous.

Combine results from step (c) above to calculate the overall rank of content.

Select X % of content with low rank of exploration score and Y % content with high rank of learning score.

Combine results from the above step to get the final list of learning content.

Student will be shown with the following system generated structure

COURSE 1

Unit 1
Lesson 1, Lesson 2, Lesson 3

Unit 2
Lesson 4, Lesson 5

. . .

Unit n
Lesson n−2, Lesson n−1, Lesson n

All the Units—Lesson combination are locked except the first unit—Lesson and there is limit to the extent of content student can study in single day. When student starts learning the unit lessons, student can see practice quizzes for the lesson after reading certain content or after some span of time. Once, student reaches the end of lesson, then student have to attempt the Lesson Mastery Exam.

Following are the process steps for Lesson Mastery Exam:

Open Unit—Lesson 1

Read Lesson Notes 1

Read Lesson Content Page 1

Practice Quiz 1

Read Lesson Notes 2

Read Lesson Content Page 2

. . .

. . .

. . .

Lesson Mastery Exam

If a student fails, the same lesson will be repeated for student but with new content along with different combination/ordering of old notes and content pages.

If student passes the Exam, then next lesson option will be available to student to read.

After reading/learning all the Lessons of Unit—Unit Mastery Exam is given to student to evaluate the learning level.

Following are the process steps for Unit Mastery Exam:

Open Unit of course
Read Lesson 1—Lesson Mastery Exam
Read Lesson 2—Lesson Mastery Exam

. . .
Read Lesson n—Lesson Mastery Exam
Unit Mastery Exam

If student fails, same Unit will be repeated for student but with new lessons along different combination/ordering of old lessons (in which competency level is ‘Not Met’) and their notes and content pages.

If student passes the exam, the next unit of course option will be available for students to read.

Dynamic roles and access: System has ability of dynamic roles where a dynamic user can have:

Access to one of more modules based on role type;

Access to one of more functionalities of the module;

Access to different departments for the chosen functionality;

For example:

For Level 1: A user role can be created which has access to 4 modules (attendance, grades, learning plans and fee accounting).

For Level 2: For each module, the user can get access to sub functionalities, attendance entry, grade view, learning plan approval, fee reports.

For level 3: For each functionality, the user role can access one or more departments/schools within the institution e.g. middle school and primary school.

Multiple Interfaces: System has multiple interfaces for different types of roles

Student Login: Three (3) interfaces and apps including single click interface.

Teacher Login: Two (2) interfaces and apps.

Parent Login: Two (2) interfaces and apps

Other logins: Two (2) interfaces

Single Click Interface: Single click interface to help users to navigate between functionalities. The interface is user friendly and easy to navigate. There are no redundant or unnecessary clicks buttons or clicks. All functionalities, useful reports, daily routine activities are well managed on one screen. Daily alerts, activities, schedules, events, assignments, projects, assessments, grades, notes, learning plans, profile, notifications, email updates are available on single click of mouse. The users can create shortcuts for daily used things. Further, the users can move from one part of module to another in single click.

Single Point of Data Entry: Any data entered in the system for a functionality is directly accessible by any other functionality. The system eliminates the need of duplication of data entry. For example—student data entered once can be used in library, fee management, transportation, learning plans, and the like.

Defined Workflows in all modules: All modules and functionalities in the software have predefined and configurable workflows that makes tasks easier for the users to understand the usage flow.

Approval Processes: Up to six levels of configurable approval process for different modules and functionalities. Some of the approvals are listed below:

Student leaves approval; Faculty/staff leave approval; Attendance approval; Grades management approval; Report card/Transcript approval; Budgeting approval; Salary approval; Supplemental wages approval; Accounting transaction approval; Budget event approval; Budget committee/area approval; Purchase order approval; Purchase order event approval; Purchase order committee/area approval; Expense approval; Expense event approval; Expense committee/area approval; Invoice approval; Invoice event approval; Invoice committee/area approval; Event & area management—requisition approval; RFP approval; Asset/inventory approval

Dynamic report writer and predefined reports: the IEMS 116 has more than 1500 built in reports which are available in PDF, Graphical, and Excel format. The dynamic report writer module gives the ability to pull data from any modules of the software and create desired reports.

Virtual School: The IEMS 116 can be used as a complete virtual school. Hence, students and/or teachers is not required need to be present in the classroom to attend the class. The teachers can create online courses, assignments, contents assessments, and the like for the students. The student/parent can register themselves by choosing their courses. The Parent can monitor all the progress of their children in a single window. It provides such a platform, that technical/non-technical users (teachers/parents) can create student learning content for student better performance and can also monitor the progress.

Single installation for multiple instances: The IEMS 116 is more flexible to handle multiple instances on single installation. Organization can manage their multiple institutes on single system and single server. There is no need to install different software for different departments like accounting, HR, payroll, transportation, library, and the like.

Distance Education: Physical learning centers connected to one system (i.e. main campus). Online integration of regional and distance learning centers, online student registration, fee payment and approval process, assignments, projects, assessments and grading with MIS reports. The main campus has access of all the centers and can manage and monitor all the activities of the centers remotely.

Workspace: A unique one of a kind project space for teachers and students to work in collaboration with other students. The workspace includes report writing, document versioning, forums for discussion, project planner and project management for team. The uniqueness is in the face that is part of the advanced learning system and can leverage all learning features.

Online Exam Process: The IEMS 116 has a unique online assessment module which has multiple features which includes, scheduling, assigning a type of online exam with various functionalities like:
i. Dynamic question bank from multiple vendors;
ii. Multiple types of exam and assessment features;
iii. Official exams;
iv. Practice exams;
v. Different categories of questions and types of exams;
vi. Random question/fixed question exams;
vii. Tool for question selection linked with learning outcomes;

2 or 3 factor login mechanism for students attempting the exam called the exam check-in process;

A customized timer and algorithm for browsers which is intelligent enough to identify internet outage;

Auto connection with grade module for posting of grades;

A separate student exam login from the main student login for attempting exams and assessments;

Integration with assessments;

Learning System for faculty and teachers: The IEMS 116 has a very unique feature of a learning model for teachers where teachers can become students and can use the full learning system for any of their research, training and assessments.

Advanced Grading System: Grades management is handles through nine (9) different types of screens and in multiple layers along with:

Different types of grade entry—Normal scoring, Letter grading, rubric grading, learning outcomes grading;

Normalization of grades at task level—By scaling/simple normalization and by T-Score;

Auto score compilation at task level, at quarter or semester level and final academic year level;

Calculation of competency score and competency level for each learning outcome;

Proprietary algorithm for calculating grades at different levels (Task level, term level, final level) and the finalization process;

Multiple levels of approval before generating the transcript;

3 layered—Double Entry Accounting: System has a complete double entry accounting system with unique algorithm of posting a double entry which is visible on screen as the user is creating or entering a transaction;
i. Auto division of amount based on configuration;
ii. Back-end calculation and real time displays to the user;
iii. Transaction access to the users;
iv. Approval process of all transactions;

System has a 3-layered structure in accounting and works on a unique financial year session different from the academic session;

Layer 1: Virtual books for fee management, accounts payables and receivables, tax receivables, fee receivables;

Layer 2: Accounting Journal and sub journals;

Layer 3: General Ledger and Sub ledgers;

Single point of entry of accounting data and any transaction entered at Layer 1 automatically goes in to all journals, sub journals, ledgers and sub ledgers;

Unique accounting double entry screens with fund election, account selection, sub account selection, budget line item selection;

Unique step by step process for creation of account expense and collection statements, cash statements and balance sheet;

Unique financial session change process management;

Multi fund accounting system: System has a unique feature of creating and maintaining different books, account statements, balance sheets for different funds in the single installation and instance. For example, if a school district has seven (7) different types of funds, they can maintain seven (7) different sets of books which can provide individual fund accounting and integrated fund accounting.

Integrated procurement process: System has a unique and integrating procurement and budgeting process. All steps are linked with budgeting.

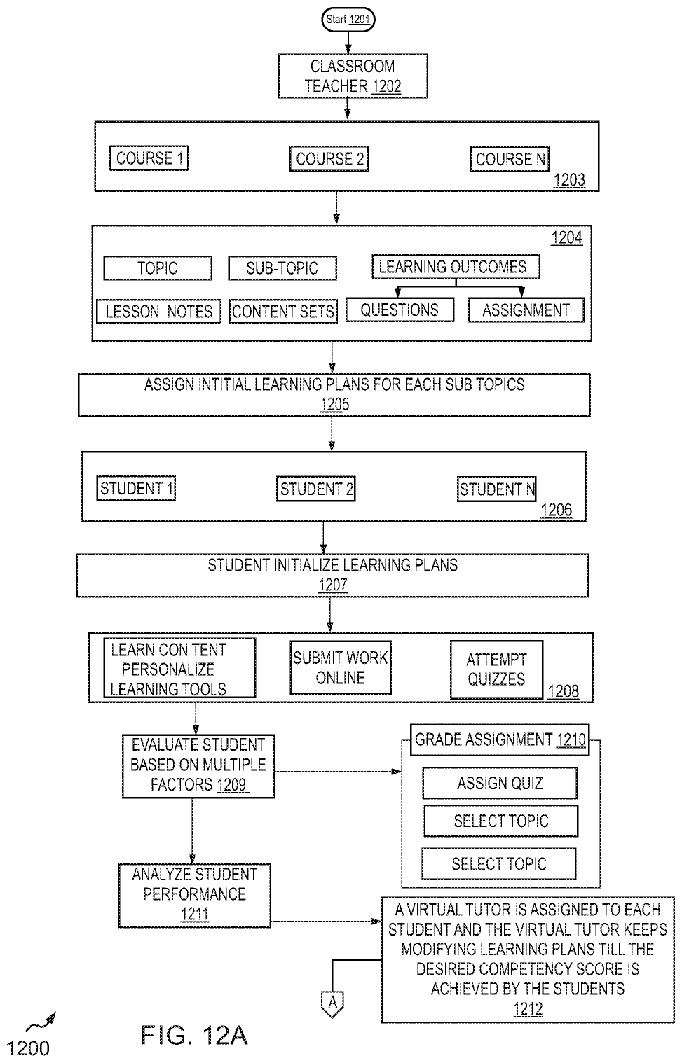

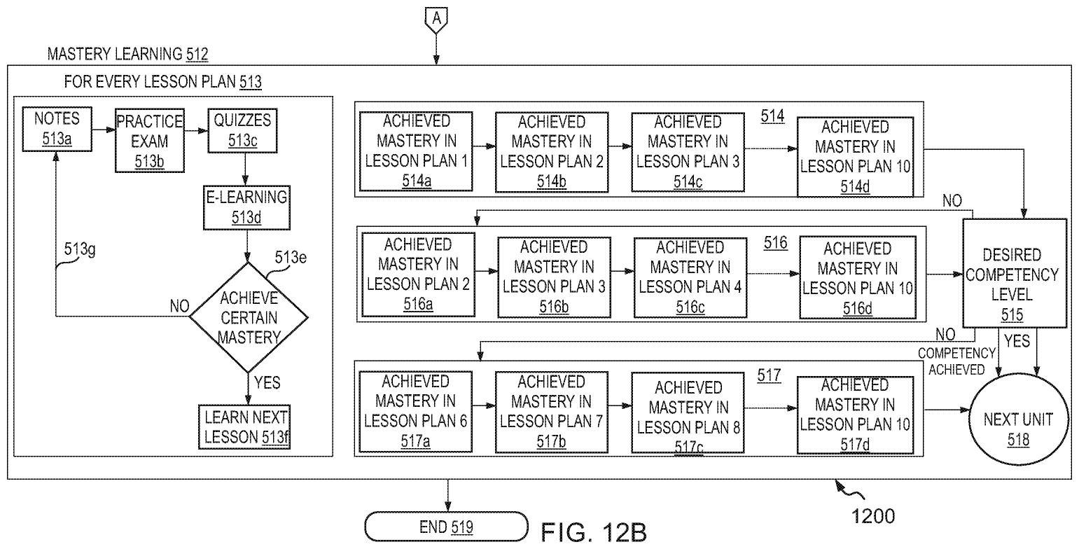

FIGS. 12A and 12B collectively show a flow diagram 1200 depicting classroom teacher configuration, in accordance with an example embodiment. At 1201, the configuration of classroom teacher starts. At 1202, a classroom teacher is created. At 1203, courses, such as course 1, course 2 and course N are created. At 1204, the courses are organized into topic, sub-topic, learning outcomes, lesson notes, content sets, questions and assignment.

At 1205, the classroom teacher 1202 assigns initial learning plans for each sub-topic. At 1206, the classroom teacher 1202 provides the initial learning plans for each sub-topic to students, such as student 1, student 2 and student N. At 1207, the students initialize learning plans. At 1208, the students learn content with personalize learning tools, submits work online and attempt quizzes.

At 1209, the student is evaluated based on multiple factors. At 1210, based on the evaluation assignment of the students are graded. At 1211, the evaluation output is provided to analyze student performance. An analysis report is generated for analyzing the student performance. At 1212, a virtual tutor (intelligent agent) is assigned to each student. The virtual tutor keeps modifying learning plans till the desired competency score is achieved by the student. The virtual agent accesses the master learning module to modify the learning plans. The mastery learning module is explained with reference to FIG. 5B and is not explained again for the sake of brevity.

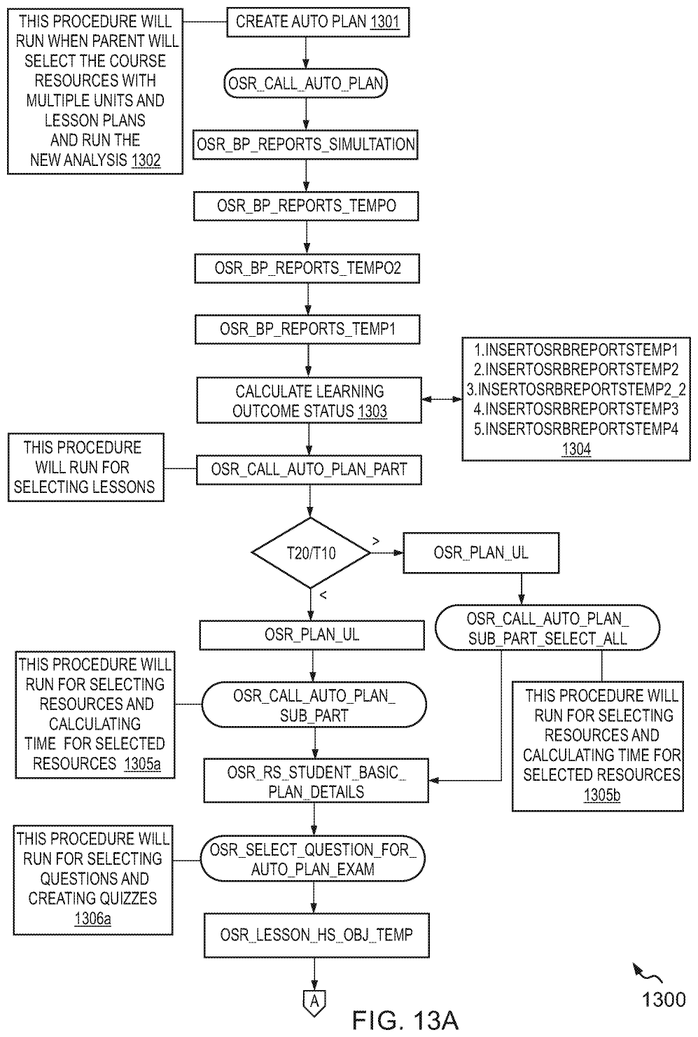

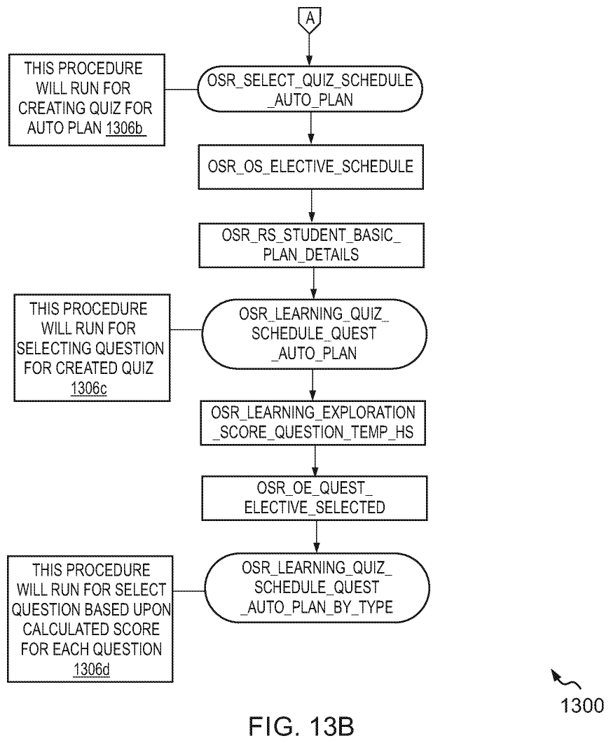

FIGS. 13A and 13B collectively show a flow diagram 1300 depicting a machine learning generated auto plan 1301 using curriculum map, in accordance with an example embodiment.

Smart algorithms based on mastery and reinforcement learning govern the personalized learning plans that generate auto plan 1301 for users. The auto plan 1301 provides the personalized learning plans with the support of intelligent agent, such as system-tutors, teachers and facilitators. For example, when a parent selects learning course resources, procedure OSR_CALL_AUTO_PLAN is executed. The learning course resources are selected with multiple units and lesson plans and run the new analysis.

The steps of generating the auto-plan 1301 are described below:

Step 1302: Check type of run
i. Firstly, check count of rows of Timing for that student from table for content for that course
ii. After that check count of rows of Timing for that student from table for content for that course type from past courses also
iii. Now system will run procedure based on student timing rows

Step 1303: Calculate learning outcome status and lesson competency score. Using insertion statements 1304, the following insertions are performed.
i. Insert all the content, task and quiz columns in temp tables for reports calculation.
ii. It will save all the objectives for which unit and lesson are selected
iii. It will store objective status for every worksheet
iv. It will store objective status for every objective for every question
v. It will calculate quiz average of every question for a particular objective
vi. Calculate overall status of Objective using following formula: (Sum (Status/5)*Wt.)/Total Wt.
vii. Check the Competency Level of Lesson using following formula: Sum of all objectives status for that lesson/Total number of objectives
viii. Now while creating plan there are two options to select. On is detailed and other is summary.
ix. If detailed is selected, then it will consider all the lessons whose competency score is from 1 to 5.
x. If summary is selected, then it will consider lessons whose competency score is from 1 to 4.

Steps 1305a and 1305b: Select content and assign content timing
i. Calculate Time for lessons (T20) 11. If it is Less than 2.5 then it will set lesson Total time by making it double of Default Time of lesson.
ii. Calculate Time for lessons 12. If it is Less than 2.5 to 4 then it will set lesson Total time equals to Default Time of lesson.
iii. Calculate Time for lessons 13. If it is greater than 4 then it will set lesson Total time by making it half of Default Time of lesson.
iv. Calculate Time of Content (T10) 14. Store time of content for that lesson content from student content time table.
v. Compare lesson time and Content time (T20 & T10)
vi. Now if T10>T20, then it will select content on the base of Ranks if T10<T20, then it will select all content for that lessons
vii. Firstly, it will rank the content on the basis of Time different using following calculation.
   Average (Time taken by student for every content for that course and content type)—Average (Time taken by student for that content type and course type)
viii. It is going to calculate time to allocate for every resource that is selected based on rank
ix. If T1>T2>T3=T2
   T1<T3<T2=(T3+T2)/2
   T2>T1>T3=T1
   T3>T1>T2=(T1+T2)/2
   T3<T2<T1=T1
   T2<T3<T1=T3+T1

Here T1 is time from config table

T2 is Average time taken by Student for that content

T3 Average time taken for that content type and course type

After that it will select content based on rank till total time is completed

Steps 1306a, 1306b, 1306c and 1306d: Create quiz and select questions
i. First it will count the total no. of objectives selected for that Lesson
ii. After that it will calculate the no. of question to select for that quiz by multiplying no. of objectives to increase factor, currently increase factor is set as 2
iii. After this it will insert all the objective in temp tables In this firstly it will calculate the time for that quiz using following formula:
iv. Firstly it will calculate the time for a question for every question using following formula:
   Quiz time allotted/Total no. of questions
v. After this it will calculate the average time for one question by taking average of time that we had calculated in last step
vi. After this it will compare it will the configure minimum time required for every question which is set as 2
   a. If it is more that minimum required, then it will pick average time came
   b. if it is less than minimum required then it will pick minimum required
vii. After this it will multiply it with No. of question and whatever value will come it will make it multiple of 5
viii. After this it will insert row in Plan basic details for that quiz
ix. Now firstly it will insert all the questions for that objective in score temp table
x. Now in this procedure firstly it will separate the count of question based on objective status and not used. It will calculate count for Not used objective, Question count with objective status 1, Question count with objective status 2, Question count with objective status 3, Question count with objective status 4, Question count with objective status 5
xi. After this it will calculate count required for every objective status type with following formulas:
   Not used=(10*Total Question Required Count)/100
   Objective Status 1=(40*Total Question Required Count)/100
   Objective Status 2=(20*Total Question Required Count)/100
   Objective Status 3=(15*Total Question Required Count)/100
   Objective Status 4=(10*Total Question Required Count)/100
   Objective Status 5=(5*Total Question Required Count)/100
xii. At 1307, question from top from every category mentioned in last step are selected. It will shift count in next category if question count is still pending
xiii. After calculating the required count for every objective status, system will check the total required count objective status wise with total question count objective wise that we had calculated in step 4.

QCA+QCB+QCC+QCD>Q

If it is greater than Q, it will reduce the required count for QCD by 1. After that it will again compare the total required count objective status wise with total question count objective wise and again if sum is greater than Q than it will reduce the required count for QCC by 1 and so on.
xiv. After calculating the count separately for every Objective status, system will start to compare the count with question available for every particular question. System will start a loop for every type of objective status.
   Now if the available count is less than the required count then, It will shift the particular remaining count for the next type of objective status.
   For e.g. value of QCA is 7, and available question for not met objective is 4 then it will shift remaining 3 question count for the next objective status type (Partially met) and so on.
xv. Once the count is calculated system will start to select the questions for exam on the basis of objective status. It will pick the question in the form of Zig-Zag. For e.g. value of QCA is 7 and there are total 2 Not met Objectives, so system firstly will pick one question from first objective and then after that system will pick next question from second objective and then again next question from first objective and so on.
xvi. Similarly, system will pick questions for every type of objective status, same as that only.
xvii. After selecting the question system will schedule the lesson exam with selected question.

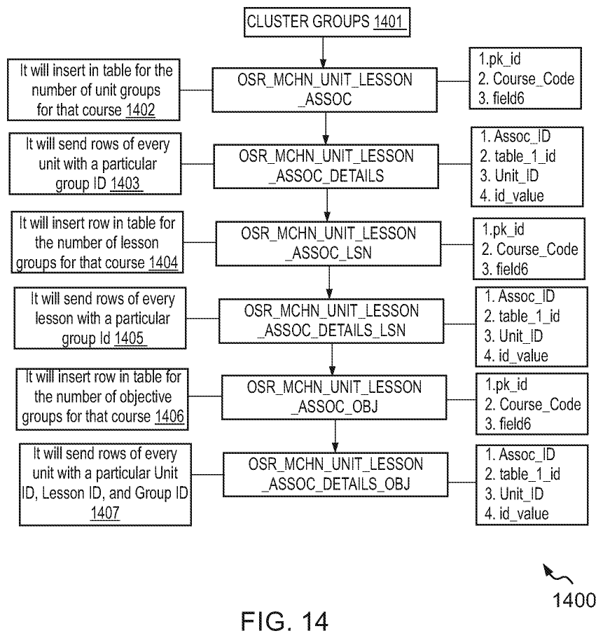

FIG. 14 shows flow diagram 1400 depicting procedure for cluster groups 1401, in accordance with an example embodiment.

At 1402, row is inserted in table for the number of unit groups for that course. At 1403, rows of every unit are sent with a particular group ID. At 1404, insert row table for the number of lesson groups for that course. At 1405, rows of every lesson with a particular group ID for that course are sent. At 1406, it will insert row in table for the number of objective groups for that course. At 1407, it will send rows of every unit with a particular unit ID, lesson ID and group ID.

Once the content is approved by the administrator for machine learning first step is to create groups of all units, lessons and learning outcomes from different approved clusters. Now, the admin 302c will create groups of all the matching units, lessons and learning outcomes from the approved clusters. Here groups denote to attach similar kind of unit lesson and outcomes under one tree. Every course has multiple unique groups of Units, Lessons, and learning outcomes. In a particular group admin can assign multiple units, lessons and learning outcomes from different clusters respectively. Here units, lessons and learning outcomes are separate entities. Admin will also assign the details level and initial or not for all the course resources mapped with the selected unit and lesson. Also, will assign the difficulty level for the questions mapped with the units and lesson of approved clusters.

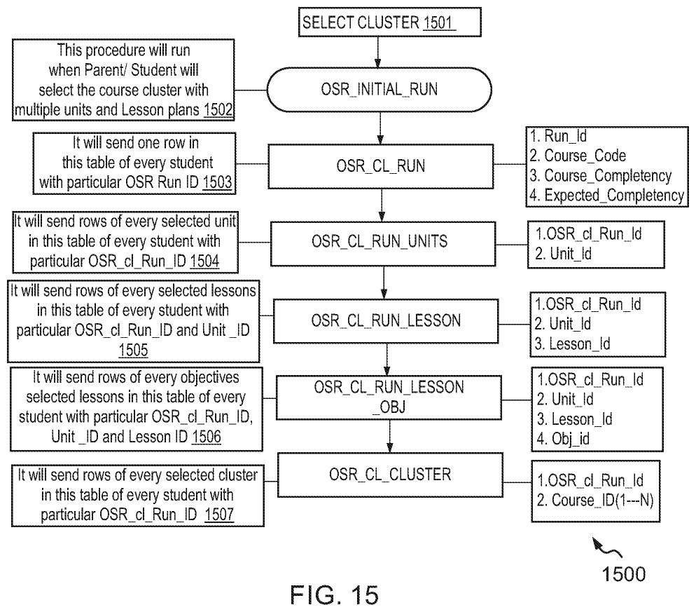

FIG. 15 shows flow diagram 1500 depicting procedures for cluster selection 1501, in accordance with an example embodiment. Once user has subscribed to the course with advance packages, he/she will select the multiple course clusters from the approved ones. After that user will select the particular units and lessons from the selected clusters and will also select the expected competency score for the course.

At 1502, this procedure will run when a parent/student will select the course cluster with multiple units and lessons plans. At 1503, it will send one row in table of every student with particular OSR RUN ID, as shown in FIG. 15. At 1504, it will send rows of every selected unit in this table of every student with particular OSR_CL_RUN_ID. At 1505, it will send rows of every selected lessons in this table of every student with particular OSR_CL_RUN_ID and UNIT_ID.

At 1506, it will send rows of every objectives of selected lessons in this table of every student with particular OSR_CL_RUN_ID, UNIT_ID and LESSON_ID. At 1507, it will send rows of every selected cluster in this table of every student with particular OSR_CL_RUN_ID.

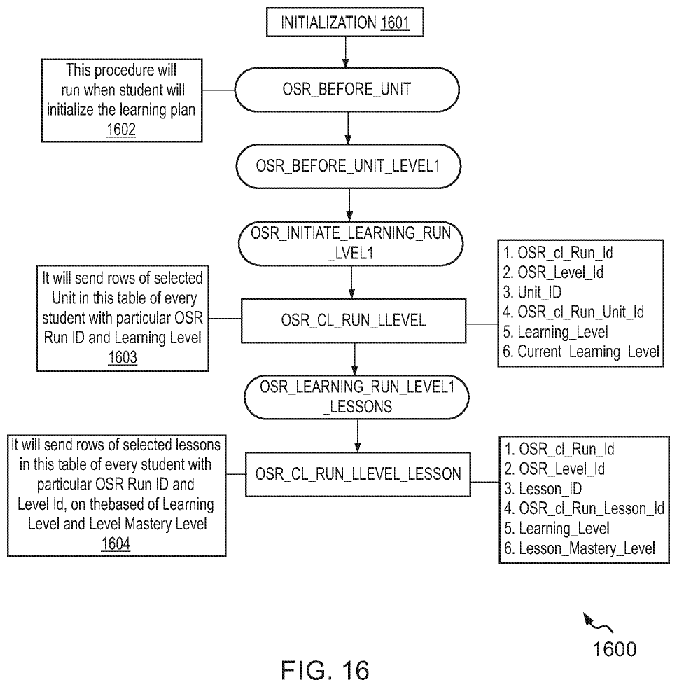

FIG. 16 shows flow diagram 1600 depicting procedures for initialization 1601, in accordance with an example embodiment. At 1602, the procedure will run when student will initialize the learning plan. For example, the student initializes first unit (unit learning level 1). The student will select all the lessons which parents have selected while selecting clusters (e.g., cluster selection 1501). The student then initializes first lesson (lesson learning level 1). In this procedure, check runs of lesson. Now, the IEMS 116 will check that enough learning data for the selected lesson is available or not. If enough data is available, then it will run section 2 and 3 algorithms else it will run section 1 algorithms. Now suppose enough learning data is not available, then insert rows in learning tables.

Here, rows in learning tables are inserted. Now, rows of all outcomes, contents and questions of selected lessons are inserted in the learning tables. Firstly, it will insert rows of all the outcomes in counter table of learning outcomes. Further, rows of all the objective and content combination in counter and q-values are inserted in table of content. After that it will insert rows of all the objective and questions combination in counter table of question.

After initializing the unit, learner is going to initialize first lesson. After initializing the lesson first, it will create a unique lesson learning ID of the learner. At 1603, it will send rows of selected unit in this table of every student with particular OSR_RUN_ID and learning level.

At 1604, it will send rows of selected lessons in this table of every student with particular OSR_RUN_ID and LEVEL_ID, on the basis of learning level and mastery level.

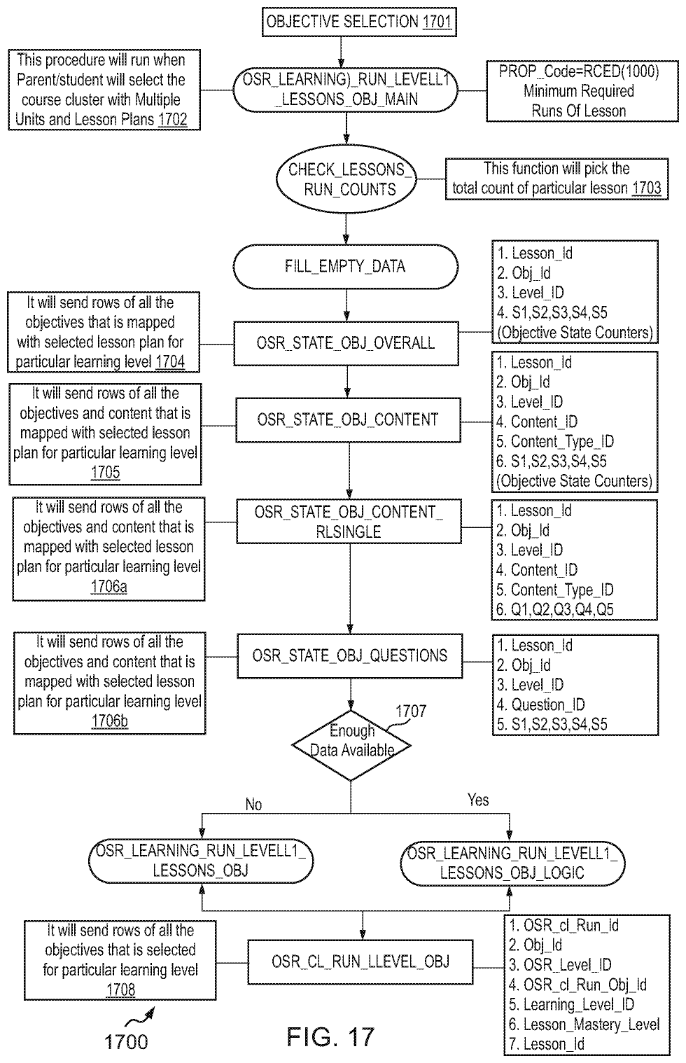

FIG. 17 shows a flow diagram 1700 depicting procedures for objective selection 1701, in accordance with an example embodiment. The objective selection 1701 includes selecting learning outcomes.

At 1702, the procedure starts when a parent/student will select the course cluster with multiple units and lesson plans. Firstly, calculate total count of objectives. Now if course competency is equal to expected competency then it will select all the objectives. If course competency is greater than expected competency, firstly it will check number of objectives if less than or equal to 3 then select all objectives otherwise it will pick objectives using random formula.

At 1703, the function for checking of number of objectives will pick total count of particular lesson. At 1704, it will send rows of all the objectives that is mapped with selected lesson plan for particular learning level. At 1705, it will send rows of all the objectives that is mapped with selected lesson plan for particular learning level. At 1706a and 1706b, it will send rows of all the objectives and content that is mapped with selected lesson plan for particular learning level. At 1707, check if enough data is available or not. At 1708, it will send rows of all the objectives that is selected for particular learning level.

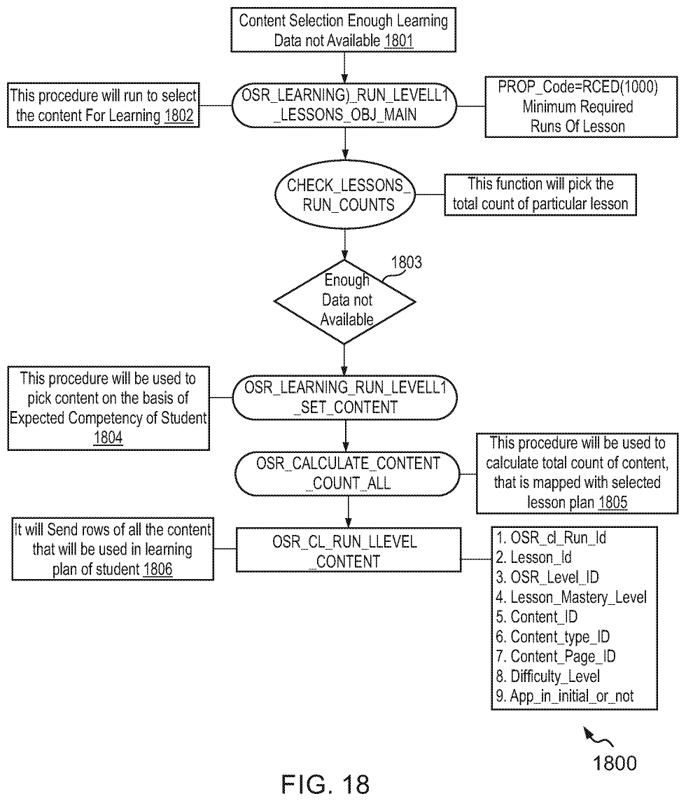

FIG. 18 shows flow diagram 1800 depicting procedures for content selection when enough learning data not available 1801, in accordance with an example embodiment. Here, a learning content is selected. Selecting the learning content includes the following steps:
i. Firstly, fetch all the Learning content that is mapped with selected learning outcome
ii. Fetch Total Number of content of Notes and Content Tool
iii. Calculate total Count of Objectives that is selected in first step
iv. Calculate content count that system is going to choose for selection using following formula:

C=CEIL(Objective Selected Count+(20*(Objective Selected Count/100)))
v. It will divide calculated count in notes and content as 4/7 of total count as notes and 3/7 of total count as content sets
vi. Now it will check if selected count is greater than total count then it will select all the content otherwise it will pick content whatever the count is calculated
vii. After that it will select the notes and content tool whose initial or not is selected as yes and if initial or not content is not available that much then it will pick other content whose detail level is more.

At 1802, this procedure will run to select the content for learning. At 1803, it is detected that enough data is not available. At 1804, this procedure will be used to pick content on the basis of expected competency of student. At 1805, this procedure will be used to calculate total count or content, that is mapped with selected lesson plan. At 1806, this procedure will send rows of all the content that will be used in learning plan of student.

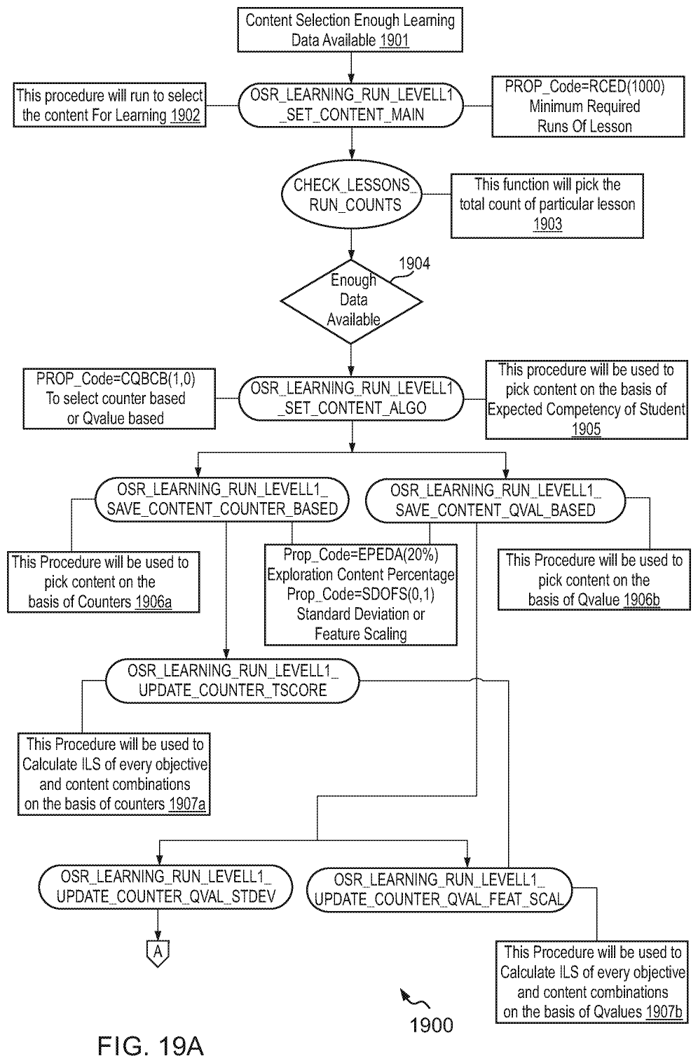

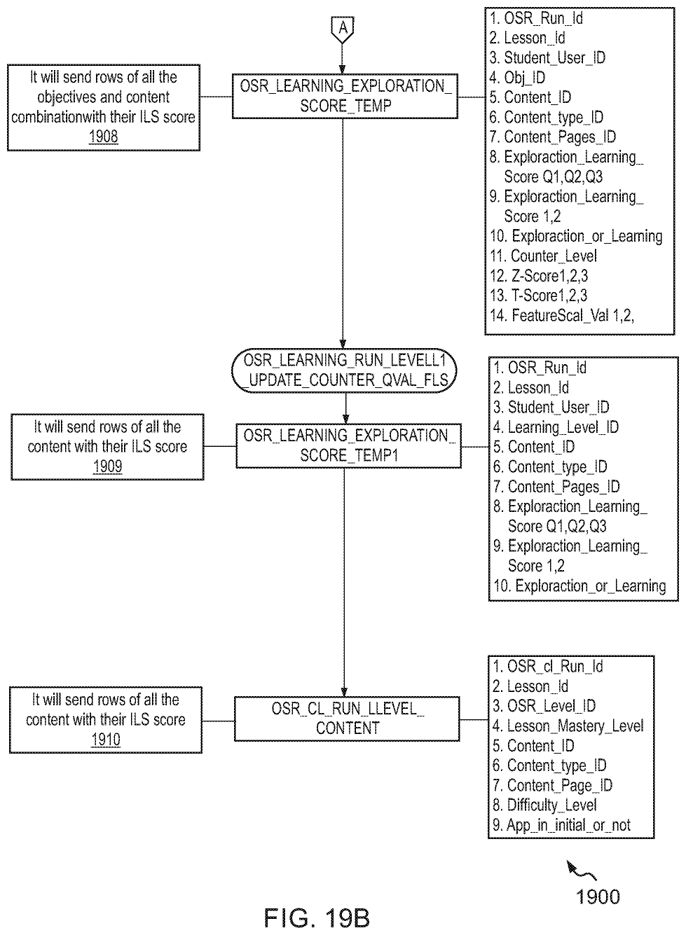

In an example embodiment a content selected may have enough data available, which is explained next with reference to FIGS. 19A and 19B.

FIGS. 19A and 19B collectively show a flow diagram 1900 depicting procedures for content selection with enough data available 1901, in accordance with an example embodiment. At 1902, this procedure will run to select the content for learning. At 1903, function of checking lesson count will pick for the total count of particular lesson.

At 1904, enough data availability is detected. At 1905, this procedure will be used to pick content on the basis of different algorithm of counters and Qvalues. At 1906a, this procedure will be used to pick content on the basis of counters. At 1906b, this procedure will be used to pick content on the basis of Qvalues.

At 1907a, this procedure will be used to calculate ILS of every objective and content combinations on the basis of counters. At 1907b, this procedure will be used to calculate ILS of every objective and content combinations on the basis of Qvalues.

At 1908, it will send rows of all the objectives and content combination with their ILS score. At 1909, it will send rows of all the content with their FLS score. At 1910, it will send rows of all the content that is selected for particular learning level.

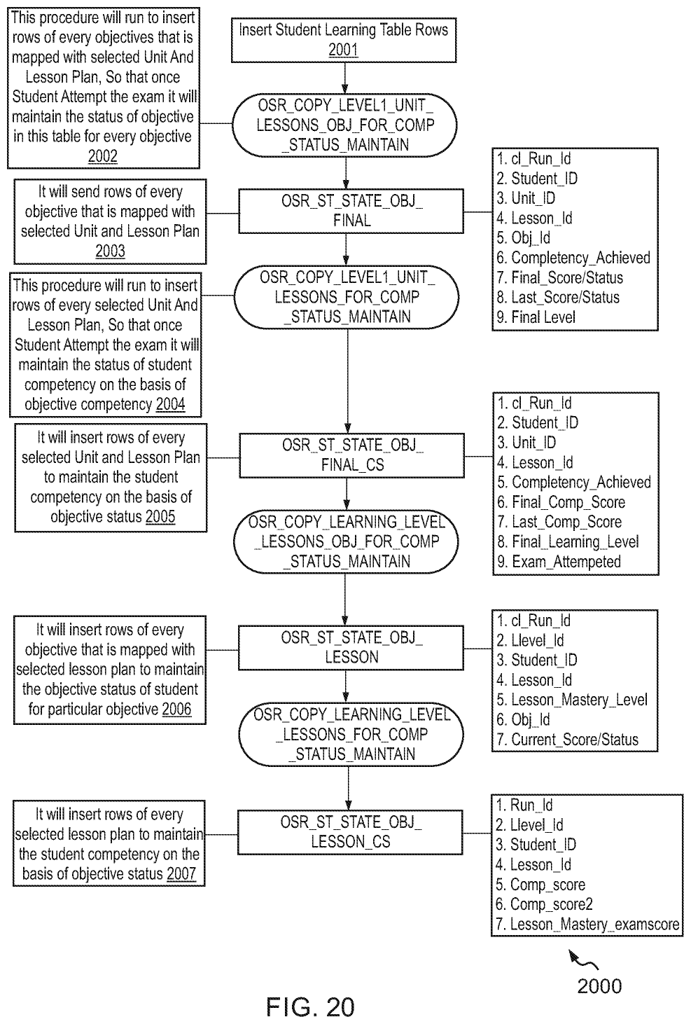

Now, the IEMS 116 will insert rows in all the tables in which it is going to maintain status of outcomes for each lesson and unit. The procedures for insertion of student learning table rows is explained next with reference to FIG. 20.

FIG. 20 shows flow diagram 2000 depicting procedures for insertion of student learning table rows 2001, in accordance with an example embodiment. At 2002, this procedure will run to insert rows of every objectives that is mapped with selected unit and lesson plan, so that once student attempts the exam it will maintain the status of objective in this table for every objective. At 2003, it will send rows of every objective that is mapped with selected unit and lesson plan.

At 2004, this procedure will run to insert rows of every selected unit and lesson plan, so that once student attempts the exam it will maintain the status of student competency on the basis of objective competency. At 2005, it will insert rows of every selected unit and lesson plan to maintain the student competency on the basis of objective status. At 2006, it will send rows of every objective that is mapped with selected lesson plan to maintain the objective status of student for particular objective. At 2007, it will insert rows of every selected lesson plan to maintain the student competency on the basis of objective status.

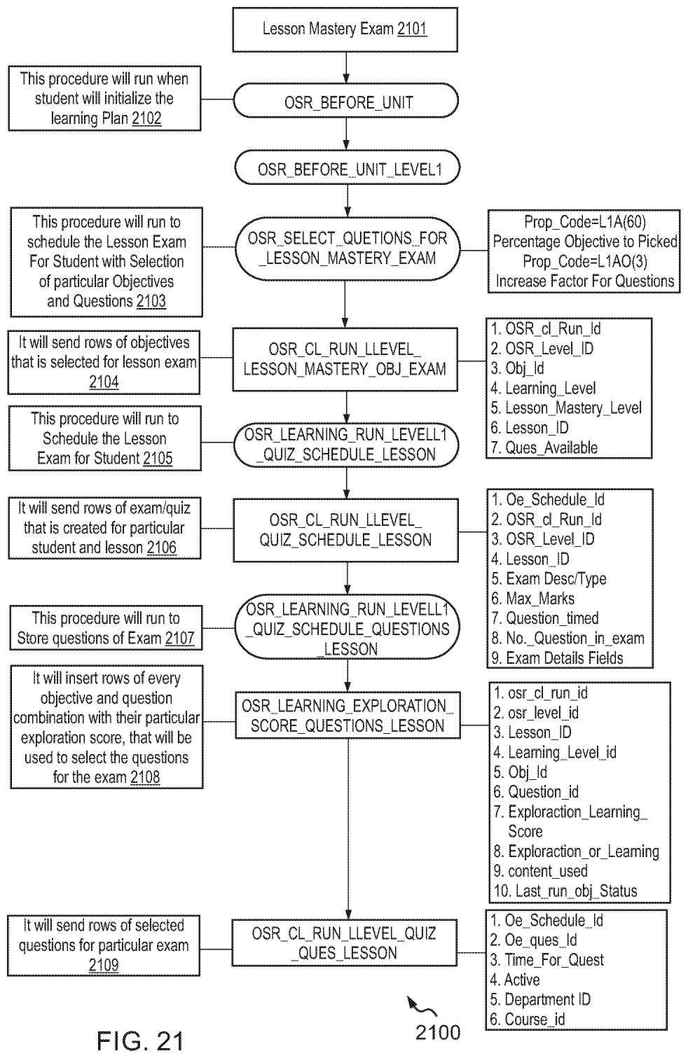

FIG. 21 shows a flow diagram 2100 depicting procedures for lesson mastery exam 2101, in accordance with an example embodiment. In an example embodiment, the lesson mastery 2101 is performed by scheduling quiz for a lesson. Now firstly system will schedule a quiz for the selected lesson. After scheduling the quiz, the IEMS 116 will fetch objectives count that is selected (please refer FIG. 18). After fetching the objectives, the IEMS 116 calculates the total count of questions using following formula:

Question Count To picked=CEIL(objectives Count*Increase Factor)

Here Increase Factor is variable, and for now it is configured as 2. It is noted that all the configured values come from pre-defined configurations tables. After calculating the count, it will schedule an exam for student with 2 minutes for every question and at last it will round off the time with 5 factors. Now it will select question from each outcome equally and will give priority to those questions whose difficulty level is lower. Now if enough question count is not available for a particular question then it will shift the count to next outcome.

At 2102, this procedure will run when student will initialize the learning plan. At 2103, this procedure will run to schedule the lesson exam for student with selection of particular objectives and questions. At 2104, it will send rows of objectives that is selected for lesson exam. At 2105, this procedure will run to schedule the lesson exam for student.

At 2106, it will send rows of exam/quiz that is created for particular student and lesson. At 2107, this procedure will run to store questions of exam. At 2108, it will insert rows of every objective and question combination with their particular exploration score, that will be used to select the questions for exam. At 2019, it will send rows of selected questions for particular exam.

In an example scenario, a learner learns a learning content and attempt a quiz. Further, a learning outcome status and competency score for the learner are calculated. At this point, the IEMS 116 calculates the learning outcome status of objective using following formula and conditions:

For single response, if answer right then correct weightage is given and if wrong then incorrect weightage is given.

For multiple responses, firstly it will equally divide weightage in all correct and incorrect option. For example, question 4 with 2 options are correct and 2 are incorrect then it will assign 2-2 weightage to correct options and 2-2 weightage to incorrect options.
Case1: If select all then it will correct weightage as 4 and incorrect weightage as 4.
Case 2: If No correct selected then correct weightage as 0 and incorrect weightage as 4 either one incorrect is selected or both incorrect are selected.
Case 3:
   a. If no incorrect is selected, then
   b. If both Correct selected, then return correct weightage 4 and incorrect weightage 0
   c. If only one correct selected, then return correct weightage 2 and incorrect weightage 2
Case 4 If correct and incorrect both selected
   d. If Correct 1 and Incorrect 1 selected then C. W=2 I.W=2
   e. If Correct 2 and Incorrect 1 selected then C. W=4 I.W=2
   f. If Correct 1 and Incorrect 2 selected then C. W=2 I.W=4

Calculate objective Score=round((((Correct Weightage*Lesson Learning Level)/(Correct Weightage*Lesson Learning Level+In-Correct Weightage*Lesson Learning Level)*100
g. Here correct weightage is sum of difficulty level of those question which are mapped to particular objectives and which are answered correctly by students.
h. Here In-Correct weightage is sum of difficulty level of those question which are mapped to particular objectives and which are answered Incorrectly by students.

It will update status of those objective only which are selected in that particular lesson exam.

After calculating the score system will update the objective status on the basis of objective score. These values will be configured from backend. Following are the values configured for Objective Status:
i. Objective status 1=0-24.99%
j. Objective status 2=25-39.99%
k. Objective status 3=40-59.99%
l. Objective status 4=60-79.99%
m. Objective status 5=80-100%

After updating the objective status of student system will update the competency of student on the basis of following formula:

Competency Score=Sum of Objectives status/Total No. of Objectives

Here basically average of objectives status those are mapped for that lesson learning run are calculated. The table with value of competency score is updated.

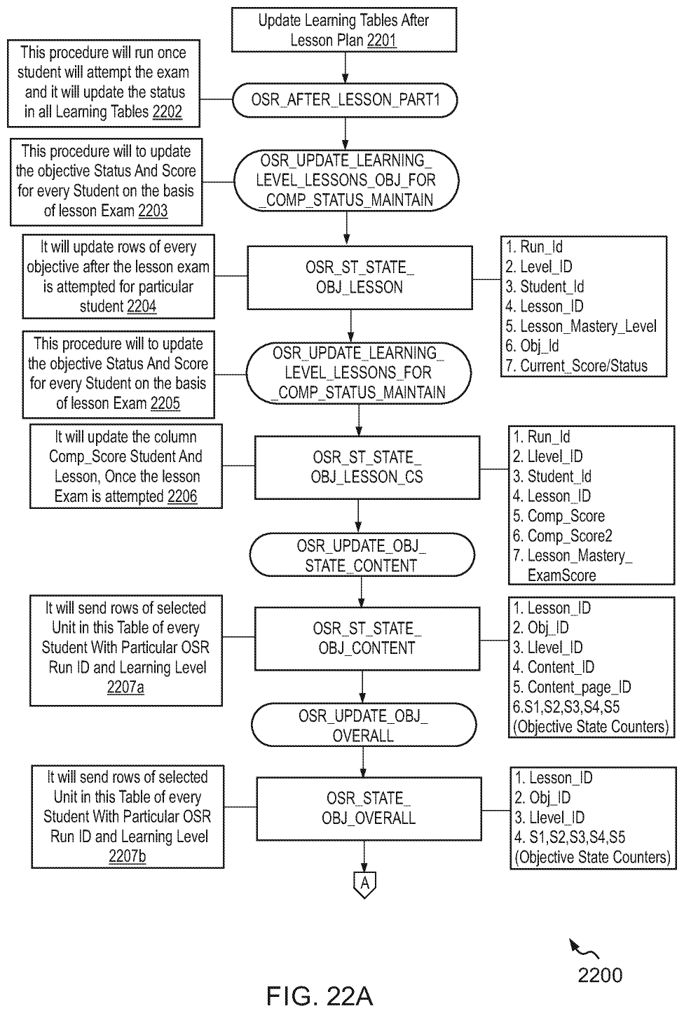

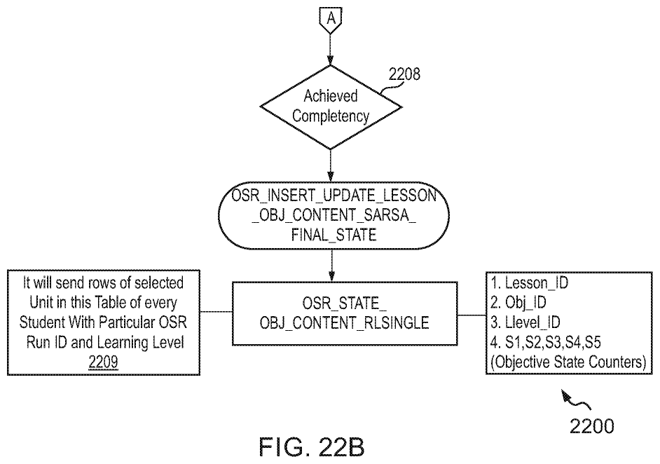

Now after updating the objective status system will update all the learning tables. Firstly, the IEMS 116 updates the objective counters table. The counters of the outcomes as per outcome status are updated. After that it will update the content counter table. It will update counter for each content and outcome combination based on outcome status. After that it will update the question counter table. It will update counter for each content and outcome combination based on question correct and incorrect. If a student achieves the competency then it will update Q-values tables, else it will not update the table. For now, suppose lesson competency is not achieved. The updating of learning tables after lesson plan is explained next with reference to FIGS. 22A and 22B.

FIGS. 22A and 22B collectively show a flow diagram 2200 depicting procedures for updating learning tables after lesson plan 2201, in accordance with an example embodiment. At 2202, this procedure will run once student will attempt the exam and it will update the status in all learning tables. At 2203, this procedure will run to update the objective status and score for every student on the basis of lesson exam.

At 2204, this procedure will update rows of every objective after the lesson exam is attempted for particular student. At 2205, this procedure will run to update the competency score for every student on the basis of lesson exam.

At 2206, this procedure will update the column COMP_SCORE for particular student and lesson, once the lesson exam is attempted. At 2207a and 2207b, these procedures will send rows of selected unit in this table of every student with particular OSR_RUN_ID and learning level.

At 2208, it is checked if the student has achieved competency. At 2209, this procedure will send rows of selected unit in this table of every student with particular OSR_RUN_ID and learning level.

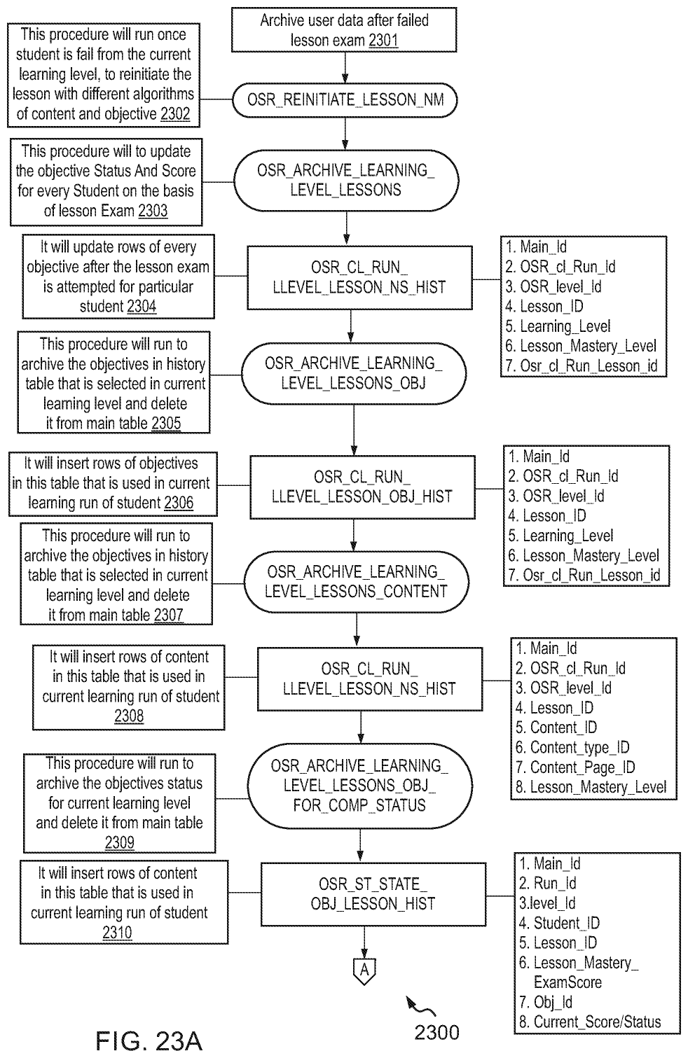

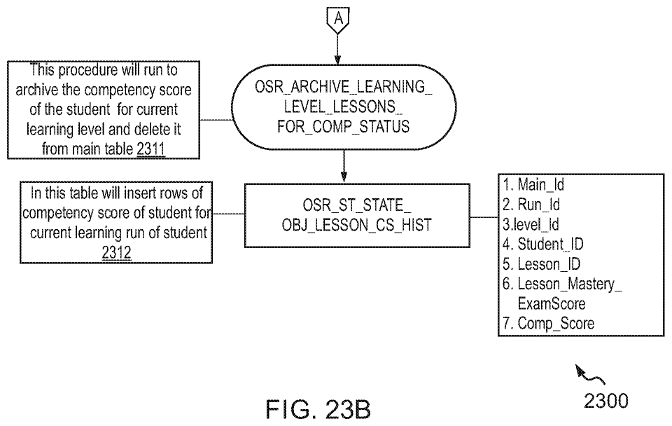

In an example scenario, if a student does not achieve the desired competency, lesson plans are modified. In an example embodiment, previous lessons are archived and a new a modified lesson based on a learning level is created. For example, a lesson of learning level 1 is updated to lesson learning level 2. The data of lesson first learning level are archived. The student has to reinitiate the lesson exam. In such scenario, before the lesson exam is reinitiated, the IEMS 116 archives the learner data for current lesson mastery level. The IEMS 116 will archive the lesson of student in history table with current lesson mastery level. Once the lesson of student is archived, objectives selected in last lesson run archived in history table with current lesson mastery level. Then the content selected in last lesson run are archived in history table with current lesson mastery level. The IEMS 116 also archives the objective status and competency score of students for current lesson mastery level. It will archive objective status and competency score tables data. The procedures for archiving the user data after failed lesson exam is explained next with reference to FIGS. 23A and 23B.

FIGS. 23A and 23B collectively show a flow diagram 2300 depicting procedures for archiving user data after failed lesson exam 2301, in accordance with an example embodiment. At 2302, this procedure will run once the student has failed from the current learning level, to reinitiate the lesson with different algorithms of content and objective.

At 2303, this procedure will run to archive the lesson in history table that is selected in current learning level and delete it from main table. At 2304, this procedure will insert rows of lesson plans in this table that is used in current learning run of student.

At 2305, this procedure will run to archive the objectives in history table that is selected in current learning level and delete it from main table. At 2306, this procedure will insert rows of objectives in this table that is used in current learning run of the student.

At 2307, this procedure runs to archive the content in history table that is selected in current learning level and delete it from man table. At 2308, this procedure will insert rows of content in this table that is used in current learning run of student. At 2309, this procedure will run to archive the objective status of student for current learning level and delete it from main table.

At 2310, this procedure will insert rows of objective status of student in this table for current learning run of student. At 2311, this procedure will run to archive the competency score of students for current learning level and delete it from main table. At 2312, this procedure will insert row of competency score of students for current learning run of student.

Further, a new run of the lesson is created. The new run of the lesson is created by inserting new row with next level of lesson mastery. For this, learning outcomes are selected. The IEMS 116 fetches all the learning outcomes of that lesson plan. The objectives are selected on the basis of their status in last lesson learning run. It will use follow algorithm to select objective on the basis of objective status. Firstly, the IEMS 116 calculates count of objectives to pick using following formula:

Objective count to Pick=FLOOR ((Objective Picked in Last Run of lesson)*0.80)

Now system will use following criteria to select objectives:

If N.M Obj>0, P.M Obj>0, M Obj>0, then pick all ‘NOT MET’ objectives then 70% of P.M objectives and 30% of ‘MET’ objectives.

If N.M Obj=0, P.M Obj>0, M Obj>0, then pick all P.M Objectives then if required objective are still pending then will pick Met Objectives.

If N.M Obj>0, P.M Obj=0, M Obj>0, then pick all N.M Objectives then if required objective are still pending then will pick Met Objectives

If N.M Obj>0, P.M Obj>0, M Obj=0, then pick all N.M Objectives then if required objective are still pending then will pick P.M Objectives

If N.M Obj=0, P.M Obj>0, M Obj=0, then pick all P.M Objectives

If N.M Obj>0, P.M Obj=0, M Obj=0, then pick all N.M Objectives

In case of Partially and Met Objectives, system will order those objectives using following formula:

Score of objectives=((S1+S2)/(S1+S2+S3+S4+S5))

Here S1, S2, S3, S4, S5 are different objective status counters from Objective learning Tables and then will pick objectives with top scores. After this, the IEMS 116 picks one objective that is not used in last lesson learning run. The IEMS 116 selects all the objectives those are not used in last lesson learning run then after that order the selected objectives using following formula:

Score of objectives=((S1+S2)/(S1+S2+S3+S4+S5))

Here S1, S2, S3, S4, S5 are different objective status counters from Objective learning Tables. And then pick top objective for lesson learning run.

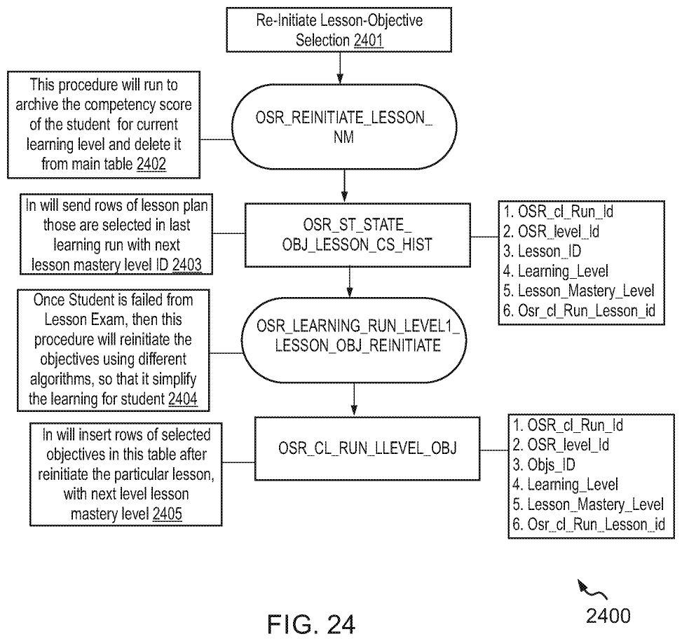

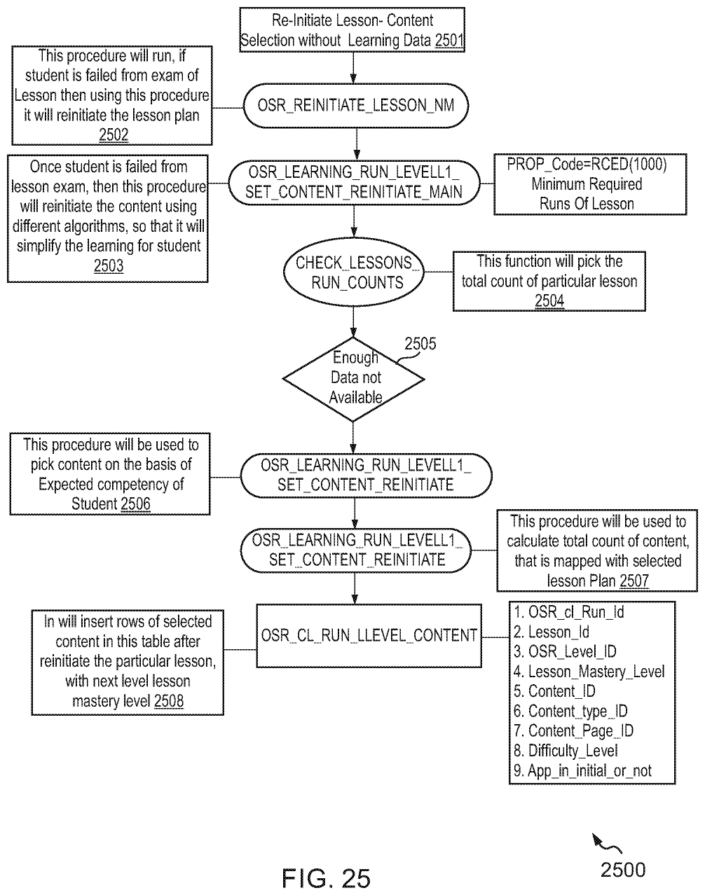

The procedures for reinitiating lesson based on objective selections and reinitiating lesson based on content selection without learning objective are explained with reference to FIGS. 24 and 25.

FIG. 24 shows a flow diagram 2400 depicting procedures for re-initiating lesson based on objective selections 2401, in accordance with an example embodiment. At 2402, this procedure runs if a student fails from exam of lesson. The procedure reinitiates the lesson plan.

At 2403, this procedure sends rows of lesson plan that are selected in last learning run with next lesson mastery level ID. At 2404, once the student has failed from lesson exam, then this procedure reinitiates the objectives using different algorithms, so that it will simplify the learning for students. At 2405, this procedure inserts rows of selected objectives in this table after reinitiating the particular lesson, with next level lesson mastery level.

In at least one example embodiment, learning content for the students are selected. For selecting the learning content, all the learning content that is mapped with selected learning outcome are selected. After selecting the learning content, total number of content of notes and content tool are fetched. The total count of objectives selected in first step are calculated. The content count for the selection is chosen using following formula:

C=CEIL (Obj selected count+(20*(Obj selected count/100)))

Based on the above formula, the notes and content set count ( 4/7 notes count & 3/7 content set count of total count) are divided. Now it will check if the selected count is greater than total count then it will select all the content otherwise it will pick content whatever the count is calculated. After that it will select the notes and content tool whose initial or not is selected as yes and if initial or not content is not available that much then it will pick other content based on detail level. And also, it will give priority to content which is not selected in last lesson learning run. The procedures for reinitiating lesson based on content selection without learning objective are explained next with reference to FIG. 25.

FIG. 25 shows a flow diagram 2500 depicting procedures for reinitiating lesson based on content selection without learning data 2501, in accordance with an example embodiment. At 2502, this procedure runs when a student has failed from exam of lesson and reinitiates the lesson plan.

At 2503, once the student has failed from lesson exam, then this procedure reinitiates the content using different algorithms, so that it will simplify the learning for the student.

At 2504, the total count of particular lesson is picked. At 2505, it is detected that enough data is not available. At 2506, this procedure picks content on the basis of expected competency of student. At 2507, this procedure will be used to calculate total count of content that is mapped with selected lesson plan. At 2508, this procedure inserts rows of selected content in the table after reinitiating the particular lesson with next level lesson mastery level.

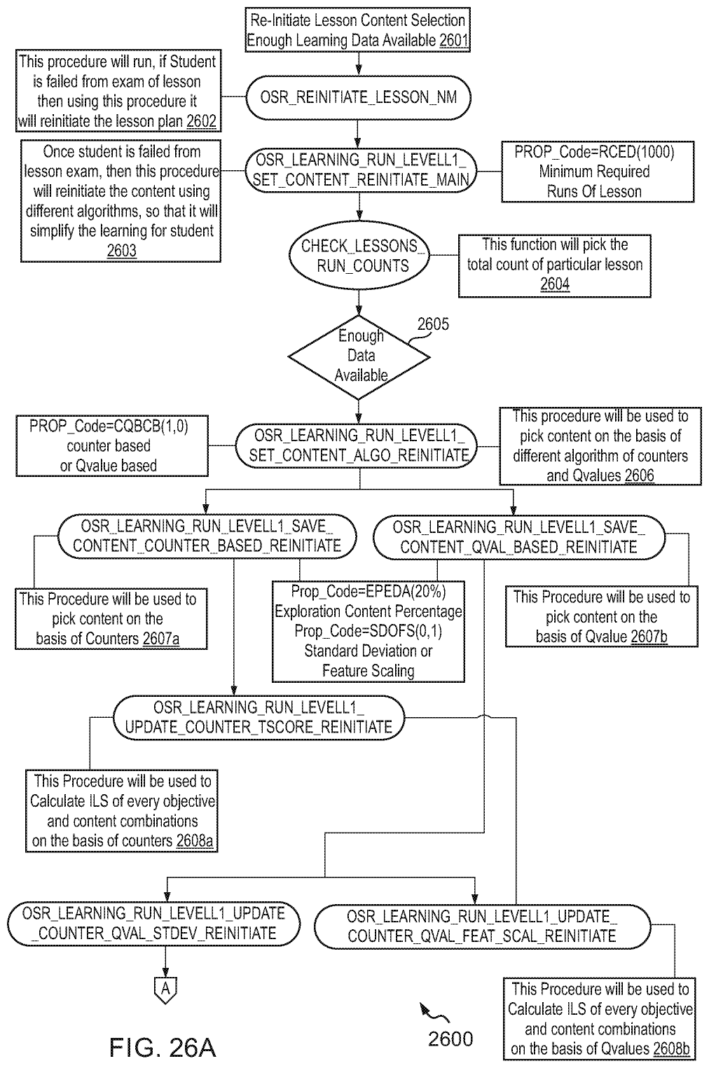

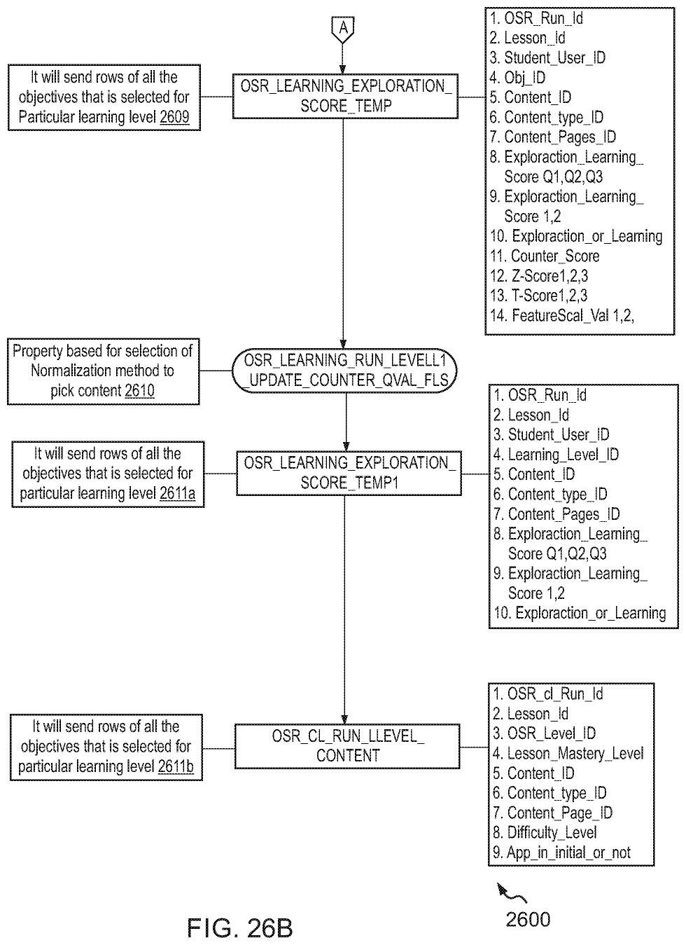

In a scenario, there may be enough learning data available for reinitiating the lesson. The procedures for reinitiating lesson based on content selection with enough learning data available is explained next with reference to FIGS. 26A and 26B.

FIGS. 26A and 26B collectively show a flow diagram 2600 depicting procedure for reinitiating lesson based on content selection with enough learning data available 2601, in accordance with an example embodiment. At 2602, this procedure will run, if a student fails in a lesson exam. Using this procedure, the lesson plan is reinitiated.

At 2603, once the student fails from the lesson exam, then this procedure will reinitiate the content using different algorithms, so that the learning for student is simplified.

At 2604, the total count for particular lesson is picked. At 2605, availability of enough data is determined.

At 2606, the procedure will be used to pick content on the basis of different algorithm of counters and Qvalues. At 2607a, this procedure will be used to pick content on the basis of counters. At 2607b, this procedure will be used to pick content on the basis of Qvalues.

At 2608a, this procedure will be used to calculate ILS of every objective and content combinations on the basis of counters. At 2608b, this procedure will be used to calculate ILS of every objective and content combinations on the basis of Qvalues.

At 2609, this procedure will send rows of all the objectives that is selected for particular learning level. The rows of the objectives are inserted at table 2610 that includes property based for selection of normalization method to pick content. At 2611a and 2611b, the procedure will send rows of all the objectives that is selected for particular learning level.

After reinitiating the lesson, a lesson exam for the reinitiated lesson is reinitiated. In at least one example embodiment, a quiz for the lesson is scheduled. Firstly, objectives count with old and new counts are fetched. The objectives which are old those are selected in last lesson learning RUN_ID and new one which are not used in last lesson learning Run are fetched.

After fetching the objectives, the total count of questions is calculated using following formula:

Question Count To picked=CEIL (objectives Count (New+Old)*increase Factor)

Here Increase Factor is variable, and for now it is configured as 2. After this IEMS 116 saves the objectives in a temp table that is selected for current lesson mastery exam. After calculating the count, an exam for the student is scheduled. In the exam, 2 minutes for every question is provided and at last it will round off the time with 5 factors. An average of difficulty level of questions that are used in last lesson learning run is calculated. After this the IEMS 116 calculates learning score for every question and objective combination using following formula:

Learning Score=0.25*((S1+S2)/(S1+S2+S3+S4+S5))+(0.25 or 0.125 or 0)*(last attempted status)+0.25*(Used/Not Used)+(0.25 or 0.20 or 0.15 or 0.10 or 0.5) (Based on difficulty level)

Here S1, S2, S3, S4, S5 are the Objective status counters for every question and objective combination. It will give 0.25 if question is correct in last run, 0.125 if question is incorrect in last run, 0 if question is correct in last run. Here it will give 0.25 if questions are not used in last run and 0 if question is used. It will give 0.25 if question difficulty level is 1, 0.20 if question difficulty level is 2, 0.15 if question difficulty level is 3, 0.10 if question difficulty level is 4, 5 if question difficulty level is 5.

After calculating the order system will run an algorithm to pick/select the question on the basis of Objective Status. Firstly, system will calculate counts of question for every objective status.
a. 50% of Total Questions for Not Met Objective
   QCA=Q*(50/100)
   Here QCA is question count for Not met Objectives
b. 25% of Total questions for partially Met Objectives
   QCB=Q*(25/100)
   Here QCB is question count for Partially met Objectives
c. 15% of Total Question for Not Used Objectives (In last learning Run)
   QCC=Q*(15/100)
   Here QCC is question count for Not Used Objectives
d. 10% of Total Question for Met Objectives
   QCD=Q*( 10/100)
      Here QCD is question count for Met Objectives

After calculating the required count for every objective status, system will check the total required count objective status wise with total question count objective wise that we had calculated in step 2.

QCA+QCB+QCC+QCD>Q

If it is greater than Q, it will reduce the required count for QCD by 1. After that it will again compare the total required count objective status wise with total question count objective wise and again if sum is greater than Q than it will reduce the required count for QCC by 1 and so on.

After calculating the count separately for every Objective status, system will start to compare the count with question available for every particular question. System will start a loop for every type of objective status. Now if the available count is less than the required count then, it will shift the particular remaining count for the next type of objective status. For e.g. value of QCA is 7, and available question for not met objective is 4 then it will shift remaining 3 question count for the next objective status type (Partially met) and so on.

Once the count is calculated system will start to select the questions for exam on the basis of objective status. It will pick the question in the form of Zig-Zag. For e.g. value of QCA is 7 and there are total 2 Not met Objectives, so system firstly will pick one question from first objective and then after that system will pick next question from second objective and then again next question from first objective and so on. Similarly, system will pick questions for every type of objective status, same as that only. After selecting the question system will schedule the lesson exam with selected question.

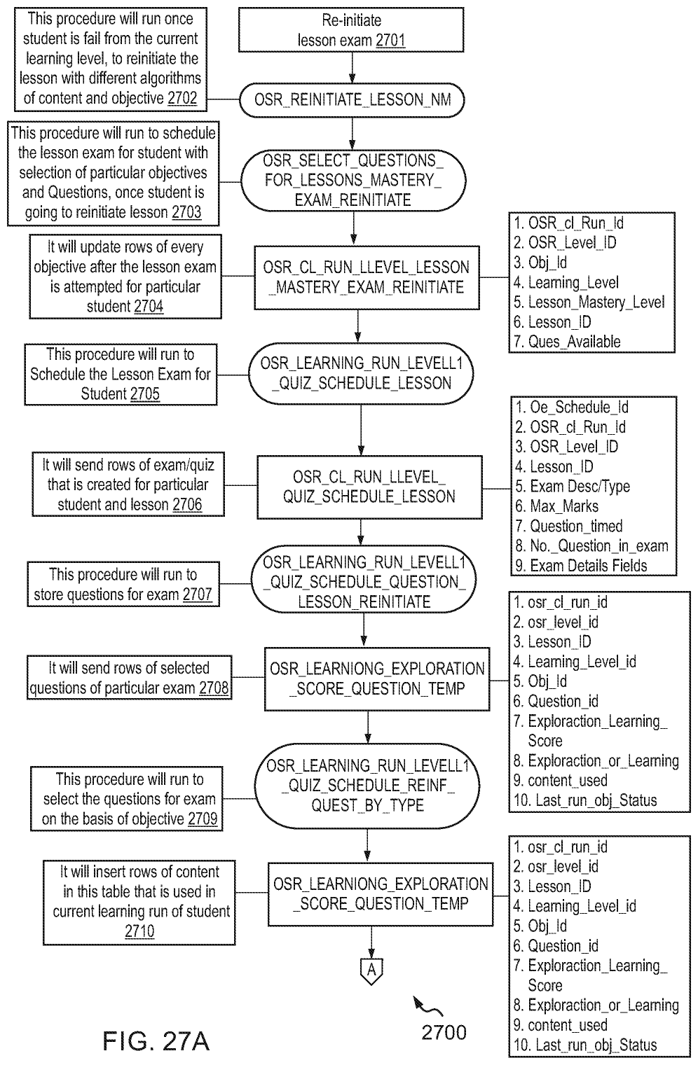

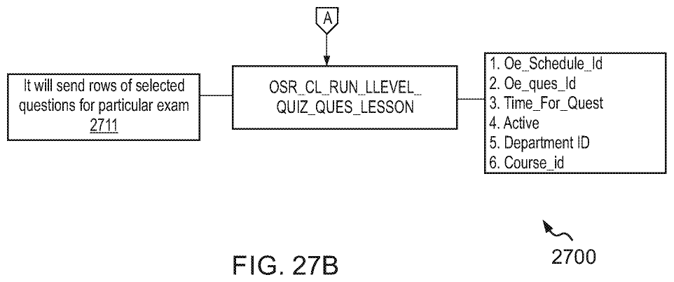

The procedures for reinitiating lesson exam 2701 are explained next with reference to FIGS. 27A and 27B.

FIGS. 27A and 27B collectively show a flow diagram 2700 depicting procedures for reinitiating lesson exam 2701, in accordance with an example embodiment. At 2702, this procedure will run if a student fails a lesson exam. Using this procedure, the lesson plan is reinitiated.

At 2703, this procedure runs to schedule the lesson exam for student with selection of particular objectives and questions, once student fails from exam and when the student is going to reinitiate the lesson.

At 2704, this procedure sends rows of selected unit in a table of every student with particular OSR_RUN_ID and learning level. At 2705, this procedure runs to schedule the lesson exam for the student. At 2706, this procedure sends rows of exam/quiz that is created for particular student and lesson.

At 2707, this procedure runs to store questions of exam. At 2708, this procedure sends rows of selected questions for particular exam. At 2709, this procedure runs to select questions for exam on the basis of objective status. At 2710, this procedure updates values of content used for every question and objective combination row (i.e., which question is going to be selected for exam by the IEMS 116). At 2711, this procedure sends rows of selected questions for particular exam.

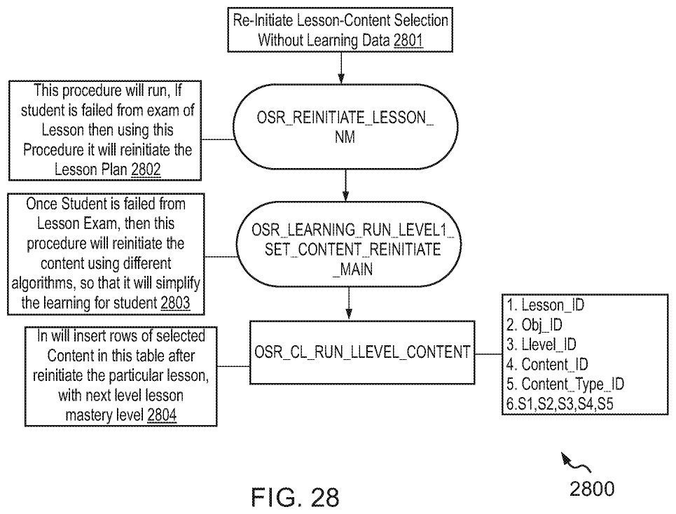

FIG. 28 shows a flow diagram 2800 depicting procedure for reinitiating lesson based on content selection without learning data 2801, in accordance with an example embodiment. At 2802, this procedure runs when a student fails a lesson exam. When the procedure is executed, a lesson plan is reinitiated.

At 2803, once the student fails from the lesson exam, then this procedure reinitiates the content using different algorithms, so that the learning for the student is simplified. At 2804, the procedure will insert rows of selected content in a table after reinitiating the particular lesson, with next level lesson mastery level.

In an example scenario, student may complete all lessons of selected unit. After the student completes learning of the lessons of the selected unit, a unit exam is scheduled. The IEMS 116 schedules a unit exam by inserting rows in a table. This procedure runs when the IEMS 116 runs the procedure of Initialization 1601. Once the student attempts the lesson exam or clears the lesson exam, the procedures to select question for unit exam is started. At this point, total count of objectives that are mapped with selected unit are fetched. The IEMS 116 lowers down the count of objectives. In at least one example embodiment, the IEAMS 116 picks 80% of total objectives, such as

C=Total Objective*( 80/100)

The objectives are inserted in a temp table. After storing the objectives, score for each objective and question combination is calculated using following formula:

Learning Score=0.25*((S1+S2)/(S1+S2+S3+S4+S5))+(0.25 or 0.125 or 0)*(last attempted status)+0.25*(Used/Not Used)+(0.25 or 0.20 or 0.15 or 0.10 or 0.5) (Based on difficulty level)

Here S1, S2, S3, S4, S5 are the Objective status counters for every question and objective combination. It will give 0.25 if question is correct in last run, 0.125 if question is incorrect in last run, 0 if question is correct in last run. Here it will give 0.25 if questions are not used in last run and 0 if question is used. It will give 0.25 if question difficulty level is 1, 0.20 if question difficulty level is 2, 0.15 if question difficulty level is 3, 0.10 if question difficulty level is 4, 5 if question difficulty level is 5.

Further, the status of objectives is calculated. The IEMS 116 may use different ways to calculate objective final status on the basis of objective status in different lesson runs:
a. If it is moving from higher to lower, then it will take lower status as objective status
b. If it is moving from lower to higher then it will take average of all status as final objective status
c. If it is moving from lower to higher then higher to lower, then it will take average of all status as final objective status

After calculating the status, the IEMS 116 fetches all the objectives on the basis of their status. The question count for particular type of objective status is calculated using following formulas:
a. Not Used Objective Question Count=Total Question*( 10/100)
b. Not Met Objective Question Count=Total Question*( 50/100)
c. Partially Met Objective Question Count=Total Question*(25100)
d. Met Objective Question Count=Total Question*( 10/100)

After calculating the required count for every objective status, the total required count objective is checked in status-wise manner with total question count objective wise that we had calculated in the initialization 1601.

QCA+QCB+QCC+QCD>Q

If it is greater than Q, it will reduce the required count for QCD by 1. After that it will again compare the total required count objective status wise with total question count objective wise and again if sum is greater than Q than it will reduce the required count for QCC by 1 and so on.

After calculating the count separately for every objective status, system will start to compare the count with question available for every particular question. System will start a loop for every type of objective status.

Now if the available count is less than the required count then, it will shift the particular remaining count for the next type of objective status. For example, value of QCA is 7, and available question for not met objective is 4 then it will shift remaining 3 question count for the next objective status type (Partially met) and so on.

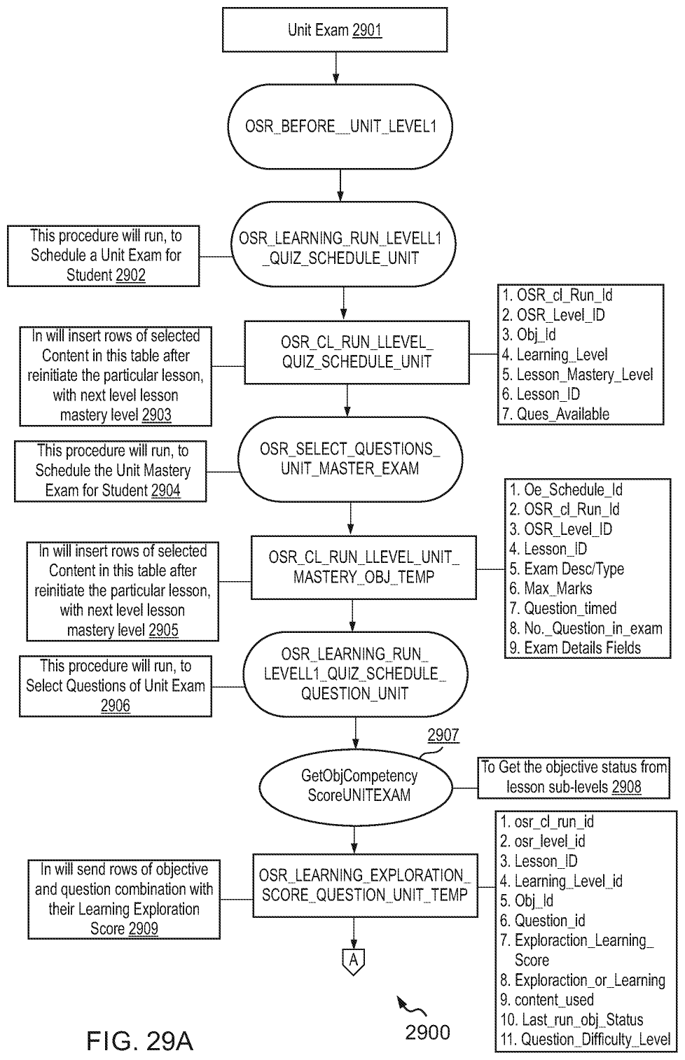

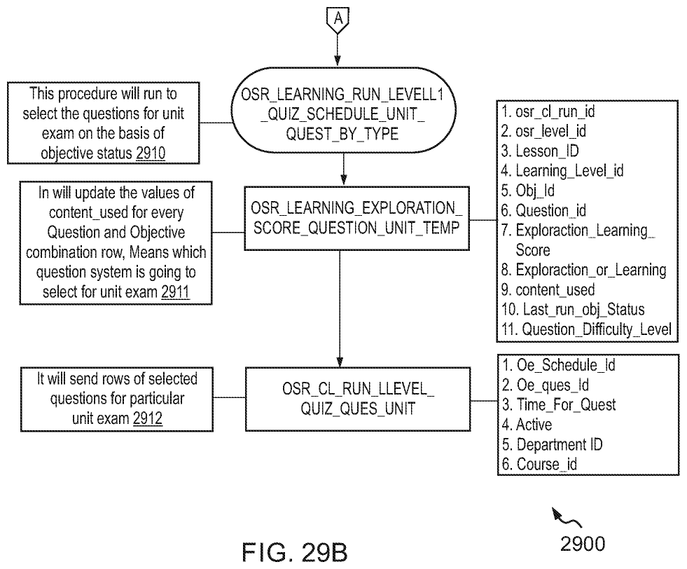

Once the count is calculated system will start to select the questions for exam on the basis of objective status. It will pick the question in the form of Zig-Zag. For example, value of QCA is 7 and there are total 2 Not met Objectives, so system firstly will pick one question from first objective and then after that system will pick next question from second objective and then again next question from first objective and so on. Similarly, the IEMS 116 picks questions for every type of objective status, same as that only. After selecting the question, the unit exam is scheduled with selected question and assign 2 minutes for every question and at last it will round off the total time with 5 factor. The procedure for creating unit exam is explained with reference to FIGS. 29A and 29B.

FIGS. 29A and 29B collectively show a flow diagram 2900 depicting procedure for unit exam 2901, in accordance with an example embodiment. At 2902, this procedure runs to schedule a unit exam for a student. At 2903, this procedure inserts rows of selected unit in a table of every student with particular OSR_RUN_ID and EXAM SCHEDULE ID. At 2904, this procedure runs to schedule the unit mastery exam for student.

At 2905, this procedure sends rows of objectives in the table that is selected for the unit mastery exam. At 2906, this procedure runs to select questions of unit exam. At 2907, competency score of unit exam of the student is accessed. At 2908, objective status from lesson sub-levels is obtained.

At 2909, this procedure sends rows of objective and question combination with their learning exploration score. At 2910, this procedure runs to select the questions for unit exam on the basis of objective status. At 2911, this procedure updates the values of content used for every question and objection combination row, means which question system is going to select for the unit exam. At 2912, the procedure sends rows of selected questions for particular unit exam.

The student attempts the unit exam, such as the unit exam 2901. Once the student attempts the unit mastery exam, the objective status and competency score of students is updated on the basis of the unit exam 2901. Firstly, the objective score is calculated on the basis of unit exam attempts. The score of the objective is calculated using following formula:

Objective Score=round ((((correct Weightage*Lesson Learning Level)/(correct Weightage*lesson Learning Level+in-Correct Weightage*lesson Learning Level)*100

Here correct weightage is sum of difficulty level of those question that are mapped to particular objectives and which are answered correctly by students. In-Correct weightage is sum of difficulty level of those question which are mapped to particular objectives and which are answered incorrectly by students. The status of those objective only that are selected in that particular lesson exam is updated. After calculating the score, the objective status on the basis of objective score is calculated. These values will be configured from backend. Following are the values configured for objective status:
Objective status 1=0-24.99%
Objective status 2=25-39.99%
Objective status 3=40-59.99%
Objective status 4=60-79.99%
Objective status 5=80-100%

An average of objective score is calculated for every runs of lesson. The average of objective score of that particular objective is calculated for every runs of lessons using following formula:

Average Objective Score=Sum of Objective score from every run of Lesson/Total no. of Runs of Lesson

After calculating objective score on basis of lesson exam and unit exam, the final objective score is calculated using following formula:

Final Objective Score=0.60*(Lesson Average Objective Score)+0.40*(Objective score on basis of Unit Exam)

Moreover, after updating the objective status of student after unit exam, the competency of student is updated on the basis of following formula:

Competency Score=Sum of Objectives status/Total No. of Objectives

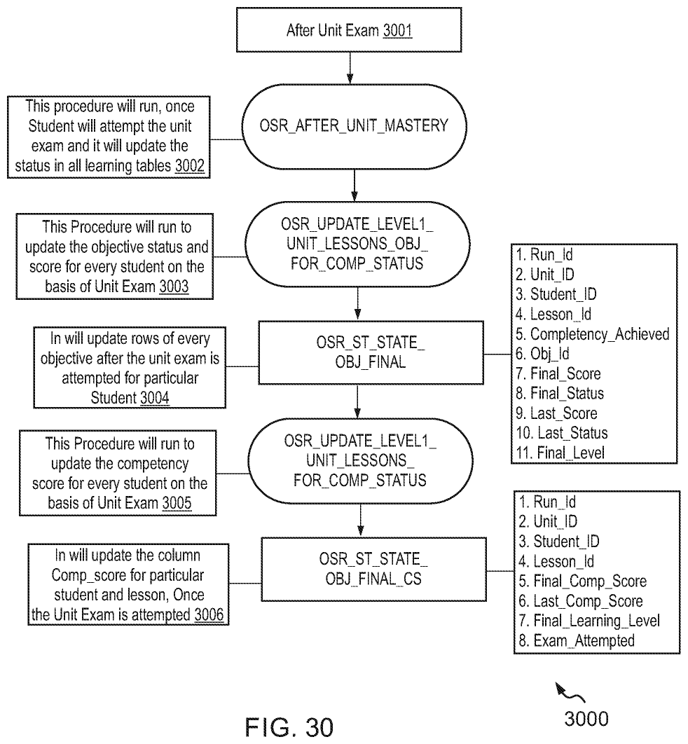

Here basically we are calculating the average of objectives status those are mapped for that Unit learning run. Once competency score for every lesson is calculated, the competency for unit is calculated by taking average of competency score for every lesson. The procedure for after unit exam is explained next with reference to FIG. 30.

FIG. 30 shows a flow diagram 3000 depicting procedure for after unit exam 3001, in accordance with an example embodiment of the present invention. At 3002, this procedure runs once a student attempts the unit exam and updates the status in all learning tables.

At 3003, this procedure runs to update the objective status and score for every student on the basis of unit exam. At 3004, this procedure updates row of every objective after the unit exam is attempted for particular student.

At 3005, this procedure runs to update the competency score for every student on the basis of unit exam. At 3006, this procedure updates the column COMP_SCORE for particular student and lesson, once the unit exam is attempted.

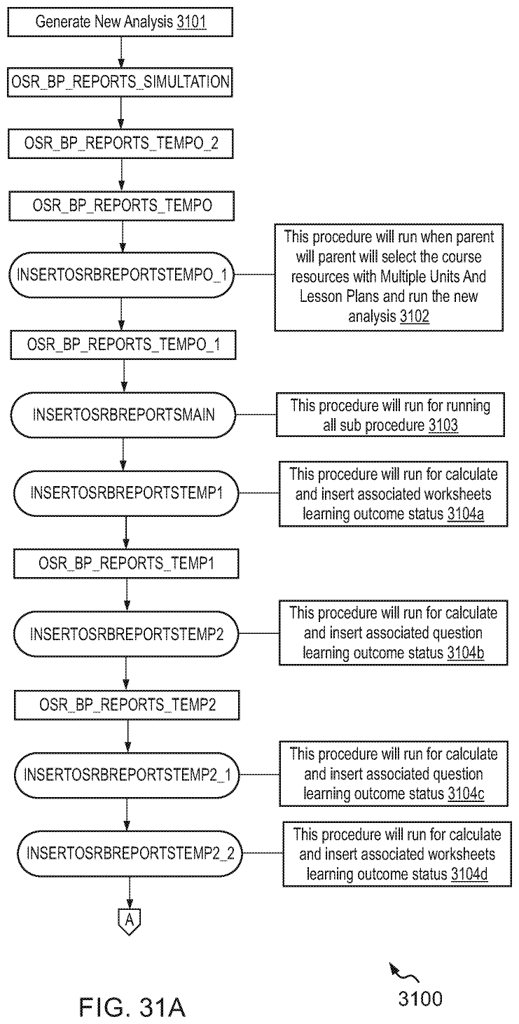

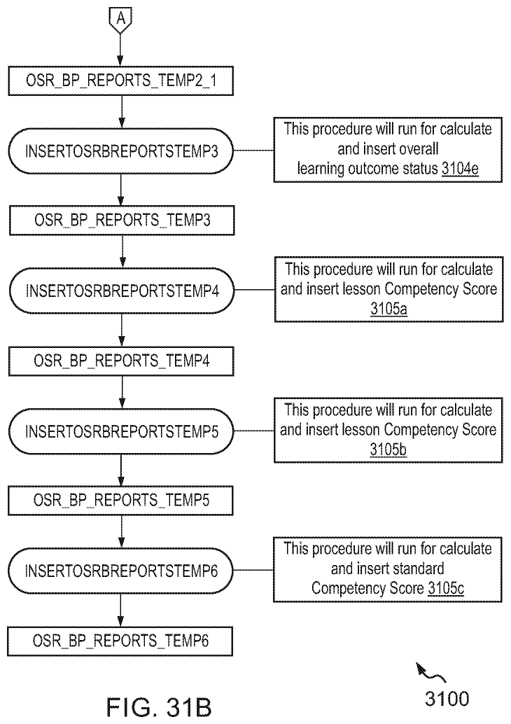

FIGS. 31A and 31B collectively show a flow diagram 3100 depicting procedure for generating new analysis 3101, in accordance with an example embodiment of the present invention. At 3102, this procedure runs when a parent selects learning course resources with multiple units and lesson plans and runs the new analysis. At 3103, this procedure runs for running all sub-procedures.

At 3104a, 3104b, 3104c, 3104d and 3104e, this procedure runs for calculating and inserting associated worksheets learning outcome status. At 3105a, 3105b and 3105c, this procedure runs for calculating and inserting lesson competency score.

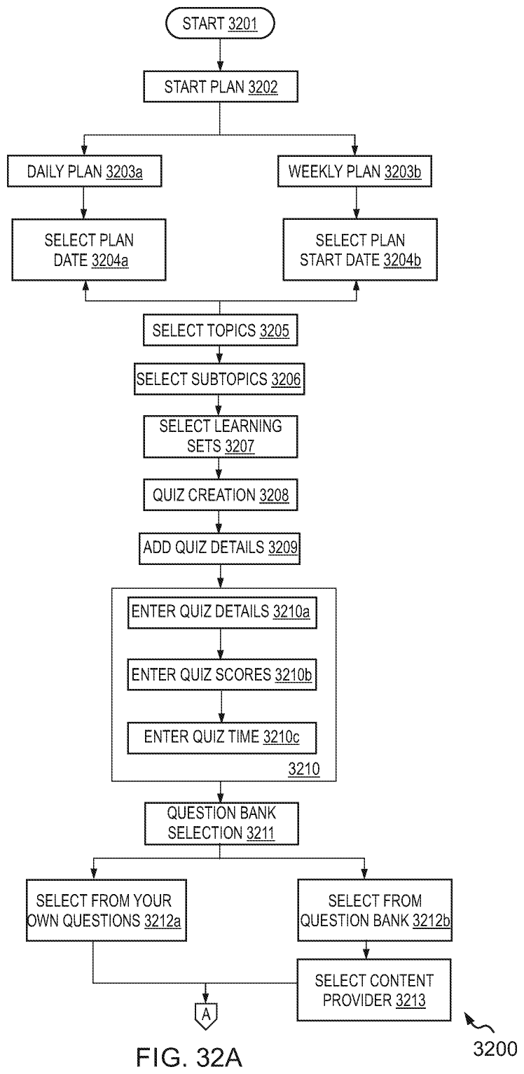

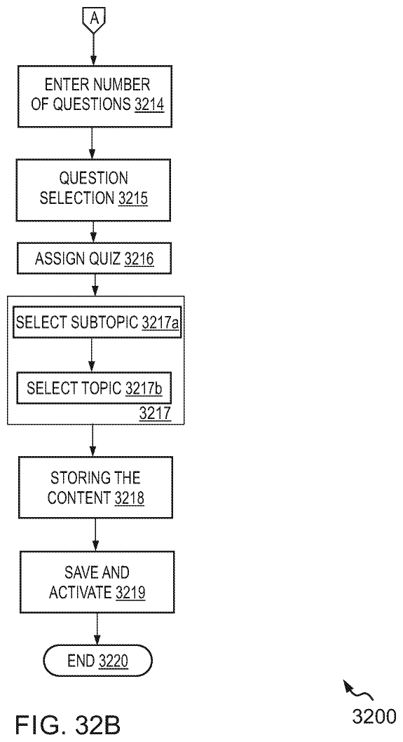

FIGS. 32A and 32B collectively show a flow diagram 3200 depicting flow of information for selecting plan for a student, in accordance with an example embodiment of the present invention. At 3201, a selection of a plan for learning by a student starts. At 3202, a plan is selected.

The selected plan can be categorized into a daily plan 3203a and a weekly plan 3203b. At 3204a, a plan date is selected and at 3204b, a plan start date is selected.

At 3205, topics for plan are selected. At 3206, sub-topics are selected. At 3207, learning sets are selected.

At 3208, a quiz is created. The quiz is created to evaluate performance and learning of the student. At 3209, quiz details are added. At 3210, quiz details 3210a, quiz scores 3210b and quiz time 3210c are entered.

At 3211, a question bank selection is performed. At 3212a, questions prepared by a tutor/parent/teacher are selected. At 3212b, questions from a question bank are selected. At 3213, a content provider is selected.

At 3214, number of questions to be included in a quiz are entered. At 3215, a selection of questions is performed. After the question selection, the selected questions are included in the quiz created. At 3216, the quiz is assigned to the tutor/parent/teacher.

At 3217a, a topic is selected. At 3217b, sub-topic is selected. At 3218, quiz content is sorted. At 3219, the quiz content is saved and activated. At 3220, the selection of plan ends.

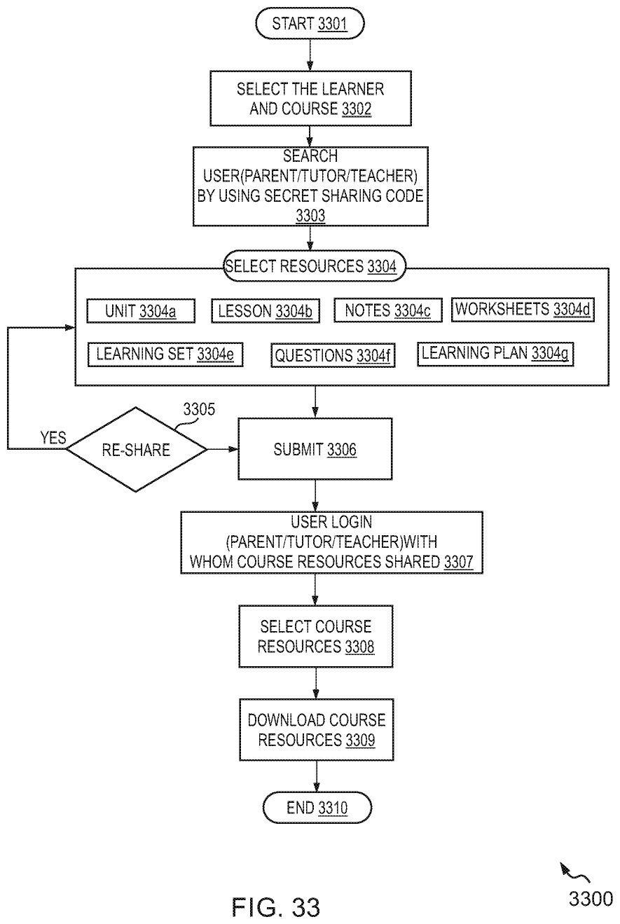

FIG. 33 shows a flow diagram 3300 depicting flow of information for selecting learner and course, in accordance with an example embodiment of the present invention. At 3301, the registration of the user as a marketplace author starts. At 3302, learner and courses for the learner are selected. At 3303, a user (parent/tutor/teacher) is searched by using a secret sharing code. At 3306, select learning resources. The learning resources include unit 3306a, lesson 3304b, notes 3304c, worksheets 3304d, learning set 3304e, questions 3304f and learning plan 3304g.

At 3305, the learning resources selected at 3304 are submitted. At 3306, the learning resources is re-shareable. The re-shared learning resources are added in the learning resources selected at 3304.

At 3306, the user (parent/tutor/teacher) logins with whom course resources are shared. At 3307, learning course resources are selected. At 3308, the learning course resources are downloaded. At 3308, the registration of the user as the marketplace author ends.

In at least one example embodiment, the IEMS 116 also provides a homeschooling platform to users. The user includes a homeschooling parent, an author, a tutor or a classroom teacher. The homeschooling parent takes a role to teach learner(s) individually at home using personalized and customized learning. The author takes a role to share learning resources in a marketplace, such as VedaJunction marketplace. Further, the author earns royalties and embraces market growth for learning course resources within a subscriber community. The tutor takes a role to teach students individually using personalized and customized learning. The classroom teacher takes a role to teach students individually using personalized and customized learning using a classroom.

The marketplace allows the user to buy/sell or share curriculum maps of the user, learning resources and individual learning plans. The user can also upload content on the VedaJunction marketplace and can sell it to VedaJunction homeschooling subscribers. Further, the user can also subscribe to learning course resources from vendors and content publishing companies tested and approved by VedaJunction. Mentor support resources on how to design curriculum and personalize individual tutorial instruction are also available in the marketplace.

Some of the features supported by the VedaJunction marketplace include course set/unit set options, upload course content with multiple versions, delete course content resources from the marketplace, easily setup a bank account for payment, sales tax setup and marketplace reports. The course set option allows the user to upload a complete set of user's learning course resources with all units, lessons, and resources. This option also allows the user to provide updated versions of the course set. For example, a new course set can be created with the updated version of the learning course resources. Also, a course set with multiple versions of same course content or with new content can be created. The unit set option allows the user to upload a set with one or more units. Each unit is associated with lessons and learning resources of the user's learning course resources. In the unit set option, the user cannot upload units that are already uploaded under a different unit set. This prevents repetition of units.

The user enters the following details of learning course resources:
i. Course Set/Unit Set name: Enter the name which you want to display when users are going to subscribe it from the marketplace.
ii. Enter tags for your course resources, so that users can search it using tags while they are going to subscribe it from the marketplace.
iii. Enter details of your course resources.
iv. Amount: Enter the price for your created resources.

The user can select the amount, only if a bank account for the user is setup. Otherwise, the user can upload it for free/zero amount. To upload the user's learning course resources with a fee, bank account information is required for the setup. And also, if the user wants to collect tax for each transaction, the user must setup the sales tax.

Resource upload type: In the initial step of uploading the resources, type of the resources is provided using resource upload type option. For example, the type of resources is described as either a unit set or a course set using the resource type option.

View/Edit access: Here the user selects two options, one is ‘Read/Edit only’ that allows the user to update the content uploaded by the user. Another access type is of ‘Read-only’ that does not allow the user to update the content. The ‘Read-only’ option allows the user to read the content and use the content to teach their learners.

Content images: This allows the user to upload images for the user's learning content resources. The images are viewed by other users who are subscribes to the user's learning course resource in the marketplace.

Learning course resources: The user selects units, lessons, learning plans, and learning resources for uploading in the marketplace. There are three sections for uploading the learning course resources:
i. Units/Learning Plans: It shows the list of Units and learning plan added for the selected course.
ii. Lessons: It shows the list of lessons created under the selected unit.
iii. Resources: It shows the list of learning resources created under the selected unit and lesson.

By default, it is showing all the content as selected. Click on the unit name to view mapped lesson plan and click on the lesson plan to view mapped resources.

In a scenario, if the user is uploading a course set, then whichever units, lessons, and resources that are selected already are used as same unit, lessons, and resources again to create a new version or an updated version of course set. In another scenario, if the user is uploading a unit set, then whichever units, lessons, and resources the user is selecting here, cannot use the selected content in any other unit set. The user needs to create a new course set for that unit.

Upload again: Once course set/unit set is approved; the user can update the version of the user's uploaded content if the user had added some more content for unit and lesson. Also, if the user wants to upload an updated version for that course content resources, then this option is used.

If a particular content is already uploaded under different unit set or course set, then a badge icon is shown in front of content. It indicates that this content belongs to different unit set or course set. The user creates a new course set for the content or updates the earlier created unit set or course set. Likewise, if content is newly created but not uploaded in this unit set or course set, that user is uploading again, then the badge icon will be shown in front of the content. The badge icon indicates that this content is not part of the current course set or unit set.

Delete course content resources from the marketplace: The user can remove the course/unit sets uploaded to the marketplace anytime. When the user requests for delete, a popup appears showing Terms and Condition for deletion of the learning resources from the marketplace. The user enters a password and clicks on ‘I Agree’ button to send delete request to VedaJunction facilitator. Once the user sends the delete request to the facilitator, there are a time-period (e.g., 7 days of time) to activate the resources again is provided. The user clicks on ‘Activate’ button to reactivate the resources in the marketplace again. Once the user clicks on the ‘Activate’ button, the delete request is canceled and the resources are ready again to subscribe in the marketplace.

Sharing Course Resources with other Parent/Tutors: This functionality is used to share the units, lessons, notes, e-learning sets, evaluation resources, and learning plans with multiple users of VedaJunction by authorizing their individual sharing codes. This way parent can share their resources for free to relative and neighbours if required.

Share/Reshare full course resources or particular set to other VedaJunction users provides a sharing option for newly added content.
i. Share content resources with multiple VedaJunction users (parents, tutors) at single click.
ii. Select Learner and Course: The user can share content for particular learner and course.
iii. Search user to share with: The user can select the user and share a secret sharing code with whom they want to share the content. Also, the user can share content with multiple user at once.
iv. Select Course Resources: User can select Units, Lesson Plans, and Resources that you want to share with the parents.
v. Units/Learning Plans: It shows the list of Units and learning plan added for the selected course.
vi. Lesson Plans: It shows the list of lesson plans created under the selected unit.
vii. Resources: It shows the list of learning resources associated with the selected lesson plan and unit.

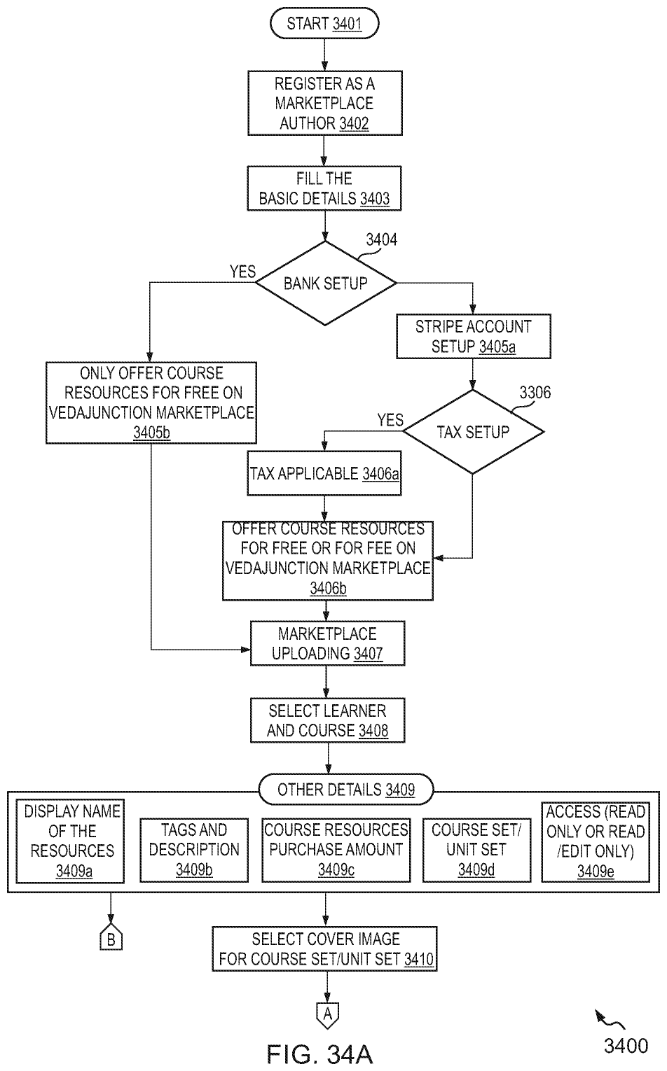

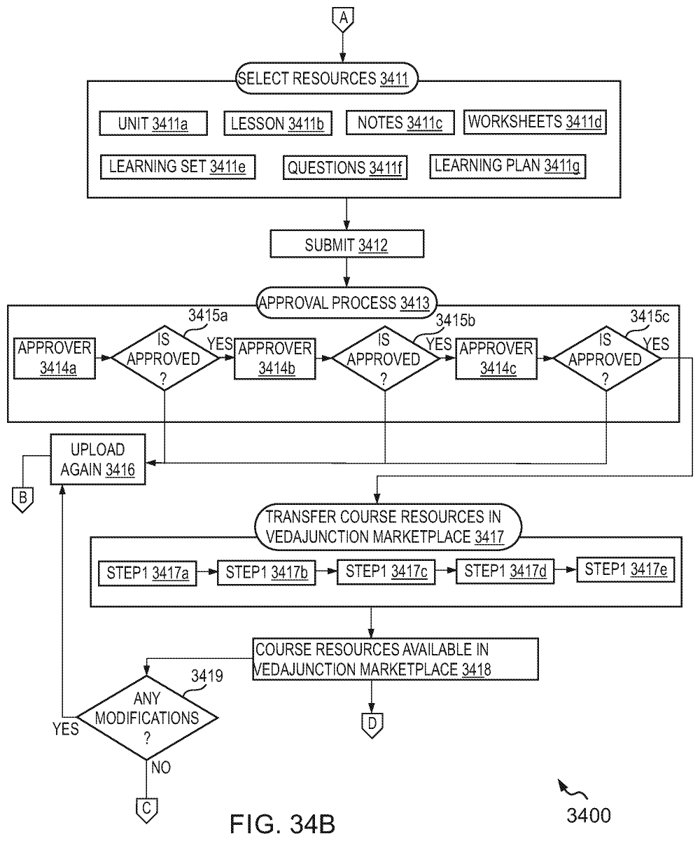

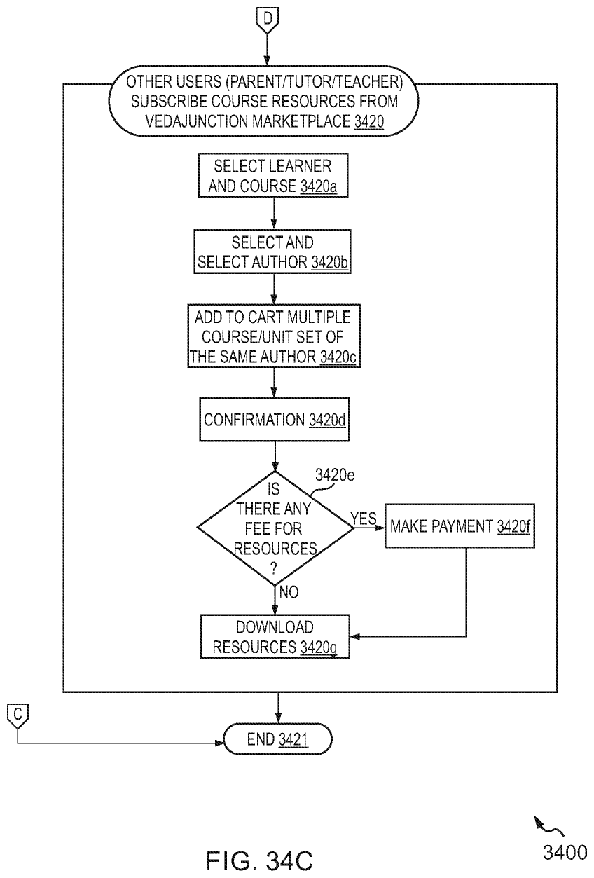

The homeschooling platform provides home learners and parents learning tools for individual and customized learning and a learning marketplace for sharing/selling and buying learning content. This supports freedom of homeschooling and provides flexibility to the homeschooling learners/parents. In order to avail the homeschooling features, a parent/tutor can register as a marketplace author. The procedures for registering a user as a marketplace is described next with reference to FIGS. 34A, 34B and 34C.

FIGS. 34A, 34B and 34C shows a flow diagram 3400 depicting flow of information for registration of a user as a marketplace author, in accordance with an example embodiment of the present invention. At 3401, the registration of the user as the marketplace author starts. The user accesses a registration page provided by user interface of the IEMS 116.

At 3402, the user is registered as the marketplace author. At 3403, basic details of the marketplace author are filled in a form. At 3404, the marketplace author selects an option for a bank setup. At 3405a, the marketplace author stripes account setup if the marketplace author selects the bank setup. At 3404b, course resources are offered for free on the VedaJunction marketplace if the marketplace author does not select the bank setup.

At 3406, the marketplace author selects a tax setup. At 3406a, tax applicable is provided for the course resources of the marketplace author. At 3406b, if the marketplace author does not select the tax setup, then the course resources are offered for free or for fee on the marketplace.

At 3407, the course resources offered for free (from 3404b) and the course resources offered for free or for fee (from 3406b) are uploaded on the marketplace. At 3408, the marketplace author selects learner(s) and courses.

At 3409, the marketplace author provides other details, such as name of the resources 3409a, tags and description 3409b, course resources purchase amount 3409c, course set/unit set 3409d, accessibility (‘Read only’ or ‘Read/Edit only’) 3409e.

At 3410, the marketplace author selects cover image for the course set/unit set. At 3411, the marketplace author selects resources, such as unit 3411a, lesson 3411b, notes 3411c, worksheet 3411d, learning set 3411e, question 3411f and learning plan 3411g. At 3412, the marketplace author submits the resources (3411a-3411g) for approval to facilitators of IEMS 116.

At 3413, the resources submitted by the marketplace author undergoes an approval process. The approval process includes different approval levels, such as approval level 3415a, approval level 3415b and approval level 3415c by different approvers, such as approver 3414a, approver 3414b and approver 3414c). At 3416, the resources are uploaded again if the resources are not approved.

At 3417, the resources are transferred to the marketplace upon successful approval by the approvers 3414a-3414c. The resources are transferred using steps 3417a-3417e. At 3418, the course resources are now available in the marketplace. At 3418, the course resources are checked by the marketplace author for any modifications. At 3419, if any modifications are required, the step 3416 for uploading the course resources again is performed. The course resources are modified by the marketplace author and uploaded. After uploading the course resources based on the modifications, steps 3409-3415 are repeated. Otherwise, if no modifications are required then proceed to step 3421.

At 3420, other users (e.g., parent/tutor/teacher) subscribe the course resources from the VedaJunction marketplace. At 3420a, learners and courses are selected by the users. At 3420b, marketplace authors are searched and selected by the users. At 3420c, the users add multiple course/unit set of the same marketplace author to their cart. At 3420d, the users wait for a confirmation of the selected multiple courser/unit set. At 3420e, the users check if there is any fee for the resources. At 3420f, a payment is completed if there is a fee of the resources. Otherwise, if there is no fee for the resources, then the users download the resources. At 3420g, the users download the resources. At 3421, the flow of information for registering the user as the marketplace author ends.

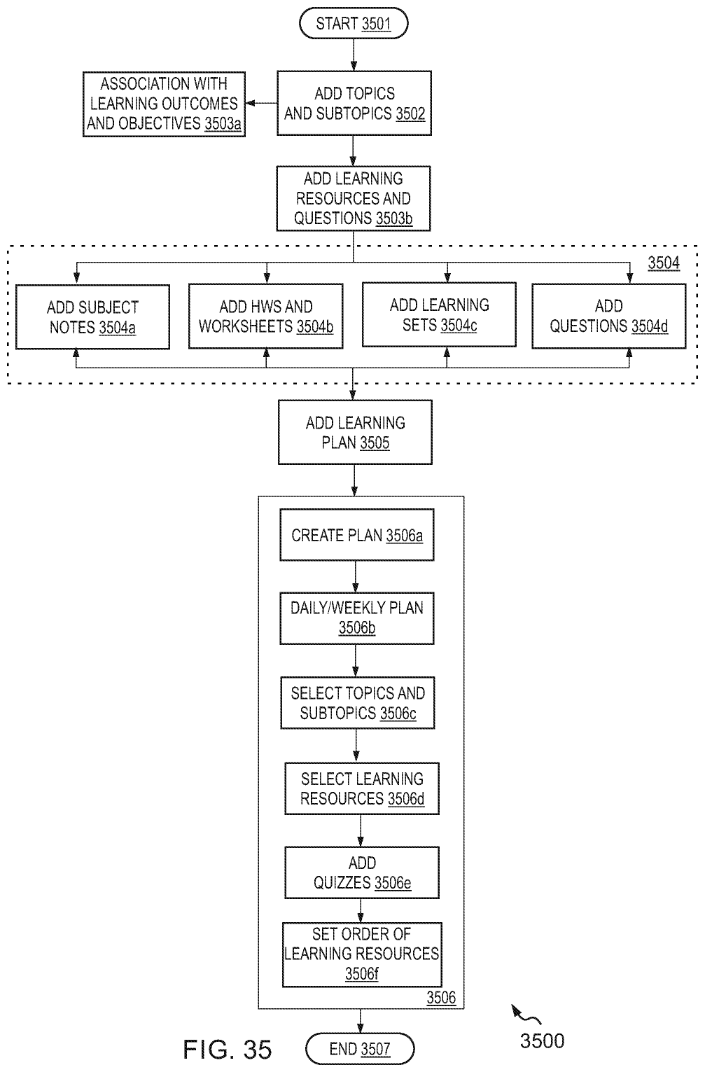

FIG. 35 shows a flow diagram 3500 depicting flow of information for adding topics and sub-topics, in accordance with an example embodiment of the present invention. At 3501, the process of adding topics and sub-topics starts. At 3502, the topics and sub-topics for learning by a student are added. At 3503a, the topics and sub-topics are associated with learning outcomes and objectives.

At 3503b, learning resources and questions are added. At 3504, subject notes 3504a, homeworks and worksheets 3504b, learning sets 3504c and questions 3504d are added.

At 3505, learning plans are added. At 3506a, a plan is created. At 3506b, daily/weekly plan is created. At 3506c, topics and sub-topics are added. At 3506d, learning resources are selected. At 3506e, quizzes are added. At 3506f, order of learning resources is set. At 3507, the addition of topics and sub-topics for a learning of the student ends.

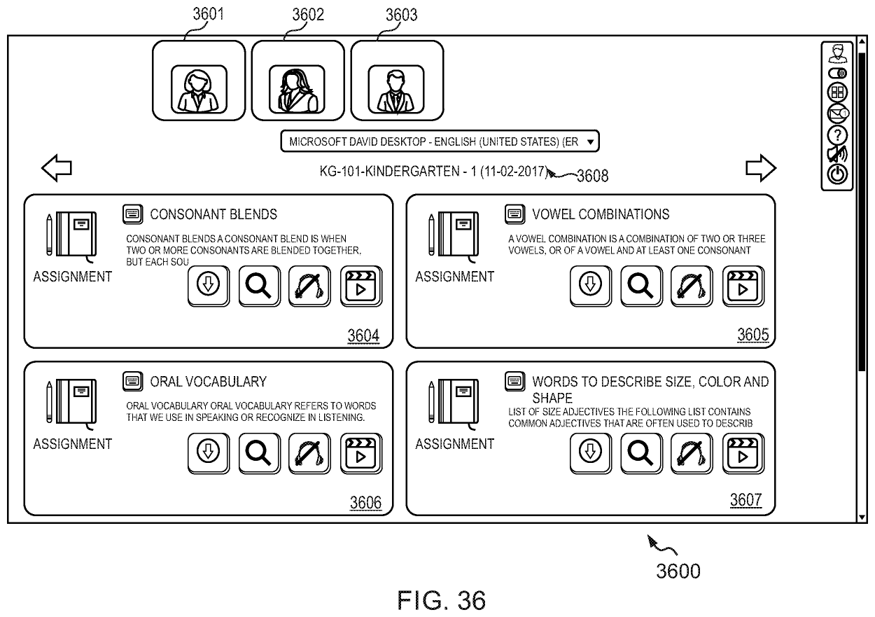

FIGS. 36 to 47A-47B illustrate screen shots of various User Interfaces (UI) associated with the IEMS 116, in accordance with an example embodiment of the present invention. More specifically, FIGS. 36 to 47A-47B depict screen shot of different modules and different stages of the IEMS 116. The screen shots are exemplary and are shown for the purpose of clarity.

As shown in FIG. 36, in UI 3600 displays users of different user roles, such as student 3601, parent 3602 and teacher 3603. Further, the UI 3600 displays learning resources, such as learning resource 3604, learning resource 3605, learning resource 3606 and learning resource 3607. In an illustrative example, the learning resources 3604-3607 include learning resources for students belonging to a particular level, such as kindergarten level 3608, as is shown in FIG. 36.

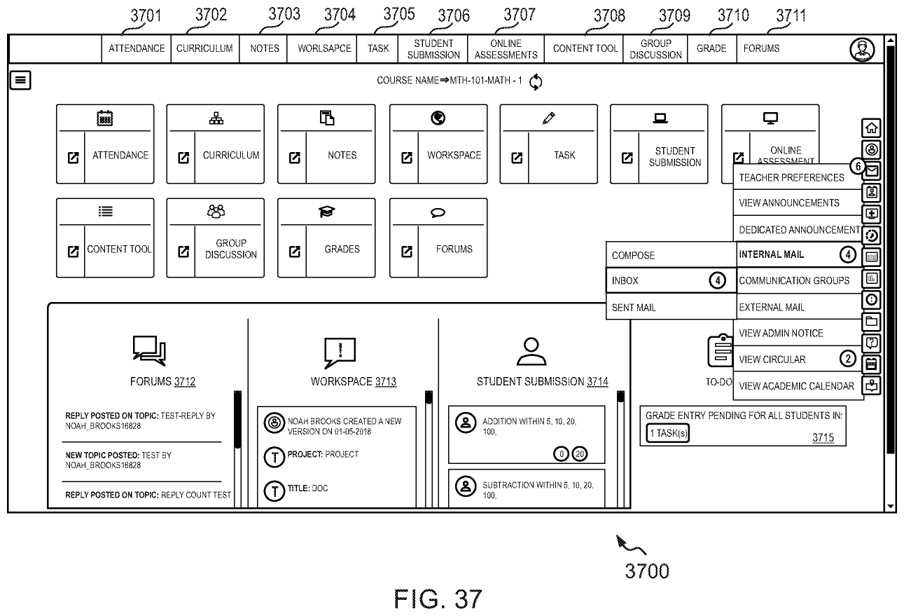

Referring now to FIG. 37, the UI 3700 is depicted to display different tabs, such as attendance tab 3701, curriculum tab 3702, notes tab 3703, workspace tab 3704, task tab 3705, student submission tab 3706, online assessment tab 3707, content tool tab 3708, group discussion tab 3709, grade tab 3710 and forums tab 3711. Further, the UI 3700 is depicted include forums option 3712 that include posts and replies from teachers/students/tutors. The posts and replies correspond to different sub-topics of the forums 3712. The UI 3700 is also depicted to include workspace option 3713 with project tag/description and title of the project. The UI 3700 also includes student submission option 3714 that includes homeworks, assignments, or tasks submitted by the student. Further, tasks that are pending for grade entry by the teacher is notified at 3715.

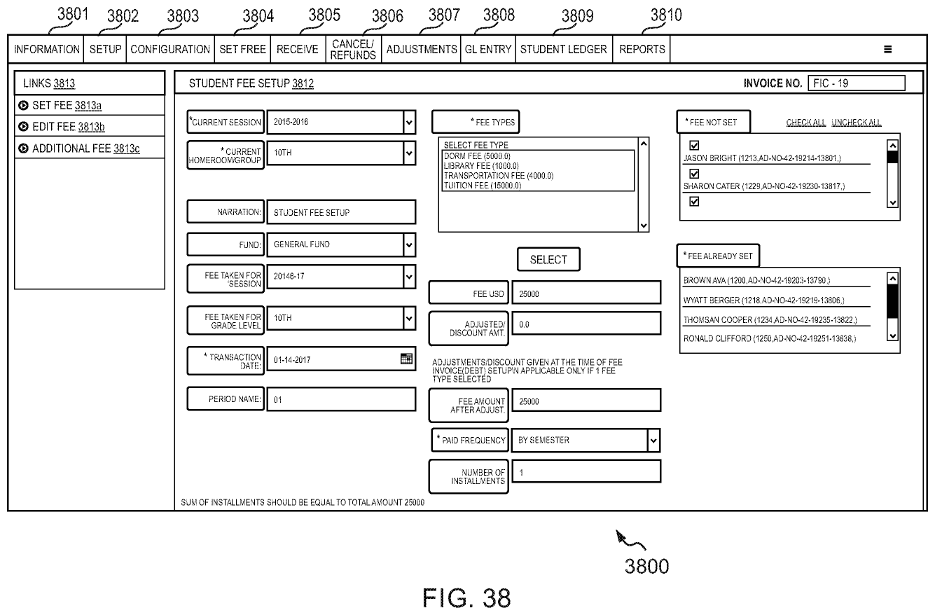

Referring now to FIG. 38, the UI 3800 is depicted to display tabs, such as information tab 3801, setup tab 3802, configuration tab 3803, set free tab 3804, receive tab 3805, cancel refunds 3806, adjustment 3807, GL entry 3808, student ledger 3809 and reports 3810. The UI 3800 is further depicted to include a student fee setup 3812. The UI 3800 also includes external links, such as links 3813 for setting fee through set fee link 3813a, for editing fee through edit fee link 3813b and for adding additional fee through additional fee link 3813c.

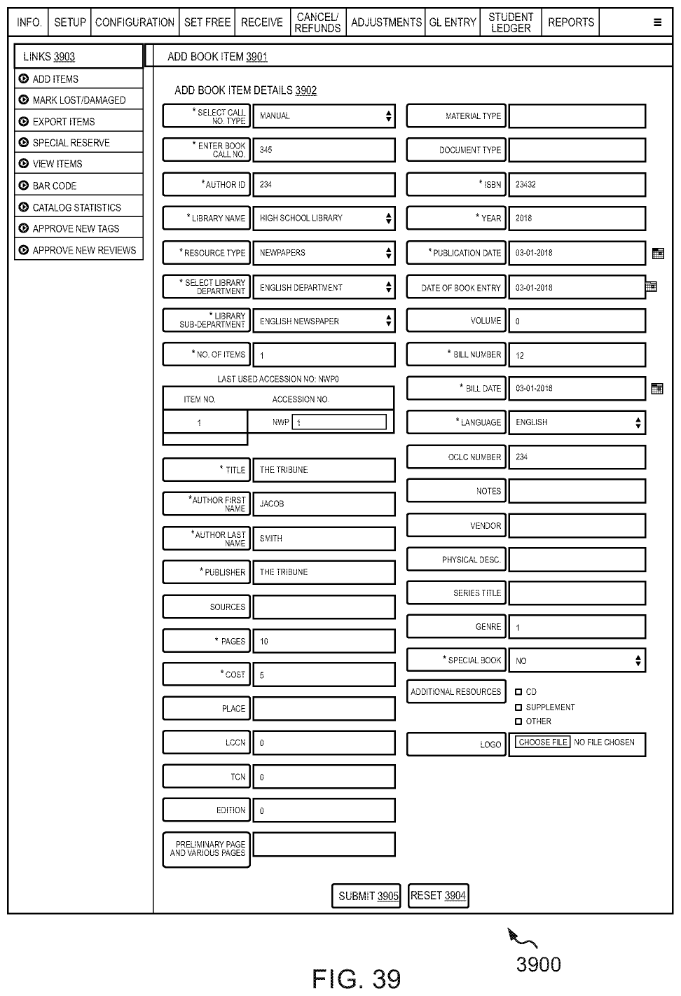

Referring now to FIG. 39, a UI 3900 displaying a page for adding book item 3901 is shown. For the book item 3901, details are entered in input fields of add book item details 3902. The UI 3900 is further depicted to include links 3903 for adding other information of a book item. In some cases, the details can be modified by clicking on reset button 3904. Once all the input fields of the add book item details 3902 are provided, a user can click on submit button 3905. The details of the book item are provided to the IEMS 116.

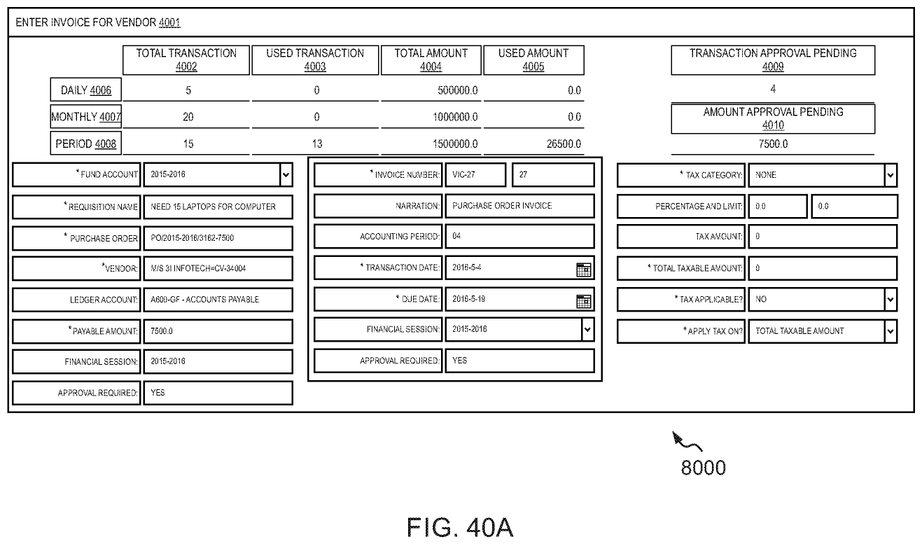

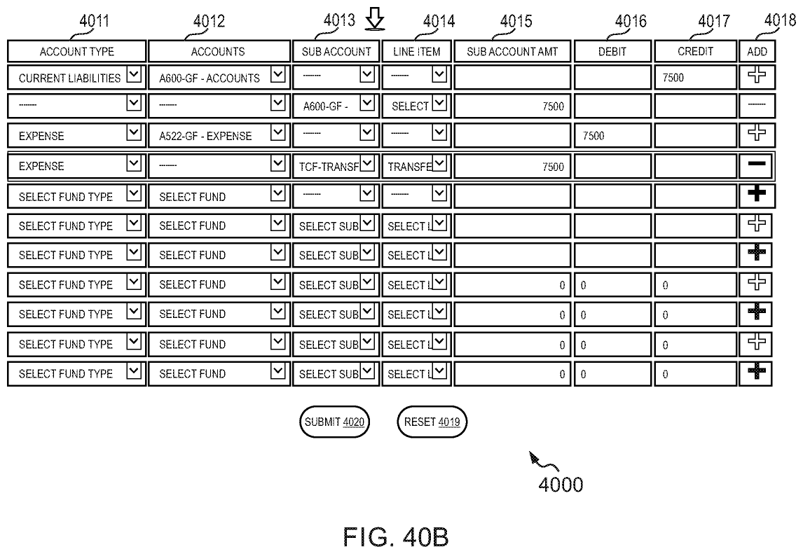

Referring now to FIGS. 40A and 40B, UI 4000 is depicted to display a page for entering invoice for vendor. The page is associated with a title 4001 that include a text ‘ENTER INVOICE FOR VENDOR’. The UI 4000 is depicted to display total transaction 4002, used transaction 4003, total amount 4004 and used amount 4005 for daily 4006, monthly 4007 and period 4008 respectively. Further, total approval pending 4009 and amount approval pending 4010 are displayed in the UI 4000.

In FIG. 40B, information of the users corresponding to bank accounts of the users are displayed. Here, bank account related information, such as account type 4011, accounts 4012, sub-account 4013, line item 4014, sub-account amount 4015, debit 4016, credit 4017 and add 4018 are included. The user can modify any information of the bank account using reset button 4019. The user can submit the information by clicking on submit button 4020.

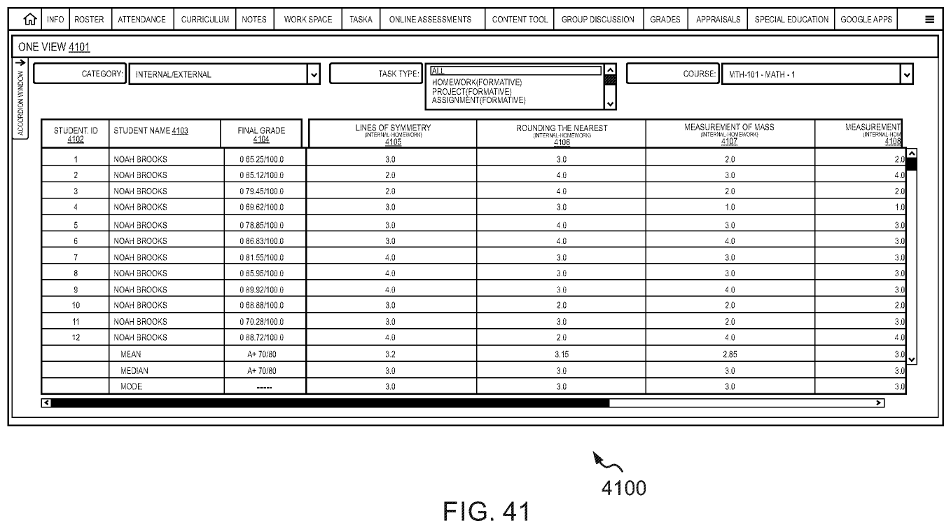

Referring now to FIG. 41, a UI 4100 displaying a view 4101 of students to the teacher/admin/parent/tutor is shown. The UI 4100 is depicted to display a table with columns for students 4102, student name 4103, final grade 4104, line of symmetry (internal-homework) 4105, rounding the nearest 4106, measurement of mass 4107 and other measurement 4108.

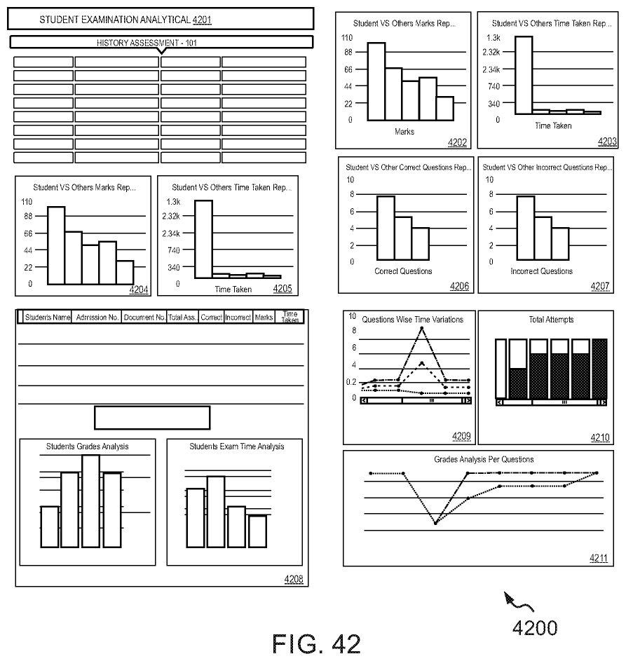

Referring now to FIG. 42, a UI 4200 displaying a student report, such as student examination analytical 4201 is shown. A graphical representation of a student performance is graphs, such as graph 4202, graph 4203, graph 4204, graph 4205, graph 4206, graph 4207, graph 4208, graph 4209, graph 4210, and graph 4211.

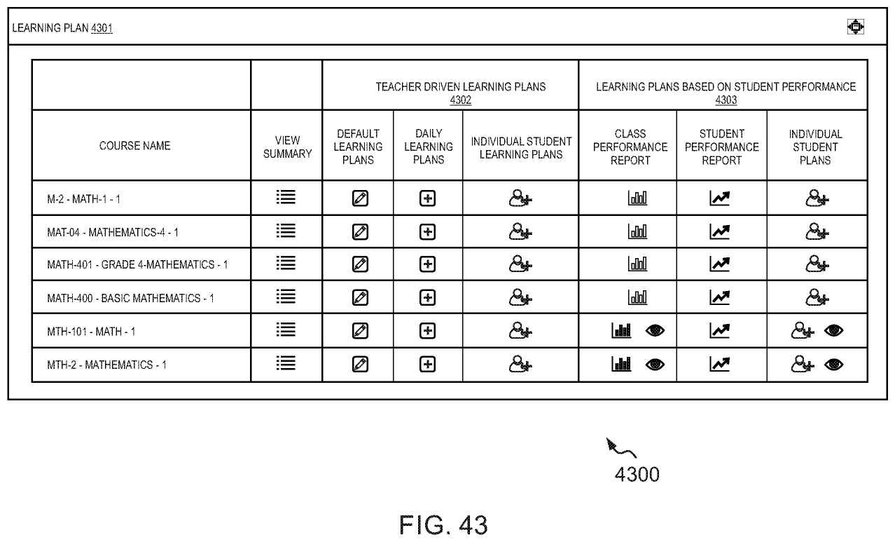

Referring now FIG. 43, a UI 4300 displaying a learning plan 4301 is shown. The learning plan 4301 includes teacher driven learning plans 4302 and learning plans based on student performance 4303. The learning plan 4301 further includes a table that stores information of different courses selected for learning by a student. The table includes columns for course name, view summary, default learning plans, daily learning plans, individual student learning plans, class performance report, student performance report and individual student plans.

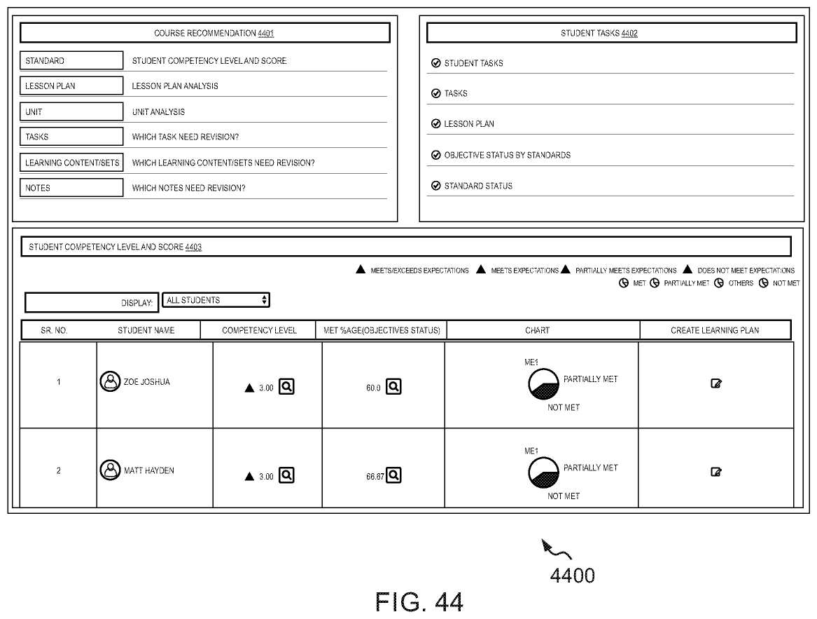

Referring now to FIG. 44, a UI 4400 displaying a course recommendation 4401 and student tasks 4402 is shown. The UI 4400 is further depicted to include a student competency level and score 4403.

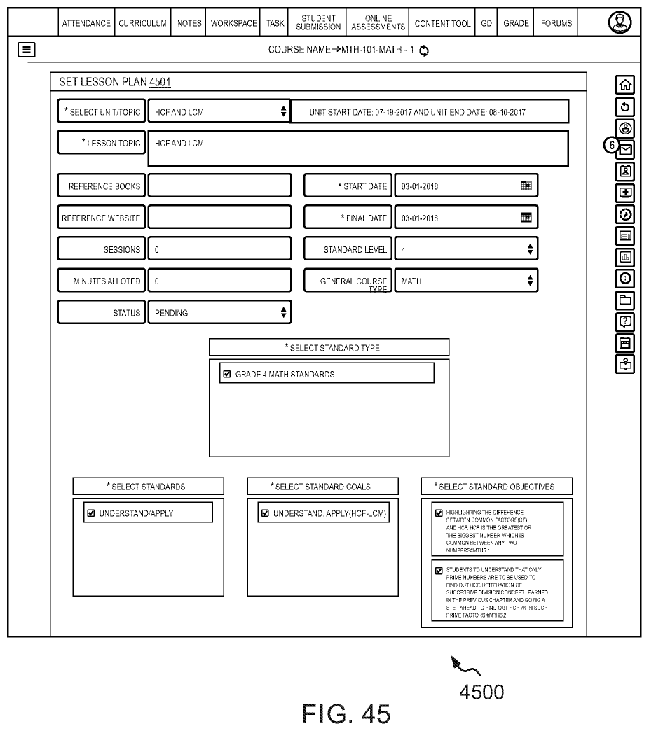

In FIG. 45, a UI 4500 displaying a set lesson plan 4501 is shown. The UI 4500 for the set lesson plan 4501 includes input fields and options for selecting unit/topic, lesson topic, reference books, reference website, sessions, minutes allotted and learning outcome status of a student. The UI 4500 also provides input fields and options for selecting standards, types of the standard, standard goals and standard objectives.

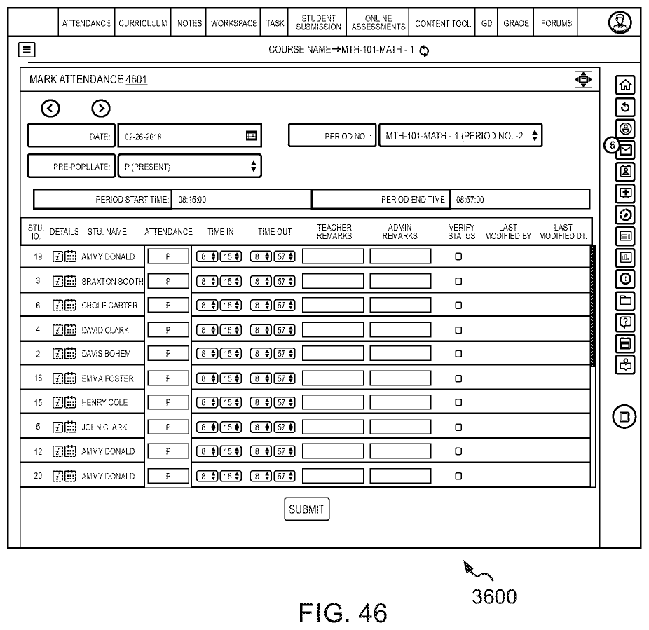

Referring now to FIG. 46, a UI 4600 displaying mark attendance 4601 of students is shown. The mark attendance 4601 includes records, such as time-in and time-out of the students for a particular class/session, teachers remarks, admin remarks, verify status, and more.

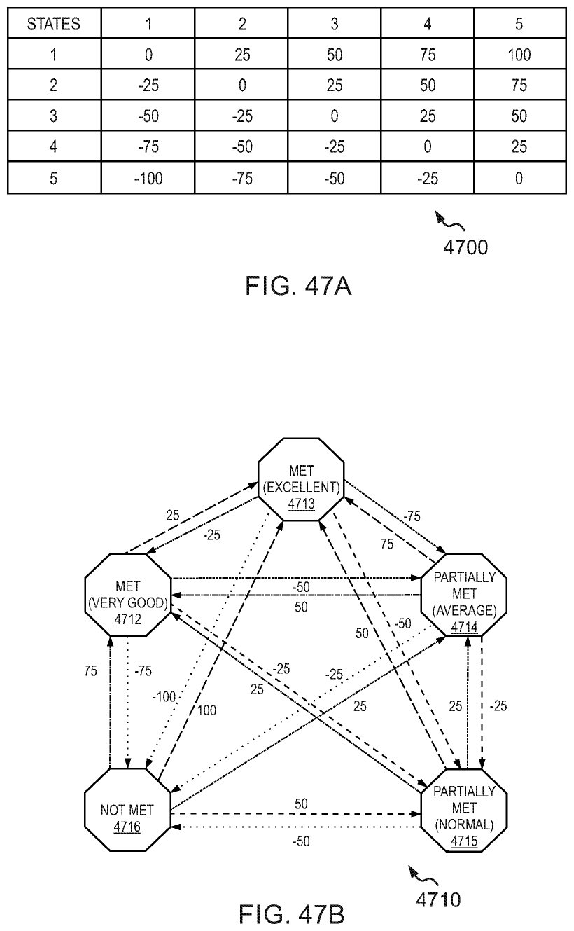

Referring now to FIGS. 47A and 47B, transition reward table 4700 and learning outcomes/objective states 4710 are illustrated, in accordance with an example embodiment.

The table 4700 corresponds to a configuration table (with percentage range defined for each state) to get the overall learning outcome status. Each state in the table 4700 represent status of each learning outcome. There are five possible states for each learning outcomes, which are shown in FIG. 47B.

In at least one example embodiment, the analysis engine of the IEMS 116 calculates student competency level and score. The calculation includes the individual standard competency score and level. Along with this, it also shows the individual objective (learning outcome) status, such as MET (VERY GOOD) 4712, MET (EXCELLENT) 4713, PARTIALLY MET (AVERAGE) 4714, PARTIALLY MET (NORMAL) 4715 and NOT MET 4716.

The MET (VERY GOOD) 4712 is state defining, where student meets very good remarks. The MET (EXCELLENT) 4713 is state defining, where student meets excellence. The PARTIALLY MET (AVERAGE) 4714 is state defining, where student meets average. The PARTIALLY MET (NORMAL) 4715 is state defining, where student meets normal values. The NOT MET 4716 is state defining, where student does not meet defined values.

Textual value associated with scores. Score assigned to each learning outcome on a scale to 1-5. Scores format (excellent) is 5, met (very good) is 4, partially met (normal) is 3, partially met (average) is 2 and not met is 1. This number computed for each objective from the student performance based on assessment(s) results that describes the skill or competency level of the students.

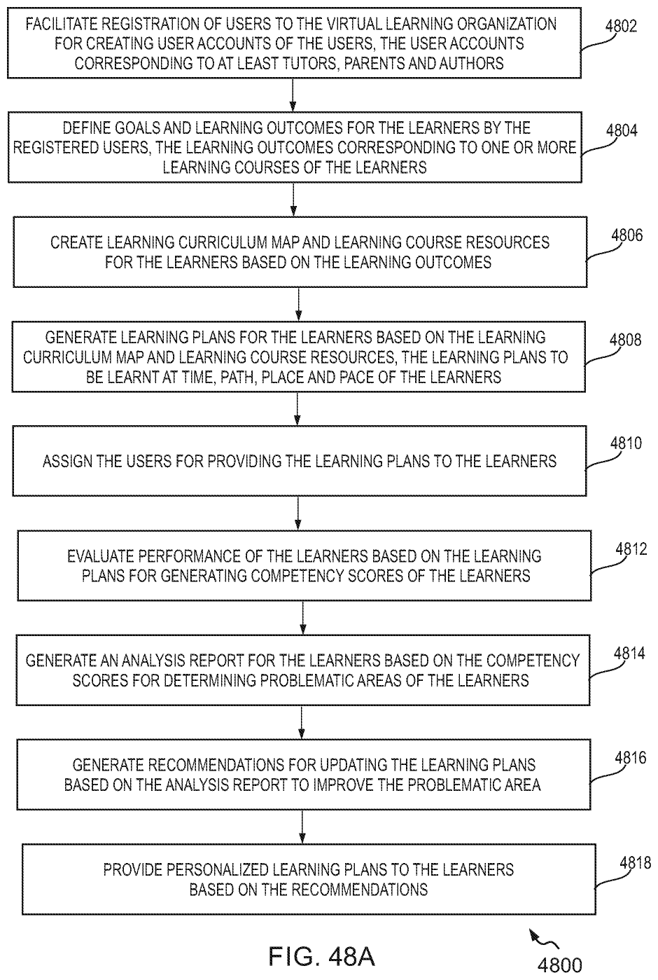

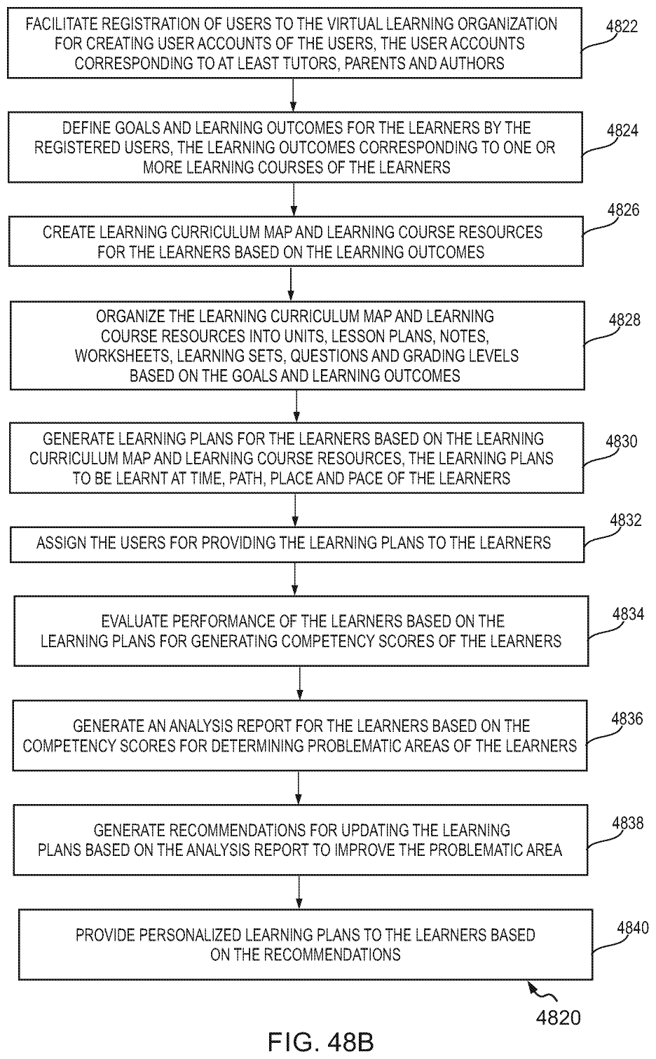

FIG. 48A illustrates a flow diagram 4800 depicting a method for providing personalized learning plans for learners of a virtual learning organization, in accordance with an example embodiment of the present disclosure. The method depicted in the flow diagram 4800 may be executed by a virtual learning system, for example, the IEMS 116. Operations of the flow diagram 4800, and combinations of operation in the flow diagram 4800, may be implemented by, for example, hardware, firmware, a processor, circuitry and/or a different device associated with the execution of software that includes one or more computer program instructions. The method starts at operation 4802.

At operation 4802, the method includes facilitating registration of users to the virtual learning organization for creating user accounts of the users. The user accounts corresponding to at least tutors, parents and authors.

At operation 4804, the method 4800 includes defining goals and learning outcomes for the learners by the registered users. The learning outcomes corresponding to one or more learning courses of the learners. In at least one example embodiment, the user accounts are created by performing configuration and single point entry of data of the virtual learning organization based on setting up a private cloud server. The one or more functionalities of the IEMS 116 are integrated into a multi-layered structure. The one or more functionalities correspond to one or more business processes related to an educational organization. The virtual learning system is installed in user devices of the users and the user accounts are created based on single sign on authentication mechanism. After installing the virtual learning system, a first administrator for handling creation of the virtual learning organization is created. The first administrator creates a second administrator for managing the virtual learning organization. The first administrator is deactivated after creating the second administrator. The first administrator defines a unique organization identifier for representing the virtual learning organization. The unique identifier associated with a name of the virtual learning organization and postal code address of the virtual learning organization. The second administrator creates a learning session for the learners and the users by the second administrator and generates a session identifier based on the learning session. The session identifier is associated with an academic session of the virtual learning organization.

At operation 4806, the method 4800 includes creating learning curriculum map and learning course resources for the learners based on the learning outcomes. The curriculum mapping is performed between the learning plans and, the goals and learning outcomes. The learning curriculum map and learning course resources are organized into units, lesson plans, notes, worksheets, learning sets, questions and grading levels based on the goals and learning outcomes. Unit-wise learning topics are added in the organized learning curriculum map and learning course resources. Multiple lesson plans of the unit-wise learning topics are also created. The multiple lesson plans are assigned to the users for providing to the learners.

At operation 4808, the method 4800 includes generating learning plans for the learners based on the learning curriculum map and learning course resources. The learning plans to be learnt at time, path, place and pace of the learners. A syllabus corresponding to a learning area is created by mapping with rubrics and weightage for internal and external assessments of the virtual learning organization. The learning plans are created using user-created learning plans created by other users registered to the virtual learning system. Also, machine-generated learning plans created by machine learning based analytical and recommendation tool are accessed for generating the learning plans.

At operation 4810, the method 4800 includes assigning the users for providing the learning plans to the learners. Tasks for the learners are posted. The tasks corresponding to learning activities of the learners comprising assignment, homework, examinations, projects, lab assignments, and group discussions. More specifically, the tasks are assigned to the respective users and the tasks are assigned to the learners by the respective faculties.

At operation 4812, the method 4800 evaluating performance of the learners based on the learning plans for generating competency scores of the learners. In at least one example embodiment, grades are provided based on the competency scores. The grades are normalized and the normalized grades are sent to facilitators for grade approval to generate transcripts for the learners. Further, grade report cards for the learners are generated upon successful approval.

At operation 4814, the method 4800 generating an analysis report for the learners based on the competency scores for determining problematic areas of the learners. The competency scores of the learners are calculated for each learning course of the one or more learning courses. The calculated competency scores are compared with pre-defined scores of the one or more learning courses. An overall learning outcome status of the learners are generated.

At operation 4816, the method 4800 generating recommendations for updating the learning plans based on the analysis report to improve the problematic areas. A graphical representation of the analysis report is shown in FIG. 42.

At operation 4818, the method 4800 providing personalized learning plans to the learners based on the recommendations. The learning plans are updated until the learners achieved a mastery level. Further, the learning plans can be shared with other users registered of the virtual learning system.

The sequence of operations of the method 4800 need not be necessarily executed in the same order as they are presented. Further, one or more operations may be grouped together and performed in form of a single step, or one operation may have several sub-steps that may be performed in parallel or in sequential manner.

FIG. 48B illustrates a flow diagram 4820 depicting a method for providing personalized learning plans for learners of a virtual learning organization, in accordance with an example embodiment of the present disclosure. The method depicted in the flow diagram 4820 may be executed by a virtual learning system, for example, the IEMS 116. Operations of the flow diagram 4820, and combinations of operation in the flow diagram 4820, may be implemented by, for example, hardware, firmware, a processor, circuitry and/or a different device associated with the execution of software that includes one or more computer program instructions. The method starts at operation 4822.

At operation 4822, the method 4820 includes facilitating registration of users to the virtual learning organization for creating user accounts of the users. The user accounts corresponding to at least tutors, parents and authors.

At operation 4824, the method 4820 includes defining goals and learning outcomes for the learners by the registered users. The learning outcomes corresponding to one or more learning courses of the learners.

At operation 4826, the method 4820 includes creating learning curriculum map and learning course resources for the learners based on the learning outcomes.

At operation 4828, the method 4820 includes organizing the learning curriculum map and learning course resources into units, lesson plans, notes, worksheets, learning sets, questions and grading levels based on the goals and learning outcomes.

At operation 4830, the method 4820 includes generating learning plans for the learners based on the learning curriculum map and learning course resources, the learning plans to be learnt at time, path, place and pace of the learners.

At operation 4832, the method 4820 includes assigning the users for providing the learning plans to the learners.

At operation 4834, the method 4820 includes evaluating performance of the learners based on the learning plans for generating competency scores of the learners.

At operation 4836, the method 4820 includes generating an analysis report for the learners based on the competency scores for determining problematic areas of the learners;

At operation 4838, the method 4820 includes generating recommendations for updating the learning plans based on the analysis report to improve the problematic areas.

At operation 4840, the method 4820 includes providing personalized learning plans to the learners based on the recommendations.

Various embodiments of the present invention (explained in conjunction with FIGS. 1 to 48A-48B) provide an integrated education management system and method. The method allows education institutes to integrate different software associated with different departments as integrated software that are accessed using a Single-Sign-On authentication. The method reduces efforts needed by the educational institutes to manage and handle software associated with different departments. Hence, the IEMS offers an all-in-one Integrated Education Management System (IEMS) to schools/colleges/universities/training schools. It further provides an SSO solution for accessing all functionalities of the educational institute. It automates all business processes of the institution and reduces administration work. It eliminates or reduce use of multiple software systems thereby reducing cost of operations and other administrative costs. It also offers an advanced learning system to schools which can offer students the ability to study, learn and practice at their own pace and at a place of their choice. The IEMS also analyzes, identifies problems with student learning, course materials and teaching and offer recommendations to each student, teachers and automatically create individual learning plans as per requirements and need. Further, the IEMS offers a complete virtual school for all students and their parents where the students can register for courses for every grade level. The IEMS allows students to study and learn virtually from home or any other place of their choice and also at any time. The parents can also create content for their children using the IEMS. The IEMS is a cloud-based offer which allows subscriber and facilitated network where students can select and choose courses to be learnt using a portal or application. The IEMS includes advanced machine learning algorithms based intelligent agent that manages and analyzes the activities of the students. Through the IEMS improves student learning outcomes using the advanced learning system, customized individual learning plans and intelligent facilitated network.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A method for providing personalized learning plans for learners of a virtual learning organization, the method comprising:
facilitating registration of users to the virtual learning organization for creating user accounts of the users, the user accounts corresponding to at least tutors, parents and authors;
defining goals and learning outcomes for the learners by the registered users, the learning outcomes corresponding to one or more learning courses of the learners;
creating learning curriculum map and learning course resources for the learners based on the learning outcomes;
generating learning plans for the learners based on the learning curriculum map and learning course resources, the learning plans to be learnt at time, path, place and pace of the learners;
assigning the users for providing the learning plans to the learners;
evaluating performance of the learners based on the learning plans for generating competency scores of the learners;
generating an analysis report for the learners based on the competency scores for determining problematic areas of the learners;
generating recommendations for updating the learning plans based on the analysis report to improve the problematic areas; and
providing personalized learning plans to the learners based on the recommendations.

2. The method as claimed in claim 1, wherein creating the user accounts comprises:
performing configuration and single point entry of data of the virtual learning organization based on setting up a private cloud server;
integrating one or more functionalities into a multi-layered structure, the one or more functionalities corresponding to one or more business processes related to an educational organization;
Installing the virtual learning system in user devices of the users; and
creating the user accounts based on single sign on authentication mechanism.

3. The method as claimed in claim 2, wherein installing the virtual learning further comprising:
creating a first administrator for handling creation of the virtual learning organization;
creating a second administrator by the first administrator for managing the virtual learning organization; and
deactivating the first administrator upon creating the second administrator.

4. The method as claimed in claim 3, wherein creating the first administrator further comprising:
defining a unique organization identifier for representing the virtual learning organization; and
associating the unique identifier with a name of the virtual learning organization and postal code address of the virtual learning organization.

5. The method as claimed in claim 3, wherein creating second administrator further comprising:
creating a learning session for the learners and the users by the second administrator; and
generating a session identifier based on the learning session, the session identifier associated with an academic session of the virtual learning organization.

6. The method as claimed in claim 5, further comprising:
creating a financial session by the second administrator using financial session element; and
generating a unique identifier of the financial session based on the financial session element, the unique identifier corresponding to an annual time-period of the virtual learning organization.

7. The method as claimed in claim 1, wherein creating learning curriculum map and learning course resources comprises:
performing a curriculum mapping between the learning plans and, the goals and learning outcomes; and
organizing the learning curriculum map and learning course resources into units, lesson plans, notes, worksheets, learning sets, questions and grading levels based on the goals and learning outcomes.

8. The method as claimed in claim 7, further comprising:
adding unit-wise learning topics in the organized learning curriculum map and learning course resources;
creating multiple lesson plans of the unit-wise learning topics; and
assigning the multiple lesson plans to the users for providing to the learners.

9. The method as claimed in claim 8, wherein assigning the multiple lesson plans further comprising:
creating a syllabus corresponding to a learning area by mapping with rubrics and weightage for internal and external assessments of the virtual learning organization; and
posting tasks for the learners, the tasks corresponding to learning activities of the learners comprising assignment, homework, examinations, projects, lab assignments, and group discussions.

10. The method as claimed in claim 9, wherein posting the tasks further comprising:
assigning the tasks to the respective users; and
assigning the tasks to the learners by the respective faculties.

11. The method as claimed in claim 1, wherein generating the learning plans comprises:
using user-created learning plans created by other users registered to the virtual learning system;
accessing machine-generated learning plans created by machine learning based analytical and recommendation tool; and
creating the learning plans based on the user-created learning plans and the machine-generated learning plans.

12. The method as claimed in claim 1, wherein providing the learning plans comprises:
creating login accounts for the learners; and
assigning the learning plans to the learners through the login accounts.

13. The method as claimed in claim 1, wherein generating competency scores of the learners further comprising:
providing grades based on the competency scores;
normalizing the grades;
sending the grades for grade approval to generate transcripts for the learners; and
generating grade report cards for the learners upon successful approval.

14. The method as claimed in claim 1, wherein evaluating performance of the learners comprises:
calculating competency scores of the learners for each learning course of the one or more learning courses;
comparing the calculated competency scores with pre-defined scores of the one or more learning courses; and
generating an overall learning outcome status of the learners.

15. The method as claimed in claim 1, wherein providing personalized learning plans to the learners based on the recommendations further comprising:
updating the learning plans until the learners achieved a mastery level; and
sharing the learning plans with other users registered to the virtual learning system.

16. A virtual learning system for providing personalized learning plans to learners of a virtual learning organization, the virtual learning system comprising:
a database storing instances of the virtual learning system; and
a learning platform coupled with the database, the learning platform configured to cause the virtual learning system to at least perform:
facilitating registration of users to the virtual learning system for creating user accounts of the users, the user accounts corresponding to at least tutors, parents and authors;
defining goals and learning outcomes for the learners by the registered users, the learning outcomes corresponding to one or more learning courses of the learners;
creating learning curriculum map and learning course resources for the learners based on the learning outcomes;
generating learning plans for the learners based on the learning curriculum map and learning course resources, the learning plans to be learnt at time, path, place and pace of the learners;
assigning the users for providing the learning plans to the learners;
evaluating performance of the learners based on the learning plans for generating competency scores of the learners;
generating an analysis report for the learners based on the competency scores for determining problematic areas of the learners;
generating recommendations for updating the learning plans based on the analysis report to improve the problematic areas; and
providing personalized learning plans to the learners based on the recommendations.

17. The virtual learning system as claimed in claim 16, wherein for creating the user accounts the virtual learning system is further caused to at least perform:
performing configuration and single point entry of data of a virtual learning organization based on setting up a private cloud server;
integrating one or more functionalities into the multi-layered structure, the one or more functionalities corresponding to one or more business processes related to an educational organization;
installing the virtual learning system in user devices of the users; and
creating the user accounts based on single sign on authentication mechanism.

18. The virtual learning system as claimed in claim 17, wherein for installing the virtual learning the virtual learning system is further caused to at least perform:
creating a first administrator for handling creation of the virtual learning organization;
creating a second administrator by the first administrator for managing the virtual learning organization; and
deactivating the first administrator upon creating the second administrator.

19. The virtual learning system as claimed in claim 18, wherein for creating the first administrator the virtual learning system is further caused to at least perform:
defining a unique organization identifier for representing the virtual learning organization; and
associating the unique identifier with a name of the virtual learning organization and postal code address of the virtual learning organization.

20. A method for providing personalized learning plans for learners of a virtual learning organization, the method comprising:
facilitating registration of users to the virtual learning organization for creating user accounts of the users, the user accounts corresponding to at least tutors, parents and authors;
defining goals and learning outcomes for the learners by the registered users, the learning outcomes corresponding to one or more learning courses of the learners;
creating learning curriculum map and learning course resources for the learners based on the learning outcomes;
organizing the learning curriculum map and learning course resources into units, lesson plans, notes, worksheets, learning sets, questions and grading levels based on the goals and learning outcomes;
generating learning plans for the learners based on the learning curriculum map and learning course resources, the learning plans to be learnt at time, path, place and pace of the learners;
assigning the users for providing the learning plans to the learners;
evaluating performance of the learners based on the learning plans for generating competency scores of the learners;
generating an analysis report for the learners based on the competency scores for determining problematic areas of the learners;
generating recommendations for updating the learning plans based on the analysis report to improve the problematic areas; and
providing personalized learning plans to the learners based on the recommendations.
